(19) United States
(12) Patent Application Publication
(10) Pub. No.: US 2025/0146981 A1
(43) Pub. Date: May 8, 2025

(54) SYSTEMS AND METHODS FOR ULTRASOUND INSPECTION OF BATTERY CELLS

(71) Applicant: TITAN ADVANCED ENERGY SOLUTIONS, INC., Salem, MA (US)

(72) Inventors: Shawn D. MURPHY, Wenham, MA (US); Nemanya SEDOGLAVICH, Boston, MA (US); Michael BELL, Boxford, MA (US); Georgios KAPODISTRIAS, Reading, MA (US)

(21) Appl. No.: 18/934,253

(22) Filed: Nov. 1, 2024

Related U.S. Application Data
(60) Provisional application No. 63/547,194, filed on Nov. 3, 2023.
(60) Provisional application No. 63/603,166, filed on Nov. 28, 2023.

(51) Int. Cl. G01N 29/27; H01M 10/42

(52) U.S. Cl. CPC G01N 29/27; H01M 10/4207; H01M 10/4285; G01N 2291/106; G01N 2291/2698

(57) ABSTRACT

A battery cell inspection system and method are disclosed. The system performs an ultrasound interrogation session of a cell by directing ultrasound at different frequencies at target points across surfaces of the cell, detecting ultrasound at the target points that is transmitted through and/or reflected from the cell, generating response signals from the detected ultrasound at each of the target points, and determining characteristics of the cell including defects, anomalies and cell capacity based upon the response signals. During the session, the transducers are not in contact with the surfaces of the cell, and the transducers and the cell are immersed in an electrically non-conductive fluid. The system can also configure the ultrasound transmitted at the target points into focused beams. Alternatively, an inspection system can be configured to determine characteristics of a cell during a formation stage of the cell.

### CROSS-REFERENCE TO RELATED APPLICATION(S)

This application claims benefit of and priority under 35 U.S.C. § 119 (c) to and is a non-provisional of U.S. Provisional Application No. 63/547,194, filed Nov. 3, 2023, entitled “Systems and Methods for Ultrasound Inspection of Battery Cells,” and U.S. Provisional Application No. 63/603,166, filed Nov. 28, 2023, each of which is incorporated by reference herein in its entirety.

### FIELD

The present disclosure relates generally to inspection of energy storage devices (e.g., battery cells), and more particularly, to inspection of battery cells (e.g., lithium-ion batteries) using ultrasound, for example, during manufacturing of the battery cells and/or as part of quality control for manufactured battery cells.

### BACKGROUND

Battery cells, such as lithium-ion battery cells, can be constructed by disposing alternating positive and negative electrode layers (cathode and anode layers, respectively) with a non-conductive separator layer between each anode/cathode pair to form an anode/separator/cathode assembly (“assembly”). Each assembly, or group of assemblies, can then be immersed in an electrolyte. Thus, each anode, cathode, and separator form a surface of the battery cell.

Rechargeable battery cells (e.g., lithium-ion), also known as secondary battery cells, generally have three types. In a first example, to form a cylindrical battery cell, a continuous assembly is successively wound around a starting center point and onto itself. The resulting assembly is then included within a cylindrical metal case or housing, and the electrolyte is added to the housing. In a second example, to form a prismatic battery cell, multiple assemblies comprising anode, cathode, and separator elements are formed, cut, and then stacked on top of one another. The stack of assemblies is enclosed in a pouch or bag, an electrolyte is added to the bag, and the bag is placed in a substantially rectangular housing. In a third example, a pouch battery cell includes stacked assemblies similar to prismatic cells, but the pouch battery cell configuration can have large rectangular dimensions as compared with the cells' thickness. The stacked assemblies are included within the battery pouch and electrolyte is added to the pouch, but typically no housing is used.

Battery cells (e.g., lithium-ion) can be manufactured in multiple stages. These stages include layer construction, cell assembly/electrode assembly, formation (also known as electrolyte filling and wetting or soaking), cell activation, and post-activation. A summary of each stage is provided below.

In the layer construction phase (e.g., the earliest phase), different metal foil substrate materials are selected for the anode and cathode layers, and a non-conductive polymer (or layers of polymers) is/are selected for the separator layer. Copper and aluminum films can be selected for the anode and cathode layers, respectively. A “slurry” coating solution is prepared that includes chemical components such as active materials, a polymer binder, and conductive agents and other additives. The components are mixed together to form the slurry. The metal foil substrates are coated with the slurry to create metal film electrodes with desired properties. The metal film electrodes are then baked in an oven, rolled, and compressed under high pressure (also known as calendaring) to promote adhesion and uniformity and to improve porosity. The metal film electrodes are then cut into strips of a desired shape in accordance with the design/type of the battery cell.

The cell assembly/electrode assembly stage includes winding or stacking of an anode, a separator, and a cathode in a “sandwich” configuration. The resulting assembly is then formed into the desired battery cell type. Contacts can then be added to the one or more assemblies.

At the formation stage, the assemblies are placed in the housing (cylindrical cell), bag (prismatic cell), or pouch (pouch cell). An electrolyte is introduced into the battery cell, which fills the bag or pouch and all components within it. In prismatic cells, for example, the bag is filled with the electrolyte in multiple successive steps and under pressure to achieve uniform distribution of the electrolyte across the layers and to minimize voids in the layers during filling. For this purpose, each filling step can be followed by shaking of the cell and hours of settling time so that the electrolyte permeates and fills pores of the layers uniformly. For at least these reasons, the formation stage is also known as the “electrolyte soaking” or “electrolyte filling and wetting” stage.

During the activation or formation stage, using the example of prismatic battery cells, the bag is sealed in a vacuum state, and a charge is applied to the contacts to enable the cells to operate electrically. For this purpose, a low voltage charge is initially applied to the contacts, and a solid electrolyte interphase (SEI) layer forms on the electrodes, specifically upon the anodes and under a 0%/0.1% State of Charge (SOC). The SEI layer protects the electrodes against corrosion by the electrolyte. Then, the cells are “graded” by charging them with a low current and then discharging them several times, over several cycles. Each cycle can take as few as three hours or as much as twenty-four hours, depending upon battery type, size, and chemistry. Also during the formation or activation stage, a degassing procedure is performed in which gas generated in the battery cell is discharged. At the same time, the aforementioned activation or formation stage steps are applicable to other battery cell formats, such as cylindrical and pouch cells, in examples.

The post-formation/post-activation stage is the final stage of manufacturing. During this stage, various characteristics of each cell and cell capacity are tested continuously over a period of, for example, from days to several weeks under controlled temperature, pressure, and humidity. An open circuit voltage (OCV) and/or direct current internal resistance (DCIR) of each battery cell is usually monitored for this purpose. Because this phase can last multiple days to weeks, the post-formation/post-activation stage is also known as the “aging” phase.

If there are no significant changes in the characteristics of each cell and cell capacity over this period, the battery cells are tested/inspected a final time via internal resistance measurements and possibly under UN/DOT 38.3 transportation requirements, in examples. Battery cells that have successfully passed these tests are then assembled into battery packs/packaged and connected to form batteries, and then prepared for shipment.

Existing inspection systems for detecting defects in battery cells include x-ray based computed tomography (CT) systems, and electrical systems including open circuit voltage (OCV), Direct Current Internal Resistance (DCIR), Alternating Current Internal Resistance (ACIR), and capacity testing systems. These existing inspection systems provide non-destructive testing of batteries to directly or indirectly determine defects.

The existing battery inspection systems generally operate as follows. CT systems scan the battery cells using high-resolution X-rays and create gray scale 2D image “slices” and 3D volumetric density maps of the cells in response. Via the images/volumes, operators of the systems can detect defects including irregularities in cell layers, delamination, voids, and unwanted metal particles, in examples.

The electrical systems, in contrast, do not detect defects directly; rather, depending on the type of system, these systems infer problems with battery cells when voltage, current, resistance, and/or charge levels of the cells do not meet expected values. In more detail, the OCV systems measure the difference in electrical potential across two terminals when the cell is disconnected from power. The DCIR systems apply a high current to anodes and electrodes over a short time period and then measure changes to the battery voltage and discharge current. The ACIR test, in contrast, applies an AC voltage waveform with a frequency of, for example, 1 kilohertz (kHz) and measures the resistance at this frequency. In capacity testing, a charge is applied to the battery cell and a load is connected for a specified time. As the battery discharges to a defined end voltage value, the state of charge of the battery is determined.

The existing battery cell inspection systems have limitations. In the CT systems, the target battery cell must be removed from the manufacturing/production line and placed in a separate CT system for scanning. The CT systems can accurately detect many defects, but this requires the use of high resolution scans. Because the scanning time increases with increasing scan resolution, each high-resolution scan can take up to an hour or more. Moreover, the images produced by the CT systems are gray-scale images, which can have low contrast. These low-contrast images can make it difficult for operators to distinguish defects from scattered radiation and artifacts, in examples. Because CT systems use X-rays, personnel exposure to X-rays should also be minimized and monitored. Moreover, the CT systems are expensive to purchase and operate.

As for the electrical inspection systems, there is no ability to directly detect defects. Rather, these systems can only infer issues with the cells at a coarse level when the test results of the systems do not meet expected values. The electrical inspection systems (with the exception of the OCV systems) also require that operators remove the battery cells from the production line to inspect, which severely restricts the number of battery cells that actually undergo inspection during manufacturing.

As a result, battery cell manufacturers cannot inspect all battery cells during manufacturing and need to test each battery cell after the formation stage and/or after the post-formation/post-activation stage for defects. This significantly increases production time and costs. Moreover, battery cell manufacturers generally experience a high battery cell defect rate in their first year of production. Experience has shown that as many as 60 to 70% of battery cells manufactured during the first year of production typically include defects that require the cells to be scrapped.

Thus, there is an unmet need for battery cell inspection systems that can detect defects in shorter time and with higher accuracy than existing inspection systems. There is also an unmet need for systems that can inspect battery cells (e.g., each and every battery cell) throughout the stages of the manufacturing process without the need to remove the battery cells from the production line.

Embodiments of the disclosed subject matter may address one or more of the above-noted needs, problems, and/or disadvantages, among other things.

### SUMMARY

Embodiments of the disclosed subject matter provide systems and methods for determining characteristics of battery cells by non-destructive ultrasound evaluation. In some embodiments, the limitations of existing battery cell inspection systems can be overcome by providing high-resolution, high-speed, ultrasound-based inspection of battery cells. Alternatively or additionally, in some embodiments, each and every battery cell can be inspected, e.g., during manufacturing/as the cells are being produced (for example, on an assembly line).

Embodiments of the disclosed subject matter can also be used post-production. In one example, battery integrators that purchase battery cells from manufacturers can use the system to inspect one, some, or each battery cell before assembling them into battery modules/prior to connecting multiple cells together to form batteries.

For example, an inspection system can be located in a customer facility (e.g., a battery cell manufacturing facility) and can be used by personnel at the facility to detect characteristics of the battery cell during the manufacturing process. These characteristics may include battery morphology, defects, anomalies, deviations, and a determination of overall battery performance, in examples. The characteristics are determined in response to ultrasound signals transmitted by the system at a plurality of predetermined target points of the battery cell. The system detects the ultrasound transmitted into and/or reflected from the battery cell at each target point, creates a representation of the detected ultrasound, known as a response signal, and then collects the response signals. The inspection system then analyzes the collected response signals for each of the target points to obtain the characteristics of the battery cell. During the transmission and detection of the ultrasound, the battery cell (and ultrasound transducers that transmit and detect the ultrasound) can be immersed in an electrically non-conductive fluid, and the ultrasound transducers do not come into contact with surfaces of the battery cell.

Current state of the art technology in battery cell manufacturing inspection is also not able to provide real-time monitoring of battery cells during the formation process. Limited insights into cells during the formation stage prevents the possibility of actively adjusting and optimizing the formation process. To address the inability of existing inspection systems to provide real-time monitoring of battery cells during the formation process, embodiments of the disclosed subject matter can provide an inspection system for monitoring battery cells during cell formation. The inspection system can include a sensing fixture, a formation chamber that receives the sensing fixture and enables formation of the cells within the sensing fixture, and at least one ultrasound transducer module associated with the battery cell and configured to perform ultrasound interrogation of the cell during the formation.

For example, the battery cells can be lithium-ion cells, and/or the at least one ultrasound transducer module can include a microelectromechanical system (MEMS) device or piezoelectric transducer (e.g., lead zirconate titanate (PZT) ceramic, or material variation of a PZT crystal). In this inspection system, faces of the ultrasound transducers can be placed in contact with the battery cell. The inspection system can also include a processing system that receives response signals from each ultrasound transducer module and determines characteristics of the battery cell based on the response signals. For example, the characteristics can be used to adjust and optimize phases of the formation process (e.g., electrolyte distribution and wetting and/or solid electrolyte interphase (SEI) layer formation), to detect/track gas due to lithium plating, and/or to detect early indicia of failure (e.g., thermal runaway).

In some embodiments, a battery cell inspection system can be configured to perform ultrasound interrogation of one or more battery cells. The inspection system can comprise ultrasound transducers, a controller, a transport module, a signal drive and acquisition system (SDM) system, and a data repository. The ultrasound transducers can be configured to: direct ultrasound at target points of the battery cell target point in response to the ultrasound transducers receiving excitation signals; to detect the ultrasound directed at the target points that is either reflected from or transmitted through the battery cell; and to generate response signals based upon the detected ultrasound. The controller and the transport module can be configured to transport the ultrasound transducers without transporting the battery cell, or to transport the battery cell without transporting the ultrasound transducers, to thereby align the one or more ultrasound transducers with the target points.

In some embodiments, the SDM can be configured to generate the excitation signals and to receive the response signals corresponding with the ultrasound interrogation of the battery cell at the target points, and the data repository stores data corresponding with the response signals associated with the interrogation of the battery cell at the target points. In the inspection system, the ultrasound transducers and the battery cell can be immersed in an electrically non-conducting fluid (e.g., dielectric or insulating fluid) during the directing of the ultrasound and the detection of the ultrasound.

In some embodiments, a method for inspecting one or more battery cells may be provided. The method can comprise configuring a predetermined number of target points on surfaces of the battery cell, interrogating the battery cell by transmitting ultrasound signals into the battery cell at each of the target points, detecting ultrasound reflected from and/or transmitted through the battery cell at each of the target points, and generating response signals from the detected ultrasound at each of the target points. The interrogation of the battery cell can be performed while the battery cell is immersed in an electrically non-conducting fluid. The method can also comprise creating a hyper pixel for each target point, where each hyper pixel includes a representation of the response signals at each target point, and determining characteristics of the battery cell(s) based upon the hyper pixels for each target point.

For example, in some embodiments, multiple response signals or values can be associated with each hyper pixel, and an analysis can be performed on these signals/values (e.g., by calculating and/or extracting features). In some embodiments, the results of this analysis, in addition to or in place of the original signals/values of the hyper pixel, can be used in further analysis. Alternatively or additionally, in some embodiments, the information derived and/or created from the hyper pixels can be compiled into an n-dimensional matrix or map (where n is greater than or equal to 2), for example, a 2D or 3D anomaly map.

In some embodiments, a battery cell inspection system can be configured to perform ultrasound interrogation of one or more battery cells. The inspection system can comprise ultrasound transducers, a controller, a transport module, a signal drive and acquisition system (SDM), and a processing system. The ultrasound transducers can be configured to direct ultrasound at target points of each battery cell in response to the ultrasound transducers receiving excitation signals, to detect the ultrasound directed at the target points that is either reflected from or transmitted through each battery cell, and to generate response signals based upon the detected ultrasound. The controller and the transport module can be configured to transport the ultrasound transducers without transporting the battery cell, or to transport the battery cell without transporting the ultrasound transducer, to thereby align the ultrasound transducers with the target points. The SDM can be configured to generate the excitation signals and to receive the response signals corresponding with the ultrasound interrogation of the target points, and to forward the response signals to the controller. The controller can create a hyper pixel for each of the target points, and wherein each hyper pixel can include a representation of the response signals generated for each of the target points. The ultrasound transducers and the battery cell can be immersed in an electrically non-conducting fluid during the directing of the ultrasound and the detection of the ultrasound. The processing system can be configured to receive the hyper pixels from the controller and to determine information concerning the battery cell based upon the hyper pixels.

In some embodiments, an inspection system for monitoring one or more battery cells during cell formation can comprise a sensing fixture, a formation chamber, at least one MEMS ultrasound transducer module, and a processing system. The sensing fixture can include a housing that accepts the one or more battery cells. The formation chamber can be configured to receive the sensing fixture and to enable formation of the one or more battery cells within the sensing fixture. At least one MEMS ultrasound transducer module can be associated with each battery cell. The at least one MEMS ultrasound transducer module can be configured to perform ultrasound interrogation of the associated battery cell during the formation of the one or more battery cells.

In some embodiments, the ultrasound interrogation can include: directing ultrasound at the battery cell in response to receiving an excitation signal; detecting the ultrasound directed at the battery cell that is either reflected from or transmitted through the battery cell; and generating a response signal based upon the detected ultrasound. The processing system can be configured to receive the response signals from the at least one MEMS ultrasound transducer module, and to determine characteristics of the one or more battery cells based on the response signals.

In some embodiments, a method for monitoring one or more battery cells during cell formation can comprise providing a sensing fixture including a housing accepting battery cells. The method can further comprise providing a formation chamber that receives the sensing fixture. The formation chamber can enable the formation of the battery cells within the sensing fixture. The method can also comprise interrogating each battery cell using at least one MEMS ultrasound transducer module associated with each battery cell.

In some embodiments, when interrogating the battery cell, the at least one MEMS ultrasound transducer module can be configured to perform ultrasound interrogation of the battery cell during the formation thereof. The ultrasound interrogation can comprise: directing ultrasound at each battery cell in response to receiving an excitation signal; detecting the ultrasound directed at each battery cell that is either reflected from or transmitted through each battery cell; and generating a response signal based upon the detected ultrasound. The method can also comprise receiving the response signals from the at least one MEMS ultrasound transducer module, and determining characteristics of the battery cell based on the response signals.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the disclosed subject matter. The features of the disclosed subject matter will best be understood from the following detailed description and example embodiments thereof selected for the purposes of illustration and shown in the accompanying drawings in which:

FIG. 1 is a schematic diagram of a high speed, ultrasound-based battery cell inspection system (“inspection system”) configured to assess characteristics of battery cells at a customer facility, according to one or more embodiments of the disclosed subject matter, where the system includes a processing system, a data repository, a controller, a signal drive and acquisition system (SDM), and an enclosure, and where the figure shows a top view of a portion of the enclosure, and the processing system is local to the customer facility;

FIG. 2 is a schematic diagram of an inspection system similar to FIG. 1, where the data repository and the processing system are instead located on a remote network at a service provider, according to one or more embodiments of the disclosed subject matter;

FIG. 3 is a top view of the inspection systems of FIGS. 1 and 2 that shows more detail of the enclosure and a transport module within the enclosure, according to one or more embodiments of the disclosed subject matter, where the transport module is configured to transport each battery cell through a tank that extends across a length of the enclosure and that is filled with an electrically non-conductive fluid, and the inspection system is configured to perform an ultrasound interrogation session of each battery cell via opposing ultrasound modules included within and mounted to inside surfaces of the tank;

FIG. 4 is a perspective view of the enclosure in FIG. 3;

FIG. 5 is an enlarged perspective view of the tank that shows multiple pairs of ultrasound modules included within the tank and shows an interrogation zone, according to one or more embodiments of the disclosed subject matter;

FIG. 6 is a schematic diagram of the inspection systems of FIGS. 1-5, according to one or more embodiments of the disclosed subject matter, where the figure shows more detail for the data repository and shows a side cross-sectional view of the tank and the interrogation zone when viewed from a left side of the enclosure;

FIG. 7 is a flowchart that lists method steps corresponding with operation of the inspection systems in FIGS. 3 and 4;

FIG. 8 is a flowchart that provides more detail for the flowchart of FIG. 7 and lists method steps associated with performing an ultrasound interrogation session of each battery cell in the interrogation zone;

FIG. 9 is a schematic diagram of another exemplary inspection system, according to one or more embodiments of the disclosed subject matter, where some of the components are located at the customer facility and others are located at a service provider, and where the figure shows a side cross-sectional view of the tank and interrogation zone when viewed from a left side of the enclosure, and where the inspection system is configured to perform an ultrasound interrogation session of each battery cell within the zone by placing each battery cell to be stationary within the zone, and instructing a robotic arm of the transport module to move opposing ultrasound transducers relative to each battery cell;

FIG. 10 is a perspective view of yet another inspection system, according to one or more embodiments of the disclosed subject matter, where the system is a portable version of the system in FIG. 9;

FIG. 11 is a schematic diagram of another exemplary inspection system at a customer facility, according to one or more embodiments of the disclosed subject matter, where the figure shows a side cross-sectional view of the tank and interrogation zone when viewed from a left side of the enclosure, and where the inspection system is configured to perform an ultrasound interrogation session of each battery cell within the zone by instructing a robotic arm of the transport module to grasp and move each battery cell between opposing ultrasound transducer modules in the zone;

FIGS. 12A-12B are images of opposing sides of an exemplary prismatic battery cell;

FIG. 12C is a table that lists properties of the battery cell in FIGS. 12A and 12B;

FIG. 13A is a schematic diagram of an exemplary battery cell shown in perspective, where predetermined target points configured by the inspection system are shown notionally superimposed upon a side of the battery cell;

FIG. 13B is an exploded perspective view of a portion of the battery cell of FIG. 13A showing an exemplary distribution of a portion of the target points;

FIGS. 14-15 illustrate components of the inspection systems of FIGS. 9-10 and illustrate method steps for performing an interrogation session upon a battery cell;

FIG. 16 is a flowchart that provides additional method steps corresponding with the method of performing the interrogation session of FIGS. 14 and 15;

FIG. 17 is a flowchart that provides alternative method steps corresponding with performing the interrogation session of FIGS. 14 and 15, where the flowchart describes another implementation of the processing system for determining defects of or within the battery cell, using machine learning and a pre-trained machine learning model;

FIG. 18 is a flowchart that describes a method of the processing system for training a machine learning model to detect defects in a type of battery cells being interrogated, where the trained machine learning model can be used in the method of FIG. 17;

FIG. 19 is a flowchart that provides additional method steps corresponding with the method of FIGS. 14 and 15, for implementation of the processing system for inferring anomalies of or within the battery cells being interrogated, using machine learning and a pre-trained machine learning model;

FIG. 20 is a flowchart that describes additional method steps corresponding with training a machine learning model based on the type of batteries being interrogated, and to infer anomalies in battery cells being interrogated, where the trained machine learning model can be used in the method of FIG. 19;

FIG. 21 is a flowchart that describes additional method steps corresponding with performing an additional “second pass” ultrasound interrogation session upon a battery cell, after the inspection system has identified the battery cell as including defects or anomalies in a prior interrogation session of the cell, and where the processing system can analyze the information obtained during the additional interrogation session to refine the identified defects or anomalies;

FIG. 22 is a schematic diagram showing an enlarged perspective view of a portion of the battery cell in FIG. 13B, where the diagram shows additional information associated with the battery cell that the method steps of FIG. 21 can use to perform the additional interrogation session of a region of the battery cell;

FIG. 23 is a block diagram showing more detail for the processing system and its components, according to one or more embodiments of the disclosed subject matter;

FIG. 24 is a schematic diagram that shows: opposing ultrasound transducers of the inspection system respectively transmitting ultrasound through a battery cell and sensing ultrasound exiting from a selected target point of the battery cell during an interrogation session; a graphical representation of response signals/hyper pixel values that the inspection system creates for each of the target points during the interrogation session; and a 2D anomaly map image (“anomaly map”) that the processing system can create based on the hyper pixels;

FIG. 25 is an exemplary anomaly map of a battery cell that shows defects in the battery cell, according to one or more embodiments of the disclosed subject matter;

FIG. 26A shows an exemplary hyper pixel dataset in tabular format on the left side of the figure, which includes hyper pixels and values for each of the hyper pixels obtained for a battery cell during an ultrasound interrogation session, and shows an exemplary ultrasound features table on the right side of the figure that includes ultrasound features extracted from the hyper pixels, where the processing system is configured to extract the ultrasound features from the hyper pixels, and to create anomaly maps of the battery cell based upon the contents of the hyper pixels and/or the ultrasound features;

FIG. 26B shows: a portion of a transmitted signal table on the left side of the figure for the same battery cell in FIG. 26A, where the table includes transmitted ultrasound signals sent to a single target point of the battery cell during the interrogation session; a portion of the hyper pixel dataset of FIG. 26A on the right side of the figure, where the portion is limited to the single hyper pixel and its hyper pixel values associated with the single target point; and an exemplary ultrasound features table at the bottom of the figure that includes ultrasound features calculated from the transmitted signals and the hyper pixel values, where the processing system is configured to calculate the ultrasound features from the transmitted signals and the hyper pixel values, and to create anomaly maps of the battery cell based upon the contents of the hyper pixels and/or the ultrasound features;

FIG. 27A is a flowchart that describes method steps of the processing system, according to one or more embodiments of the disclosed subject matter, the method steps corresponding with creating anomaly maps from hyper pixels of a battery cell and creating defect images from the anomaly maps, where the defect images include and identify defects in the battery cell;

FIG. 27B graphically illustrates elements corresponding with the method steps of FIG. 27A;

FIG. 28 is a table that lists various defects that the inspection systems can detect in battery cells and presents detailed information associated with each defect including a description, a result of the defect, and images associated with the defect, according to one or more embodiments of the disclosed subject matter;

FIGS. 29A-29F are anomaly maps that each show different defects within battery cells, where: FIGS. 29A and 29B show gas pocket defects between a housing of a battery cell and an adjacent layer of the multiple anode-separator-cathode layers of the cell; FIGS. 29C and 29D show severe wrinkling defects of an electrode (e.g., anode or cathode) of a layer; and FIGS. 29E and 29F show interlayer anomaly defects that can occur from lithium plating of electrodes or other unwanted reactions;

FIGS. 30A-30D are images associated with severe wrinkling of electrode defects in a battery cell, where: FIG. 30A is anomaly map of the battery cell that shows instances of the wrinkling across nearly 30% of its volume; FIG. 30B is an image of an X-ray computed tomography scan (CT scan image) of the same battery cell that shows the same defect for validation and/or calibration purposes; FIG. 30C is a photographic image of the same battery cell taken after the battery cell was destructively torn down that also shows the defect, for validation and/or calibration purposes; and FIG. 30D shows an enhanced image of the defect in FIG. 30C;

FIGS. 31-34 are images associated with a separator layer wrinkle defect and an anode delamination defect in a battery cell, where: FIG. 31 is a defect image rendered by the inspection system that shows both defects; FIG. 32 is a magnified photographic image of the same defect, taken after a destructive teardown of the cell; FIG. 33 is another defect image that shows only the anode delamination defect; and FIG. 34 is a magnified photographic image of the anode delamination defect taken after a destructive teardown of the cell;

FIGS. 35A-35C are additional images associated with separator wrinkle and anode delamination defects in a battery cell, where FIG. 35A is defect image produced by the inspection system for the defects, and FIGS. 35B and 35C are different photographic images of the cell taken after a destructive breakdown of the cell that show both defects;

FIGS. 36A-36C are images associated with salt deposition and anode delamination defects in a battery cell, where FIG. 36A is a defect image of the cell produced by the inspection system for the defects, and FIGS. 36B and 36C are different photographic images of the cell taken after a destructive breakdown of the cell that show the salt deposition defect only;

FIGS. 37A-37C are images that show severe wrinkling of electrode defects and vertical spot defects in a battery cell, where: FIG. 37A is anomaly map of the battery cell that shows both the wrinkling and the vertical spot defects; FIG. 37B is a CT scan image of the same battery cell that shows indicia of only the wrinkling defect for validation and/or calibration purposes; and FIG. 37C is a photographic image of the same battery cell taken after the battery cell was destructively torn down that shows only the vertical spot defect;

FIGS. 38A-38C are images that show a vertical pattern defect related to electrode delamination and layer thickness deviations in a battery cell, where: FIG. 38A is anomaly map of the battery cell that shows the defect; and FIGS. 38B and 38C are photographic images of the same battery cell taken after the battery cell was destructively torn down that show the defect, where FIG. 38B shows the defect on an outside layer of the anode/separator/cathode layers, and FIG. 38C shows the defect on the bag that houses the layers;

FIGS. 39A-39B are images that show severe wrinkling of electrode defects in a battery cell, where: FIG. 39A is anomaly map of the battery cell that shows the wrinkling defect; and FIG. 39B is a CT scan image of the same battery cell that shows indicia of the wrinkling defect for validation purposes;

FIG. 40 is a top view of an exemplary sensing fixture constructed for use in a battery cell inspection system designed for monitoring battery cells during formation of the battery cells, and where the sensing fixture is preferably designed to accept prismatic battery cells and to monitor the cells via ultrasound transducer modules configured for echo mode operation;

FIG. 41 is a schematic diagram showing various components of an exemplary inspection system for monitoring battery cells during and after the cell formation process, according to one or more embodiments of the disclosed subject matter, where the components include a sensing fixture similar to the fixture of FIG. 40, a formation chamber configured to accept the sensing fixture, a system controller, a battery management system (“BMS”), a processing system and a signal drive and acquisition system (“SDM”), and where the sensing fixture is shown loaded into a front of the formation chamber;

FIG. 42 is a flowchart that describes a method of operation of an exemplary inspection system as in FIG. 41 that is constructed according to one or more embodiments of the disclosed subject matter, where the method describes the ability of the inspection system to monitor battery cells during and after the formation process of the cells using ultrasound;

FIG. 43 shows a top view of another sensing fixture, according to one or more embodiments of the disclosed subject matter, which is designed to accept and monitor cylindrical battery cells;

FIG. 44 is a schematic diagram of another inspection system for use during and after formation of battery cells, according to one or more embodiments of the disclosed subject matter, where its sensing fixture includes additional ultrasound transducer modules that enable both echo mode and through-transmission interrogation of the battery cells, for monitoring of the cells during formation of the cells;

FIG. 45 shows a top view of another sensing fixture, according to one or more embodiments of the disclosed subject matter, designed to accept prismatic battery cells, where the sensing fixture is additionally designed to accept removeable boards that include the ultrasound transducer modules;

FIG. 46 is a perspective view of an exemplary transducer board for use in the sensing fixture of FIG. 43, where the transducer board includes a MEMS ultrasound transducer module formed from a plurality of individual capacitive micromachined ultrasonic transducers (CMUT);

FIG. 47 is a front view of a MEMS ultrasound transducer module formed from a plurality of individual CMUT transducers, where the CMUT transducers form a transducer array; and

FIG. 48 is a block diagram of a computing environment in which the described innovations may be implemented.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise. As used herein, the term “and/or” includes any and all combinations of one or more of the associated listed items. It will be further understood that the terms “includes,” “comprises,” “has,” “including,” “having,” and/or “comprising,” when used in this specification, specify the presence of stated features, integers, steps, operations, elements, and/or components, but do not preclude the presence of addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present, unless explicitly stated otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Reference Number List

The reference numbers below are used throughout this description and the accompanying drawings, unless specifically indicated otherwise:

| REF. No. | DESCRIPTION | REF. No. | DESCRIPTION |
|---|---|---|---|
| 10 | coordinate system | 100 | hyper pixels |
| 12 | palette | 100R | reference hyper pixels |
| 13 | chamber | 100F | defect-free hyper pixels |
| | | 101 | image representation of hyper |
| | | | pixel value (i.e., pixel) |
| 16 | staging conveyor | 102 | first surface (of battery cell) |
| 17 | interrogation conveyor | | |
| 18 | robotic arm | 104 | second surface (of battery cell) |
| 19 | transport module | | |
| 20 | enclosure | 110, 110′ | target point |
| 21 | interrogation direction | 111 | ultrasound feature |
| 22 | interrogation zone | 120 | axial line (passes through target |
| | | | points 110 / 110′) |
| 23 | top (of enclosure) | 170 | central processing unit (CPU) of |
| | | | processing system |
| 24 | tank | 172 | operating system |
| | | | (of processing system) |
| 25 | tank rails | 174 | memory (of processing system) |
| 30 | ultrasound transducer | 176 | network interface |
| | | | (of processing system) |
| 31 | emission face | 180 | classification module |
| | | | (of processing system) |
| 32 | [ultrasound] transducer module | 182 | machine learning module |
| | | | (of processing system) |
| 33 | staging area | 183 | circular sections |
| | | | (of sensing fixture) |
| 34 | [ultrasound] transducer module | 184 | network interface module |
| | | | (of processing system) |
| 35 | bottom (of tank 24) | 200 | data repository |
| 36 | gripper | 210 | target point pair |
| 29 | rails (of enclosure) | 218 | section (of sensing fixture) |
| 37 | transducer connection (to SDM) | 220 | common defects (rows) |
| 38 | gripper rotation axis | 222 | defect information (columns) |
| 15 | rolling path | 223 | sensing fixture |
| 14 | tray | 224 | housing (of sensing fixture) |
| 14-1 | incoming tray | 226 | inside wall |
| | | | (of sensing fixture housing) |
| 14-2 | staging tray | 228 | slots (of sensing fixture) |
| 14-3 | processed cell tray | 240 | customer facility |
| 14-4 | outgoing cell tray | 250 | formation chamber |
| 12E | empty palette | 260 | service provider |
| 28-1 | incoming gantry | 300 | Battery Management System |
| | | | (BMS) |
| 28-2 | outgoing gantry | 350 | local controller |
| 26 | shuttle | 402 | back (of section 218) |
| 38 | gripper rotation axis | 404 | front (of section 218) |
| 39 | top (of battery cell) | 702 | housing (of battery cell) |
| 40 | ultrasound transducer | 704 | bag |
| 42 | [ultrasound] transducer module | 730 | area of interest (in defect images) |
| 44 | acoustic lens | 800 | controller / system controller |
| 45 | front (of battery cell) | 802 | target point distance |
| 46 | base | 820 | display |
| 48 | focused beam (of ultrasound) | 840 | drum |
| 47 | transducer connection (to SDM) | 900 | processing system |
| 49 | chamber | 1000, 2000, | interrogation system |
| | | 3000, 4000, | |
| | | 5000, 6000, | |
| | | 7000 | |
| 51 | bottom (of tank / base) | 1035 | battery cell |
| | | 1090 | signal drive and acquisition |
| | | | module (SDM) |
| | | 1135 | temperature sensor |
| 54 | gripper pivot | 1202 | anomaly map image |
| | | | (“anomaly map”) |
| 55 | back (of battery cell) | 1204 | algorithm |
| 56 | gripper rotational movement | 1205 | reference indicating application |
| | direction | | of one or more algorithms to an |
| | | | anomaly map |
| 58 | vertical movement direction | 1206 | photographic image |
| | (of transport module) | | (of battery cell) |
| 59 | shaft (of transport module) | 1207 | reference indicating result of |
| | | | application of one or more |
| | | | algorithms to an anomaly map |
| 60 | horizontal movement direction | 1209 | reference indicating creation of a |
| | (of transport module) | | defect report |
| 119X, | pixel dimensions | 1210 | CT scan image |
| 119Y | | | |
| 61 | tank offset distance | 1302 | defect (of battery cell) |
| 62 | electrically non-conductive fluid | 1304 | defect area |
| 64 | local network | 1306 | enlarged defect area |
| 74 | tank length | 1055 | transmission axis |
| 75 | machine learning model | 1310 | defect image |
| 76 | defect mask | 1320 | charge distribution defects |
| | | | (within defect images) |
| 77 | left side (of enclosure) | 1380 | defect area target points |
| 78 | front (of enclosure) | 1382 | nearest neighbor target point |
| | | | (to defect area target points) |
| 79 | right side (of enclosure) | 1802 | defect area target point distance |
| 80 | interrogation parameters | 2500 | defect table |
| 81 | back (of enclosure) | 1002 | handle |
| 82 | defect instruction set | C1 . . . CN | columns |
| 101 | pixel | R1 . . . RN | rows |
| 92 | remote network | H | height (of battery cell) |
| | | D | depth (of battery cell) |
| 99 | portion of a battery cell | L | length (of battery cell) |
| 2602 | hyper pixel dataset | 2604 | ultrasound feature table |
| 111 | ultrasound feature | 2606 | transmitted signal table |
| 108 | transmitted signal (ultrasound) | 1309 | defect report |
| 236 | transducer board | 239, 241 | sides (of transducer board) |

### INTRODUCTION

Lithium-ion batteries typically include one or more battery cells immersed in an electrolyte. The battery cells can be arranged in layers within the battery. For example, in a prismatic battery, the layers are arranged horizontally along a length of the battery. Each cell includes the following layers/components: a cathode electrode (cathode), a separator, and an anode cathode (anode). The separator is formed from an electrically insulating material. An additional cell separator is added between each adjacent battery cell.

In some embodiments, a system for inspecting one or more battery cells, such as lithium-ion batteries, can include one or more ultrasound transducer modules. One, some, or each of the one or more ultrasound transducer modules can be configured as one of a standalone ultrasound source, a standalone ultrasound sensor, or a transducer that includes both an ultrasound source and an ultrasound sensor. One, some, or each of the one or more ultrasound transducer modules can also include multiple ultrasound transducers, such as in an array configuration. Additionally and/or alternatively, an ultrasound transducer module configured as an ultrasound sensor might be of a different type (e.g., CMUT, PMUT, etc.) than that of its associated source ultrasound transducer module. Moreover, two or more ultrasound transducer modules might be configured as ultrasound sensors and associated with a single source ultrasound transducer module.

In some embodiments, the inspection system can also include a signal drive and acquisition module (SDM). For example, the SDM can include an excitation or drive signal generator for generating and transmitting an electrical excitation signal to an ultrasound source. In response to receiving the excitation signal, the ultrasound source emits ultrasound. Characteristics of the emitted ultrasound (e.g., ultrasound amplitude, peak frequency, frequency bandwidth, pulse duration, or the like) are largely dependent upon the characteristics of the ultrasound source and of the excitation signal. The emitted ultrasound can be directed at a battery cell (or multiple battery cells). At least a portion of the ultrasound directed at the battery cell passes through the battery cell, echoes from surfaces of the battery cell, and/or is scattered or otherwise attenuated without reaching, or only partially reaching, the ultrasound sensor.

An ultrasound sensor can be disposed to sense the emitted ultrasound after the emitted ultrasound has passed through the battery cell, echoed from one or more surfaces of the battery cell, or indirectly or partially reached the ultrasound sensor. The ultrasound sensor can be configured to generate an electrical signal in response to ultrasound sensed thereby. In some embodiments, the electrical signal is an analog signal corresponding with instantaneous ultrasound amplitude versus time values. Additionally or alternatively, in some embodiments, the ultrasound sensor can be configured with appropriate electronics and an analog-to-digital converter (“A/D converter”) to generate a digital electrical signal. For example, the sensor, the electronics, and the A/D converter might be integrated in a “system on a chip” package or form factor.

In some embodiments, the electrical response signal can be transmitted to the SDM, which can include a response signal module. The response signal module can be configured to receive the electrical response signal from the ultrasound sensor at the end of each interrogation occurrence, and/or to convert the electrical signal into a corresponding digital response signal (hereinafter known as a response signal). The SDM may apply signal processing to the electrical or digital signals to filter, normalize, or otherwise modify signals to provide a response signal suitable for evaluation as a hyper pixel described below. The SDM further includes, or is interfaced with, data storage modules for storing response signals.

In some embodiments, the inspection system can direct ultrasound at or through a battery cell and can detect ultrasound received by ultrasound sensors using one or more ultrasound interrogation modes. The inspection system (e.g., using one or more logic elements) can establish a plurality of predetermined target points spatially distributed over one or more surfaces (e.g., an entire surface) of the battery cell, plus additional areas around the battery cell. Each target point comprises a location to direct the transmitted and received ultrasound signal. The battery cell and/or the various ultrasound transducers can be movable with respect to each other in a manner that allows each battery target point to be interrogated by ultrasound directed toward a preselected target point. Various interrogation modes (e.g., a through transmission mode and/or a pulse-echo transmission mode) can be selected to generate a response signal corresponding with each target point.

The collection of response signals at each target point is referred to herein as a hyper pixel. During an interrogation session, one or more ultrasound pulses are transmitted into each target point for at least a first interrogation mode, and the response signals are collected. This process is repeated for each additional interrogation mode, and the response signals in aggregate for each target point are included in a hyper pixel data structure (“hyper pixel”) for the target point. A representation of the ultrasound signals transmitted at each target point might also be included in the hyper pixel for each target point or be stored separately from the hyper pixels. The processing system then analyzes the hyper pixels for one or more of the target points to determine characteristics of the battery cells.

In some embodiments, each hyper pixel contains one or more values. Each value corresponds with a different response signal obtained for the same target point associated with the hyper pixel. Each response signal, in turn, is associated with a different configuration of interrogation parameters selected at the beginning of an interrogation session. For example, different combinations of selected ultrasound frequencies and interrogation modes (e.g., echo mode and through-transmission mode) will produce different response signals, which are stored as different response signal values for the same hyper pixel.

In some embodiments, the inspection system analyzes the hyper pixels to determine characteristics of the battery cells by extracting, or otherwise isolating, ultrasound features of the response signals of each hyper pixel. The isolated features are then analyzed in one or more various domains (e.g., a spatial domain, energy domain, resonant or non-resonant domain, a time domain, a frequency domain, a context domain, and/or others) in order to characterize one or more features of the response signal. Since isolated ultrasound features of the response signal may correspond with a plurality of different defects associated with a battery target point or target points, characterization of the one or more isolated features further includes analyzing each isolated feature of the response signal using different analyzing techniques, each corresponding with one or more of the of different defects of the battery target point.

In some embodiments, the inspection system is configured to analyze each of the response signals for each of the hyper pixels. This analysis can include the ability to evaluate ultrasound features of the response signal; classify characteristics of the response signal, e.g., according to defect type; select one or more rules corresponding with separately analyzing ultrasound features of the response signal, e.g., according to defect type; and/or other features of the response signal. As will be described below and elsewhere herein, the one or more rules can be based on correlation with response signal features generated from a plurality of battery cells of the same type (e.g., hundreds, or even thousands of battery cells) that have been evaluated by ultrasound interrogation and then, destructively broken down and shown to deterministically match response signal features with defects and anomalies found to be present in the test battery cells.

With respect to the anomalies, known response signals have specific properties when encountering different materials under different conditions, and thus the anomalies can be inferred. Alternatively or additionally, the response signals can be compared to/correlated with CT scan images of the same battery cells. In this way, validation of the defects and anomalies determined by the inspection system, and calibration of the inspection system, are possible. Alternatively or additionally, validation of the characteristics determined by the inspection system (e.g., defects and anomalies) can be accomplished by matching the characteristics against battery simulations which virtually represent each battery cell. For this purpose, in one example, the battery simulations/virtual battery cells are obtained by training one or more machine learning models with training data that includes response signals obtained by the inspection system using battery cells of a same type. The training data might also include a representation of the transmitted ultrasound signals directed at each target point that resulted in the response signals detected at each target point. In another example, training data associated with battery cells of different types may be used. In yet another example, training data associated with battery cells having a same, known defect are used to create simulated “defect masks” associated with battery cells having the same defect. In still another example, training data associated with battery cells having no known defects are provided as input to the one or more machine learning models, to create defect-free virtual battery cells. Then, response signals obtained by the inspection system for new/untested battery cells can be provided as input to the various [trained] virtual battery cells for validation and/or calibration purposes.

In some embodiments, during the analysis of the hyper pixels, the processing system may create one or more n-dimensional data structures or representations (where n≥2) from the hyper pixels as an intermediate step, for example, two dimensional (2D) or three dimensional (3D) images. The 2D or 3D images are also known as anomaly maps. An anomaly map is an image representation of the battery cell that the inspection system renders from the hyper pixels. The processing system may then determine the characteristics of the battery cells based upon the data representations (e.g., anomaly maps). For this purpose, the processing system may apply one or more rules for generating a data representation (e.g., anomaly map), and generate an image representation of the result, also known as a defect image. The signal processing techniques associated with analyzing each response signal have been experimentally shown to isolate and identify specific defects in anomaly maps. Each defect image isolates and identifies one or more specific characteristics, such as defects, anomalies, and/or charge distribution levels.

In some embodiments, the inspection system can be used to determine defects and/or anomalies both during and after the electrolyte soaking of the formation stage. Here, the system can detect and label processing and material anomalies including, but not limited to: dry zones due to inadequate soaking during an electrolyte wetting stage; wrinkles present in the separator, anode, and/or cathode; contaminants (e.g., shavings, splattering, etc.); alignment of battery cell layers (anode, cathode, and/or separator); inactive zones and residual gas after a formation stage; and instances of separator tears, tears and wrinkles in layers, and layer misalignment and delamination, in examples. In other examples, the defects can include a material distribution non-uniformity, micro shorts, soft shorts, lithium plating, and indicia of improper or non-uniform charge distribution. In some embodiments, faces of the ultrasound transducers can be in contact with the battery cells, with or without a couplant (e.g., gel or dry couplant) located therebetween.

In some embodiments, the inspection system can be a non-contact immersion ultrasound evaluation system. For this purpose, the system includes one or more ultrasound sensors that, along with the battery cell, are immersed in an electrically non-conductive fluid during testing. In such a system, the ultrasound sensors do not come into contact with surfaces of each battery cell during testing; rather, emission faces of the transducers are located at a distance from the surfaces of the battery cells, and the non-conductive fluid operates as a couplant. In examples, the non-conductive fluid can be a dielectric fluid, deionized water, a hydrocarbon (e.g., mineral oil), or aqueous solutions of ethylene glycol. For example, the non-conductive fluid can have a resistivity of at least 1 MΩ-cm (e.g., as measured by ASTM D1169-19A, “Standard Test Method for Specific Resistance (Resistivity) of Electrical Insulating Liquids,” and/or ASTM D1193-06, “Standard Specification for Reagent Water,” both of which are incorporated by reference herein).

In some embodiments, the transmitted ultrasound can be formed into a focused beam at one, some, or each of the target points. For this purpose, in one example, one or more ultrasound focusing elements may be attached to the emission face of a transducer or positioned between the transducer and its respective target point. The focusing element(s) can be selected to modify the transmitted ultrasound, e.g., to focus the ultrasound at a particular point (e.g., a battery cell target point) and/or to collimate or otherwise reshape the ultrasound at a particular point. The focusing element(s) can reshape the ultrasound at a particular point into an ultrasound image corresponding with a response signal, in one example. Alternatively or additionally, a face of one, some, or each of the transducers may be configured to focus the ultrasound into focused beams. For example, the face of the transducer can be formed of and/or comprise a ceramic, and the face of the transducer can be formed into a convex shape (e.g., the shape of a bowl).

In some embodiments, the characteristics of the battery cell that the inspection system can determine can include battery cell capacity, a predicted capacity fade over a predetermined number of battery cell cycles, overall performance and charge distribution mapping, in examples.

### Inspection System Examples

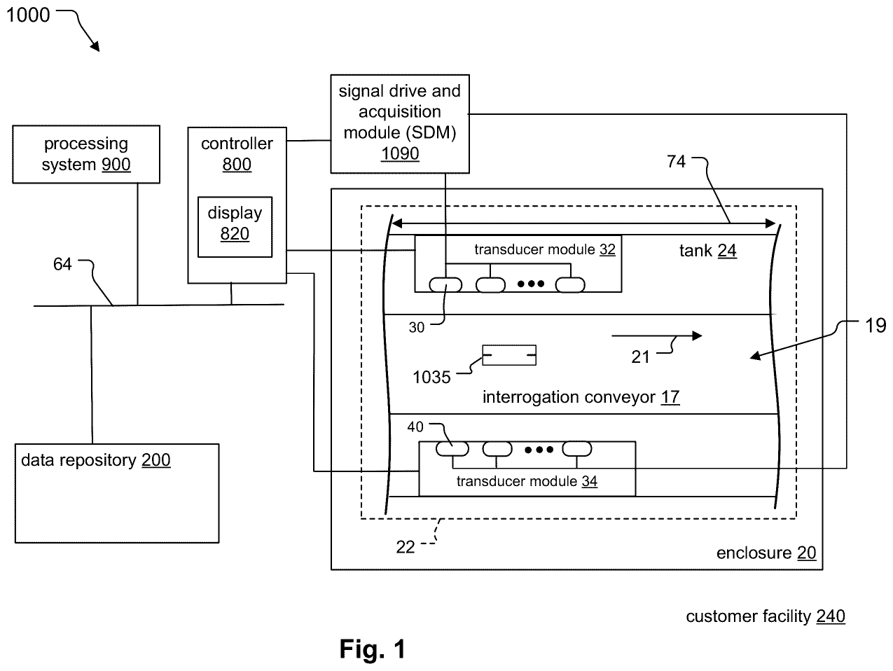

FIG. 1 shows a battery cell inspection system (“inspection system”) 1000 configured to assess characteristics of battery cells 1035, according to one or more embodiments. The inspection system 1000 is designed for use in a customer facility 240, such as a battery cell manufacturing facility that manufactures and/or assembles battery cells. The inspection system 1000 has various components, including, for example, an enclosure 20, a processing system 900, a controller 800, a signal drive and acquisition system (SDM) 1090, and a data repository 200. In the illustrated example, the enclosure 20 includes a tank 24, a pair of opposing transducer modules 32, 34, and an interrogation conveyor 17. A battery cell 1035 is shown on the interrogation conveyor 17, which can be a component of a transport module 19 of the system 1000 that is also housed by or otherwise included in the enclosure 20.

The controller 800 can include a display 820, and each of the transducer modules 32, 34 can include two or more ultrasound transducers. For example, transducer module 32 includes ultrasound transducers 30 and transducer module 34 includes ultrasound transducers 40. In some embodiments, the transducer modules 32, 34 also include or otherwise connect to sensors that detect the battery cells 1035. In some embodiments, the transducer modules 32, 34 can be and/or comprise transducer arrays.

The inspection system 1000 can be arranged as follows. The processing system 900, the controller 800, and the data repository 200 can connect to and communicate over a local area network 64, such as Gigabit Ethernet or other high-speed local network. The controller 800 can connect to the SDM 1090 and to the transducer modules 32, 34. The SDM 1090 can connect to each of the ultrasound transducers 30, 40.

In the illustrated example of FIG. 1, only a portion of the enclosure 20, the tank 24, and the interrogation conveyor 17 are shown, and are viewed from a top 23 of the enclosure 20. The transducer modules 32, 34 are included within the tank 24 and are mounted on opposing inside walls/surfaces of the tank 24 along its tank length 74. The tank 24 is filled with an immersive couplant that is electrically non-conductive, such as deionized water. An interrogation zone 22 within the enclosure 20 is also shown. As its name suggests, the interrogation zone 22 is an area within the enclosure 20 where the battery cells 1035 undergo ultrasound scanning/interrogation. The interrogation zone 22 includes the transducer modules 32, 34, a portion of the tank 24 that includes the modules 32, 24, and a portion of the interrogation conveyor 17 that includes the modules 32, 34.

The inspection system 1000 can perform interrogation sessions of battery cells 1035 as follows. The interrogation conveyor 17 moves each battery cell 1035 in an interrogation direction 21 through the tank 24 along its tank length 74, and across the interrogation zone 22. For this purpose, the interrogation conveyor 17 moves each battery cell sequentially through the interrogation zone 22 (e.g., at a constant rate of speed), during which each battery cell 1035 is immersed in the fluid within the tank 24, and sides of each battery cell 1035 facing the transducer modules 32, 34 do not come into contact with the transducers 30, 40. When each battery cell 1035 enters the interrogation zone 22, sensors within (or associated with) the transducer modules 32, 34 detect each battery cell 1035 and send a signal to the controller 800. In response, the controller 800 instructs the SDM 1090 to send excitation signals to transducers 30, 40 configured as ultrasound transmitters. In response to receiving the excitation signals, the transducers 30, 40 configured as ultrasound transmitters transmit ultrasound into the battery cell 1035.

The transducers 30, 40 configured as ultrasound receivers detect ultrasound transmitted through or reflected by the battery cell 1035, generate electrical response signals representing the detected ultrasound, and send the response signals to the SDM 1090. The SDM 1090 forwards the response signals to the controller 800, which collects the response signals for each battery cell 1035 and forwards them to the processing system 900 for analysis. The processing system 900 then determines characteristics of the battery cell based at least upon the response signals for that battery cell. These characteristics include defects and anomalies, in examples.

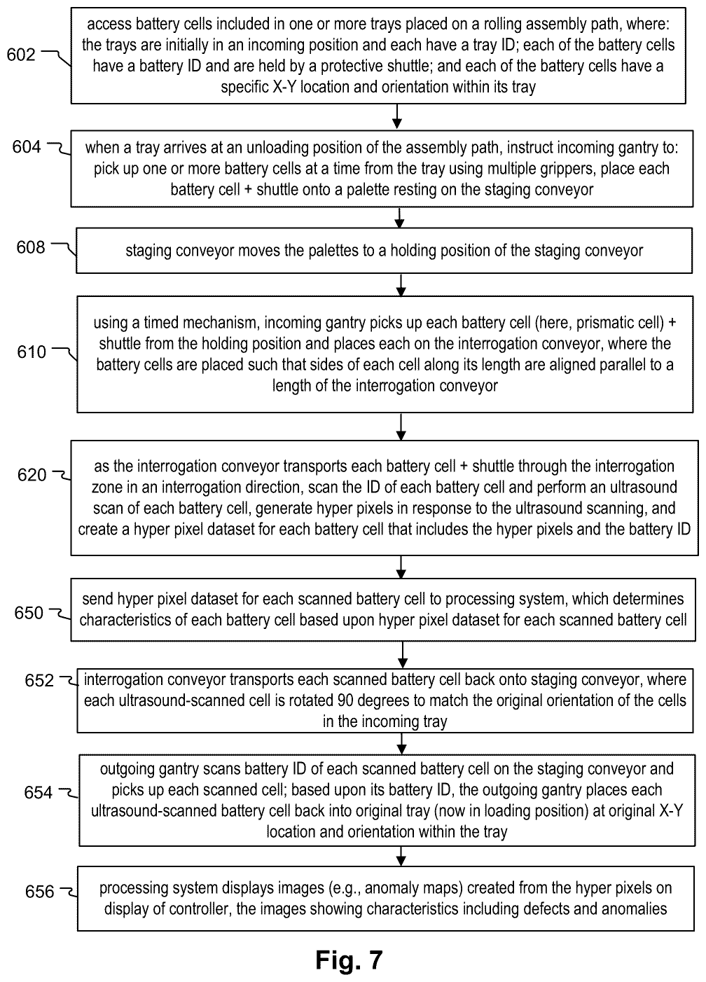

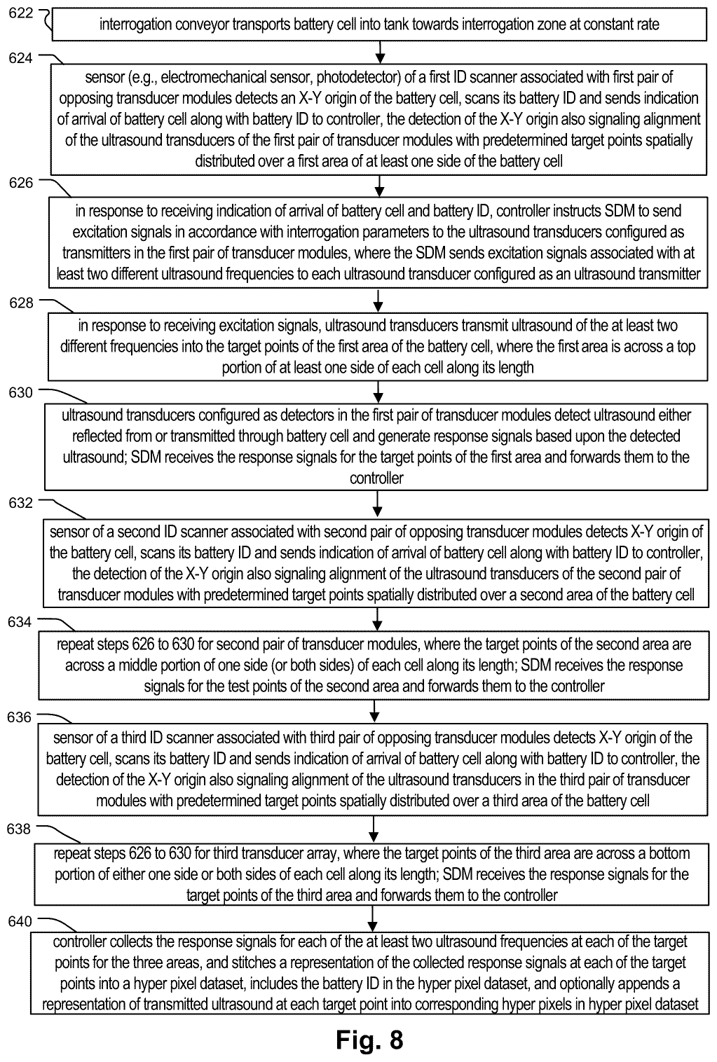

In some embodiments, the inspection system 1000 can have a throughput rate in a range of about 10 to about 55 battery cells per minute, inclusive, and/or otherwise configured in accordance with customer requirements. Throughput rate is the rate at which the inspection system performs the interrogation session upon, and determines the characteristics of, the battery cell 1035. Experimentation has also shown that the inspection system 1000 can attain a throughput rate of 55 battery cells per minute and greater. More detail for operation of the inspection system 1000 is provided at least in association with FIGS. 7-8, the descriptions of which are included herein below.

While the processing system 900, data repository 200, controller 800 and SDM 1090 are shown separate from the enclosure 20, the enclosure 20 can also include or otherwise house these components, according to one or more contemplated embodiments. In some embodiments, the controller 800 and processing system 900 can be combined into a single computing device, for example, to minimize communications overhead and maximize processing speed.

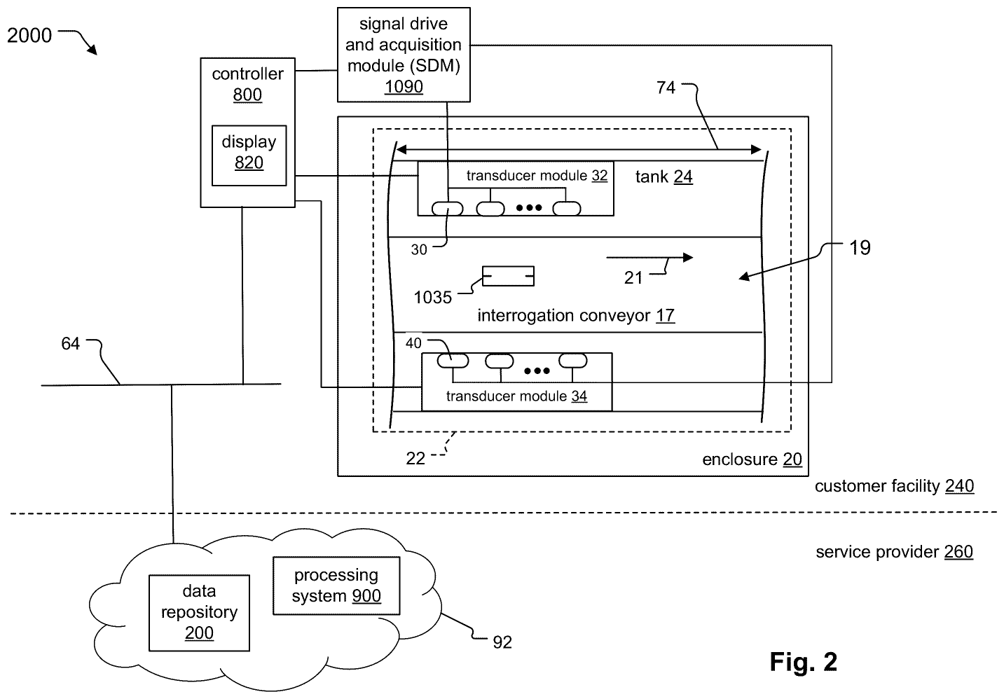

FIG. 2 is another inspection system 2000 that includes substantially the same components and operates in substantially a similar fashion as the inspection system 1000 of FIG. 1. However, there are differences. For example, the controller 800, SDM 1090, and enclosure 20 can be installed at the customer facility 240 and collectively form a test platform of the inspection system 2000, while the data repository 200 and processing system 900 can be located in a remote network 92 at a service provider 260. The test platform uses data and processing resources provided by a service provider 260 via the remote network 92. The resources of the remote network 48 can be included as part of a cloud-based computing and storage service, such as Amazon Web Services (AWS), IBM Cloud Services, and Microsoft Cloud Services, in examples. As compared to the inspection system 1000 of FIG. 1, the interrogation system 2000 can require fewer components installed at the customer premises 220. Instead, the test platforms installed at different customer premises 220 can access remote data and processing resources that are managed by a common service provider or different service providers. The remote data and processing resources provided by the service provider 260 for each customer can be isolated (e.g., firewalled) from one another and/or can be configured in different ways. The service provider 260 can provide a similar set of services to all customers as a default, and then tailor the services to each customer based upon their needs.

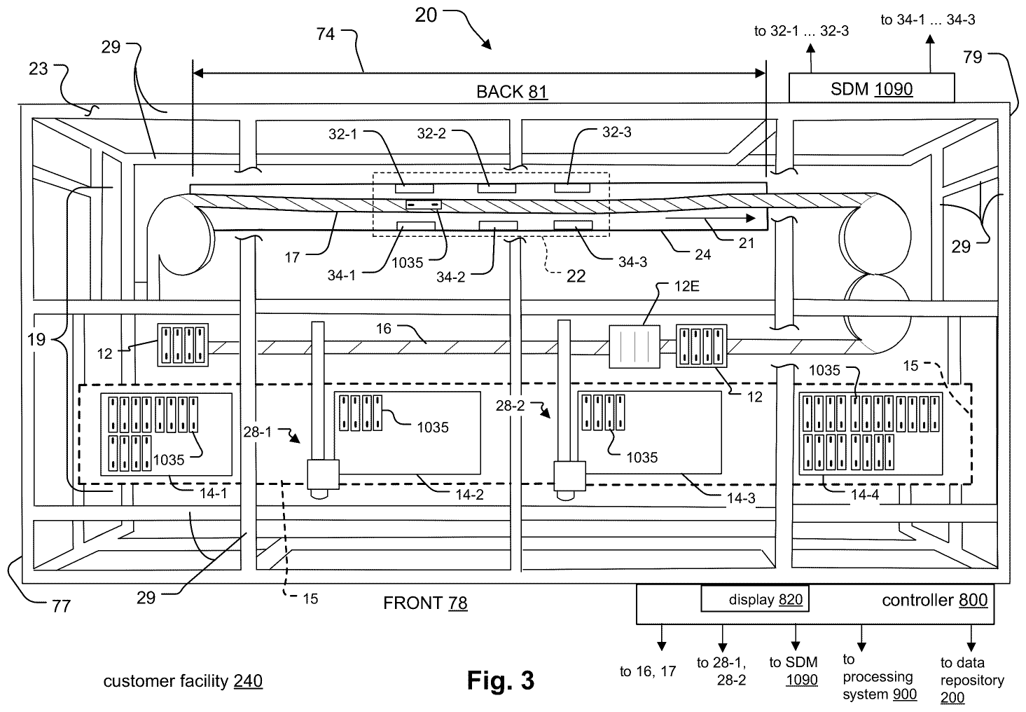

FIG. 3 shows more detail for an inspection system than could be shown in FIGS. 1 and 2. In the illustrated example, the enclosure 20 is viewed from a top 23 of the enclosure, with a front 78 of the enclosure 20 located at the bottom of the figure. The enclosure 20 also has a left side 77 and a right side 79. In the illustrated example, the enclosure 20 is substantially cuboid/has a substantially rectangular prism shape and is constructed in a chassis form factor. For this purpose, the enclosure 20 has multiple rails 29 that connect in a modular and/or adjustable fashion. The rails 29 provide support for components within the enclosure 20 and enable attachment of components to the enclosure 20. Spaces/gaps between the rails 29 allow operators of the system 1000 to access the components and monitor operation of the system.

Additional components of the transport module 19 are visible in the figure. These components include a staging conveyor 16, an incoming gantry 28-1, an outgoing gantry 28-2, a rolling path 15, trays 14, and palettes 12. The rolling path 15 extends from the left side 77 of the enclosure 20 to its right side 79 and is located near the front 78 of the enclosure 20. The trays 14 rest upon the rolling path 15 and hold multiple battery cells 1035 in a specific X-Y location and orientation within each tray 14. The trays 14 include an incoming tray 14-1, a staging tray 14-2, a processed cell tray 14-3, and an outgoing tray 14-4. The palettes 12 hold a smaller amount of battery cells 1035 than do the trays 14 and are placed upon the staging conveyor 16. For example, the palettes 12 can hold 4 or 6 battery cells 1035 (or any other number of battery cells that may be convenient). The battery cells 1035 are placed in the palettes 12 just prior to placing the battery cells 1035 on the interrogation conveyor 17. An empty palette 12E is also shown in FIG. 3.

In the illustrated example of FIG. 3, the tank 24 is substantially rectangular in shape, is open at its top, and is longest along its tank length 74. The tank is located near the back 81 of the enclosure 20. Three pairs of opposing ultrasound transducer modules (“transducer module”) are also shown and are arranged to be substantially parallel with inside walls of the tank 24 along the tank length 74. Of the three pairs, a first pair includes transducer module 32-1 and 34-1, a second pair includes transducer module 32-2 and 34-2, and a third pair includes transducer module 32-3 and 34-3. Each of the transducer modules 32-1, 32-2, 32-3 and 34-1, 34-2 and 34-3 can include at least two ultrasound transducers. In the illustrated example, transducer modules 32-1, 32-2 and 32-3 are included within the tank 24, are attached to an inside wall of the tank 24 nearest to the back 81 of the enclosure 20, and are arranged from left to right along the tank length 74. In a similar vein, transducer modules 34-1, 34-2 and 34-3 are included within the tank 24, are attached to an inside wall of the tank 24 nearest to the front 78 of the enclosure 20 and are arranged from left to right along the tank length 74. Transducer modules 32-1 and 34-1 of the first pair oppose one another; transducer modules 32-2 and 34-2 of the second pair oppose one another; and transducer modules 32-3 and 34-3 of the third pair oppose one another. All three pairs are included within the interrogation zone 22.

The tank 24 can be filled with an electrically non-conductive fluid (not visible in the figure) and the transducer modules 32, 34 can be immersed in the fluid. More detail for operation of the inspection system 1000 is provided at least in association with FIGS. 7-8, the descriptions of which are included below and elsewhere herein.

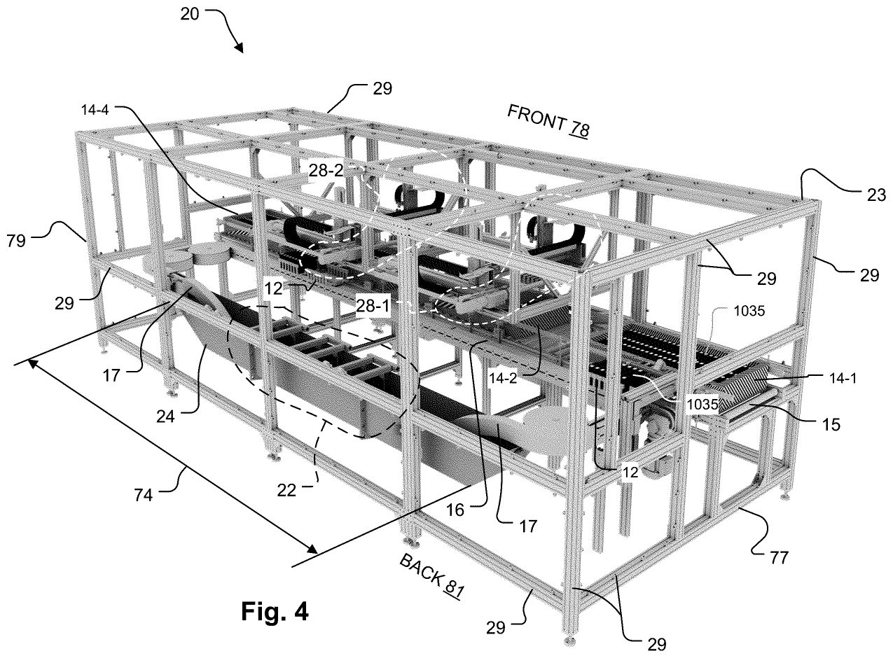

FIG. 4 is a perspective view of the enclosure 20 viewed from its left side 77. The left side 77 is located near the bottom right corner of the figure. The enclosure 20 extends from its left side 77 towards its right side 79, the latter of which is located near the top left corner of the figure. The back 81 of the enclosure 20 is closest to the viewer. This view enables more detail of the gantries 28-1, 28-2, the tank 24, and the interrogation zone 22 to be shown.

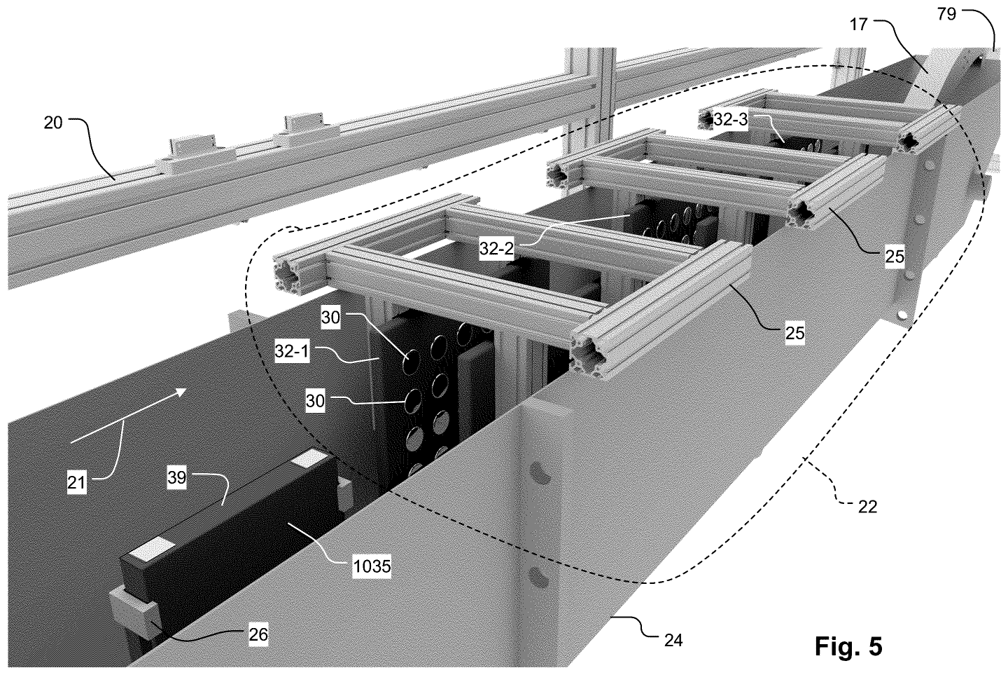

FIG. 5 shows more detail for the tank 24 and the interrogation zone 22. Tank rails 25 placed on top of the tank 24 provide additional stability for the tank 24 and protect the battery cells 1035 as they travel along the interrogation direction 21 and across the interrogation zone 22. In the illustrated example, a battery cell 1035 is carried by the interrogation conveyor 17 and is located just before entering the interrogation zone 22. A top 39 of the battery cell 1035 and a shuttle 26 that protects and holds each battery cell during interrogation are shown. Transducer modules 32-1, 32-2, and 32-3, as well as some of their transducers 30, are visible in the figure.

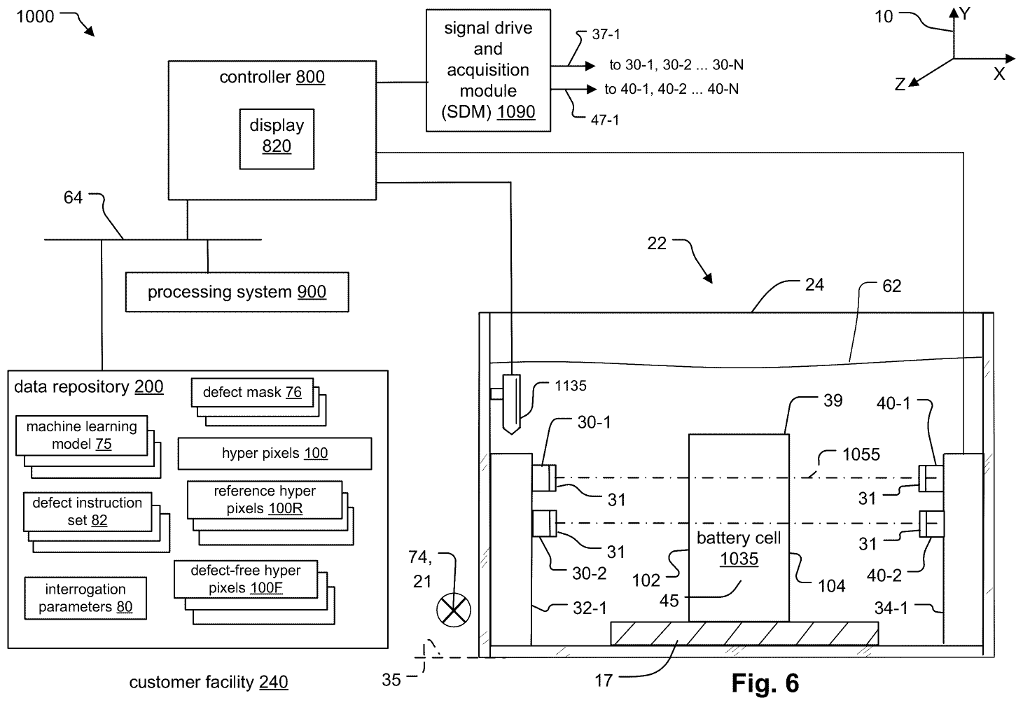

FIG. 6 shows more detail for the inspection system 1000 of FIG. 1 and for the data repository 200 in the inspection systems 1000, 2000 of FIGS. 1-5. The figure also shows additional components that could not be shown in the previous figures and shows interactions between the components. These additional components include emission faces of the ultrasound transducers 31 and a temperature sensor 1135. A coordinate axis 10 is also shown. The data repository 200 includes information that can be used by the inspection systems 1000, 2000 during the interrogation sessions of battery cells 1035. Alternatively or additionally, the data repository 200 can store information created and/or otherwise obtained as a result of each session. For example, the information can include machine learning models 75, defect masks 76, defect instruction sets 82, and interrogation parameters 80. The information also includes exemplary sets of hyper pixels created and/or used during various interrogation sessions, and in post-processing of hyper pixels. A set of hyper pixels 100, multiple sets of reference hyper pixels 100R, and multiple sets of defect-free hyper pixels 100F are shown.

In the illustrated example of FIG. 6, the tank 24 is shown in cross-section and viewed from the left side 77 of the enclosure 20. The tank length 74 and interrogation direction 21 are shown as pointing inward away from the viewer, into the paper and towards the right side 79 of the enclosure 20. The tank 24 is filled with a non-conducting fluid 62. An exemplary prismatic battery cell 1035 and the first pair of ultrasound transducers 32-1, 34-1 are also shown within the tank 24. The battery cell 1035 has substantially flat opposing surfaces 102 and 104, a top 39 and a front 45 and its front 45 faces the viewer. The interrogation conveyor 17 has moved the cell 1035 into the interrogation zone 22 such that the cell 1035 is located between the first pair of ultrasound transducer modules 32-1 and 34-1 and is immersed in the non-conducting fluid 62. The transducer modules 32-1 and 34-1 and the temperature sensor 1135 are included within the tank 24. Transducer module 32-1 includes two or more ultrasound transducers 30-1, 30-2, . . . 30-N, while transducer module 34-1 includes two or more ultrasound transducers 40-1, 40-2, . . . 40-N. Each of the ultrasound transducers 30, 40 has an emission face 31. The temperature sensor 1135 and the transducer modules 32-1, 34-1 (and thus the ultrasound transducers 30, 40) are also immersed in the electrically non-conducting fluid 62.

In some embodiments, the components of the inspection system 1000 can be arranged as follows. The processing system 900, the data repository 200, and the controller 800 connect to and communicate over the local area network 64, such as Gigabit Ethernet. The controller 800 has separate connections to the SDM 1090 and the temperature sensor 1135. The emission faces 31 of ultrasound transducers 30-1 . . . 30-N face surface 102 of battery cell 1035, while the emission faces 31 of ultrasound transducers 40-1 . . . 40-N face surface 104. The emission faces 31 of each pair of opposing ultrasound transducers 30-1/40-1, 30-2/40-2 are centrally aligned along a common transmission axis 1055. The emission faces 31 of the ultrasound transducers 30, 40 do not come in contact with the surfaces 102, 104 of the battery cell 1035 during the interrogation session. In some embodiments, the ultrasound transducers 30, 40 can be located at different heights with respect to a bottom 35 of the tank 24. Alternatively or additionally, the ultrasound transducers 30, 40 can be located at different longitudinal positions along the tank length 74. Here, the tank length 79 and the interrogation direction 21 are in the (−Z) direction of the coordinate system 10. The SDM 1090 can have separate transducer connections 37-1 . . . 37-N to each of the ultrasound transducers 30-1 . . . 30-N, and transducer connections 47-1 . . . 47-N to each of the ultrasound transducers 40-1 . . . 40-N. Each transducer connection 37, 47 functions as both a control pathway from the SDM to an ultrasound transducer and a data pathway from the ultrasound transducer to the SDM 1090.

### Inspection Method Examples

FIG. 7 is a flowchart that lists method steps corresponding with operation of an inspection system, for example, inspection systems 1000, 2000 in FIGS. 1-6. The method is associated with interrogation of prismatic battery cells. The method can begin at step 602, where the inspection system accesses battery cells 1035 included in one or more trays 14 placed on the rolling assembly path 15, where: the trays 14 are initially in an incoming position and each have a tray ID; each of the battery cells 1035 have a battery ID and are held by a U-shaped protective shuttle 26; and each of the battery cells 1035 have a specific X-Y location and orientation within its tray 14. Each battery cell 1035 within the trays 14 can be seated within an individual U-shaped fixture or shuttle 26. The shuttle 26 protects and holds each cell and keeps it upright within the tray 14, while also leaving the sides of the cells, along their length, exposed/unblocked by the shuttle 26. This allows the long sides of each cell 1035 that face the transducer modules 32, 34 to be unobstructed during ultrasound interrogation.

According to step 604, when a tray 14 arrives at an unloading position of the assembly path 15, the inspection system (via its controller 800) instructs the incoming gantry 28-1 to: pick up one or more battery cells 1035 at a time from the incoming tray 14-1 using multiple grippers of the incoming gantry 28-1, and place each battery cell and shuttle 26 onto a palette 12 resting on the staging conveyor 16. In step 608, the staging conveyor 16 then moves the palettes 12 to a holding position of the staging conveyor 16. In step 610, using a timed mechanism at the controller 800, the incoming gantry 28-1 then picks up each battery cell and shuttle 26 from the palettes 12 at the holding position and places each battery cell and its shuttle 26 upon the interrogation conveyor 17. The battery cells 1035 are placed such that sides of the cells along their length are aligned parallel to a length of the interrogation conveyor 17/parallel with the tank length 74. As a result, the long sides of the cells face the ultrasound transducers 30, 40 of the transducer modules 32-1, 32-2, 32-3 and 34-1, 34-2 and 34-3. The length of the interrogation conveyor 17 is also substantially parallel to the tank length 74.

In step 620, as the interrogation conveyor 17 transports each battery cell and shuttle 26 into the interrogation zone 22 in the interrogation direction 21, the interrogation system scans the ID of each battery cell and performs an ultrasound scan/interrogation session of each battery cell 1035, generates hyper pixels 100 in response to the ultrasound scanning, and creates a hyper pixel dataset for each battery cell that includes the hyper pixels 100 and the battery ID. In step 650, the controller 800 sends the hyper pixel dataset for each ultrasound-scanned battery cell 1035 to the processing system 900. The processing system 900 then determines characteristics of each battery cell 1035 based upon hyper pixel dataset 100 for each scanned battery cell. The scan rate of each battery cell 1035 can be determined by the speed of the interrogation conveyor 17 and can be set to a constant value (e.g., on a per customer basis). In one example, the speed or rate of the conveyor is about 500 mm/see, which corresponds to battery cells being spaced apart by about 500 mm and/or to a scan rate (otherwise known as throughput rate) of about one battery cell per second (or about 60 battery cells per minute). In other examples, the throughput rate can be about 10-55 battery cells per minute, inclusive, or greater than or equal to about 55 battery cells per minute.

According to step 652, the interrogation conveyor 17 transports each scanned battery cell 1035 back onto the staging conveyor 16, where each cell is rotated 90 degrees to match its original orientation within the tray 14. Then, in step 654, the outgoing gantry 28-2 scans the battery ID of each ultrasound-scanned battery cell 1035 and picks up each cell. Based upon its ID, the outgoing gantry 28-2 places each ultrasound-scanned battery cell back in its original tray, now in a loading position, at its original X-Y location and orientation within the tray 14. In step 656, the processing system 900 displays images to the display 820 of the controller 800. These images include anomaly maps that the processing system 900 creates from the hyper pixels of each battery cell 1035. The images show characteristics of each battery cell including defects and anomalies, in examples.

FIG. 8 is a flowchart that provides more detail for step 620 in the flowchart of FIG. 7, and lists method steps of the inspection system associated with performing an ultrasound interrogation session of each battery cell in the interrogation zone 22. The method begins at step 622. In step 622, the interrogation conveyor 17 transports the next battery cell 1035 into the tank 24 towards the interrogation zone 22, e.g., at a constant rate. At step 624, a sensor (e.g., an electromechanical sensor or photodetector) of a first ID scanner associated with the first pair of opposing transducer modules 32-1, 34-1 detects an X-Y origin of the battery cell 1035, scans its battery ID, and sends an indication of arrival of the battery cell along with the battery ID to the controller 800. The detection of the X-Y origin also signals alignment of the ultrasound transducers of the first pair of transducer modules 32-1, 34-1 with predetermined target points spatially distributed over a first area of the battery cell. Here, the first area of the battery cell is a top portion of either one side or both sides of the battery cell 1035 that face the ultrasound transducers 30, 40 of the transducer modules 32-1, 34-1.

According to step 626, in response to receiving the indication of arrival of the battery cell 1035 and its battery ID, the controller 800 instructs the SDM 1090 to send excitation signals in accordance with the interrogation parameters 80 to the ultrasound transducers 30, 40 configured as ultrasound transmitters in the first pair of transducer modules 32-1, 34-1. For this purpose, the SDM 1090 sends excitation signals associated with at least two different ultrasound frequencies to each ultrasound transducer 30, 40 configured as an ultrasound transmitter.

In step 628, in response to receiving the excitation signals, the ultrasound transducers 30, 40 transmit ultrasound of the at least two different frequencies into the target points of the first area of the battery cell 1024. As noted above, the first area is across a top portion of one side (or both sides) of each cell along its length. In step 630, ultrasound transducers 30, 40 configured as detectors in the first pair of transducer modules 32-1, 34-1 detect ultrasound either reflected from or transmitted through the battery cell 1035 and generate response signals for the target points of the first area based upon the detected ultrasound. The response signals are received by the SDM 1090, which forwards the response signals to the controller 800.

At step 632, a sensor of a second ID scanner associated with the second pair of opposing transducer modules 32-2, 34-2 detects an X-Y origin of the battery cell 1035, scans its battery ID and sends an indication of arrival of the battery cell along with the battery ID to the controller 800. The detection of the X-Y origin also signals alignment of the ultrasound transducers 30, 40 of the second pair of transducer modules 32-2, 34-2 with predetermined target points spatially distributed over a second area of the battery cell. Here, the second area of the battery cell is a middle portion of either one side or both sides of the battery cell 1035 that face the ultrasound transducers 30, 40 of the second pair of transducer modules 32-2, 34-2. According to step 634, the inspection system repeats steps 626 to 630 for the second pair of transducer modules 32-2, 34-2, where the target points of the second area are across the middle portion of one side (or both sides) of each cell along its length; the SDM 1090 receives the response signals for the target points of the second area and forwards them to the controller 800.

In step 636, a sensor of a third ID scanner associated with the third pair of opposing transducer modules 32-3, 34-3 detects an X-Y origin of the battery cell 1035, scans its battery ID and sends an indication of arrival of the battery cell along with the battery ID to the controller 800. The detection of the X-Y origin also signals alignment of the ultrasound transducers 30, 40 of the third pair of transducer modules 32-3, 34-3 with predetermined target points spatially distributed over a third area of the battery cell. Here, the third area of the battery cell is a bottom portion of either one side or both sides of the battery cell 1035 that face the ultrasound transducers 30, 40 of the third pair of transducer modules 32-3, 34-3.

In step 638, the inspection system repeats steps 626 to 630 for the third pair of transducer modules 32-3, 34-3, where the target points of the third area are across the bottom portion of one side (or both sides) of each cell along its length; the SDM 1090 receives the response signals for the target points of the third area and forwards them to the controller 800. Experimentation has shown that at least in prismatic battery cells 1035, interrogation of the sides at their top portions and interrogation of the sides at their bottom portions reliably detect misalignment between layers within the cells, while interrogation of the sides at their middle portion detect most defects in general.

Then, in step 640, the controller 800 collects the response signals for each of the at least two ultrasound frequencies at each of the target points for the three areas and stitches a representation of the collected response signals at each of the target points into a hyper pixel dataset. The collection of response signals at each target point is also known as a hyper pixel for each target point. The controller 800 might also append a representation of the transmitted ultrasound at each target point into the corresponding hyper pixels in the hyper pixel dataset.

Although some of steps 602-656 of the method of FIGS. 7-8 have been described as being performed once, in some embodiments, multiple repetitions of a particular step (or portion thereof) may be employed before proceeding to the next step. In addition, although steps 602-656 have been separately illustrated and described, in some embodiments, steps (or portions thereof) may be combined and performed together (simultaneously or sequentially). Moreover, although FIGS. 7-8 illustrate a particular order for steps 602-656, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIGS. 7-8. Alternatively or additionally, in some embodiments, the method may comprise only some of steps 602-656 (or portions thereof).

### Additional Inspection System Examples

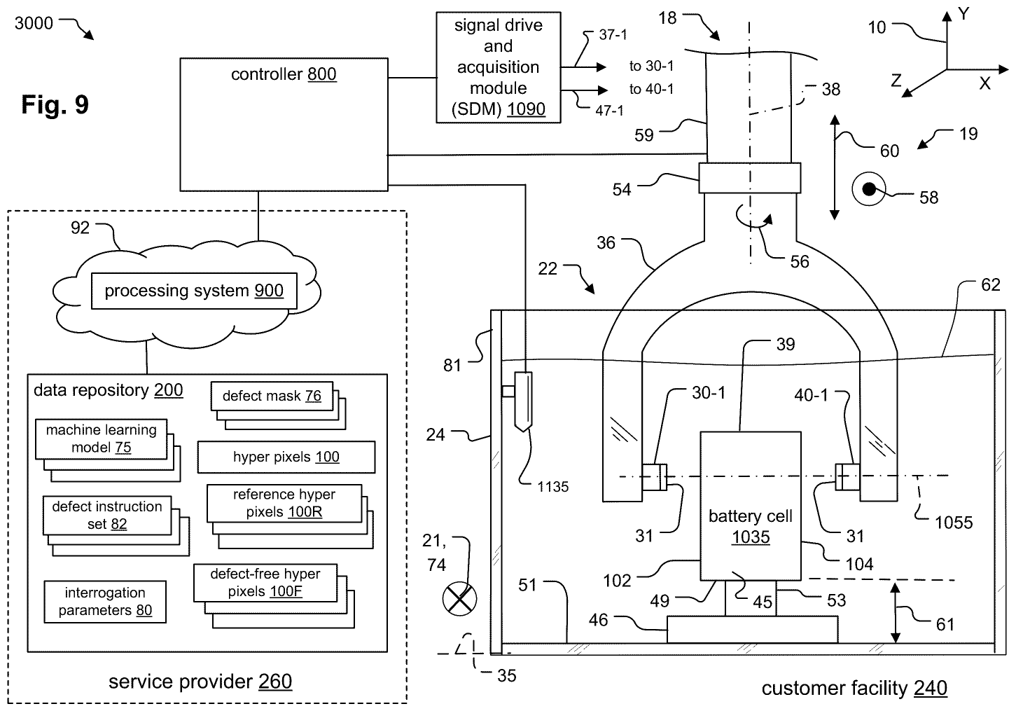

FIG. 9 shows detail for another inspection system 3000. The inspection system 3000 includes similar components as the inspection system 1000 of FIG. 6, but there are differences. Namely, the processing system 900 and the data repository 200 are located at the service provider 260, and the transport module 19 includes a robotic arm 18 with a gripper 36 (e.g., no conveyors are included). The inspection system 3000 also operates in a different manner than the inspection system 1000 of FIG. 6. Rather than transport battery cells 1035 relative to fixed opposing transducers within the tank 24 (as in the inspection system 1000 of FIG. 6), the inspection system 3000 transports opposing transducers 30-1, 40-1 relative to fixed battery cells 1035. At the same time, as in the inspection systems 1000 and 2000, both the battery cells 1035 and the opposing transducers 30-1, 40-1 are immersed in the electrically non-conductive fluid during the ultrasound interrogation of each battery cell 1035.

In the illustrated example of FIG. 9, the robotic arm 18 can provide fine movement with multiple degrees of freedom. Only a shaft 59, a gripper pivot 54, and a gripper 36 of the robotic arm 18 are shown. The gripper 36 rotates in a clockwise or counterclockwise gripper rotational movement direction 56 with respect to the fixed gripper pivot 54, around a gripper rotation axis 38. The gripper rotation axis 38 runs substantially parallel to the shaft 59. The degrees of freedom of the robotic arm 18 include a vertical movement direction 58 (in the Y/−Y direction of the coordinate system 10), a horizontal movement direction 60 that is substantially in or out of the figure (in the Z/−Z direction of the coordinate system 10), and the gripper rotational movement 56 direction. The gripper rotational movement direction 56 is substantially in the X/−X direction of the coordinate system 10 when the shaft 59 lies substantially perpendicular to a plane of the bottom 35 of the tank 24.

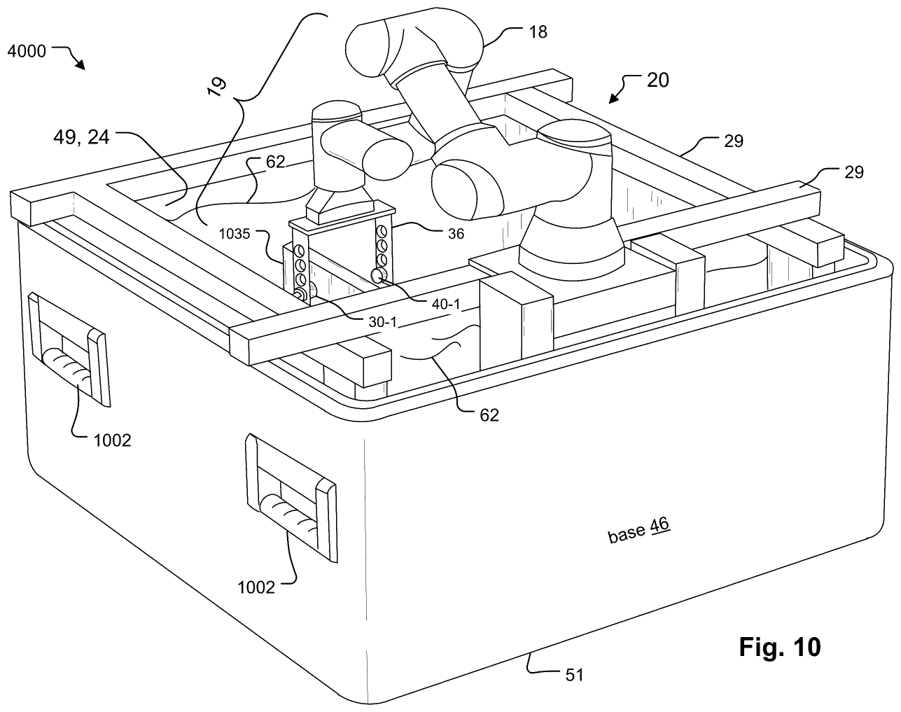

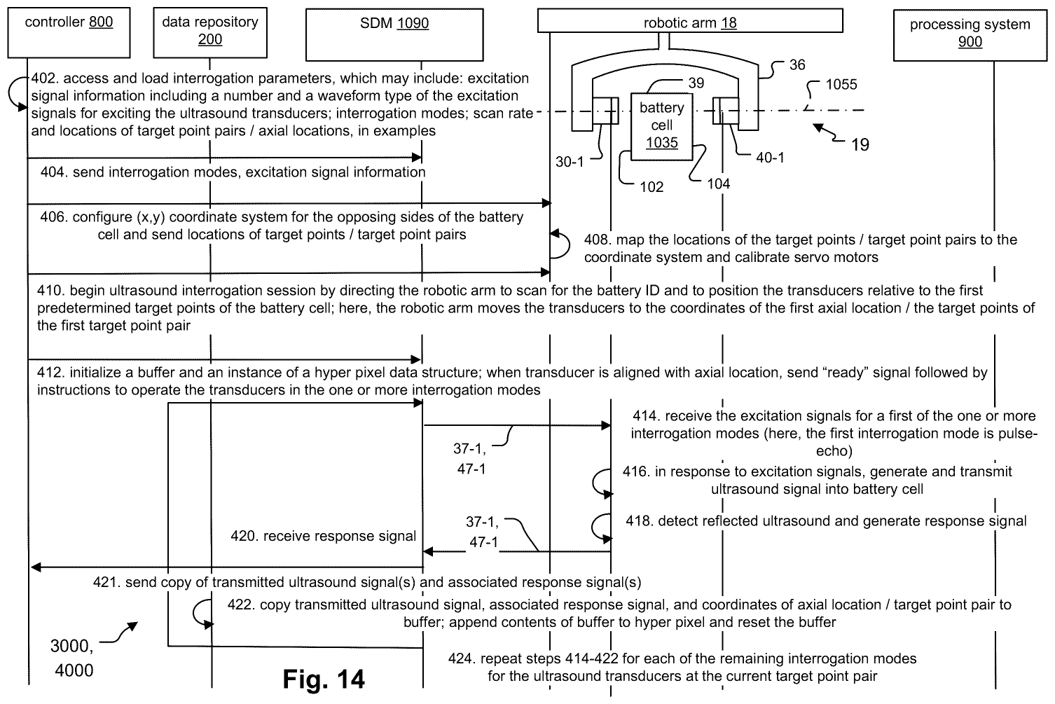

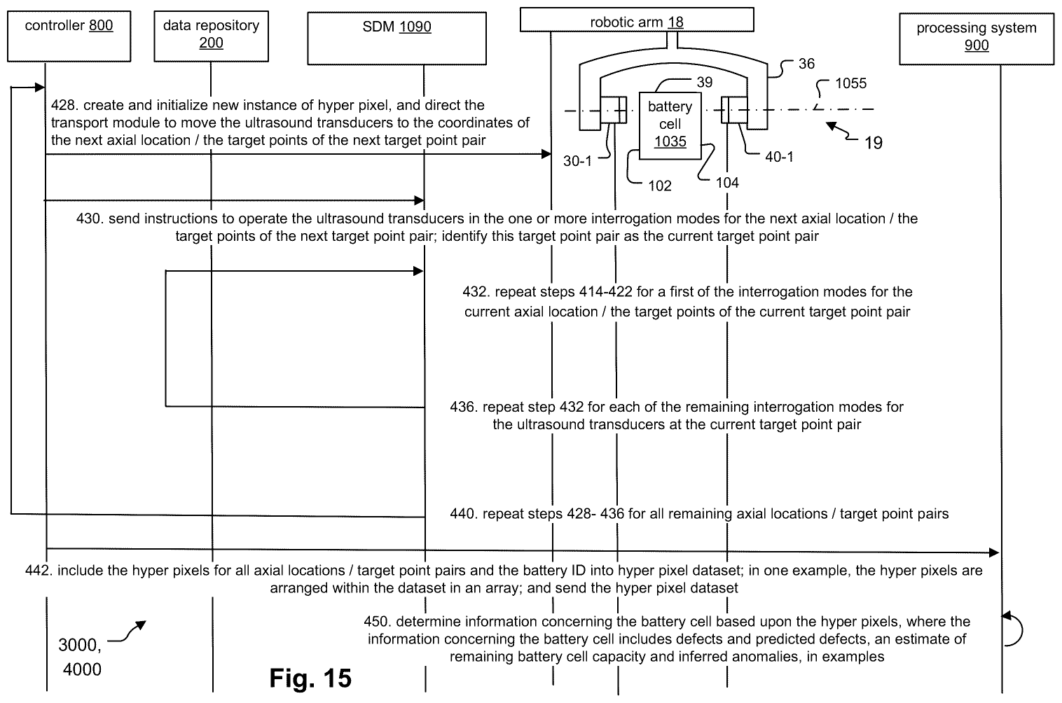

Operation of the inspection system 3000 is described in association with FIGS. 14-15, the descriptions of which are included below and elsewhere herein. The emission faces 31 of the pair of opposing ultrasound transducers 30-1, 40-1 are centrally aligned along the common transmission axis 1055. The emission faces 31 of the ultrasound transducers 30-1, 40-1 do not come in contact with the surfaces 102, 104 of the battery cell 1035 during the interrogation session. FIG. 10 shows yet another inspection system 4000. The system 4000 is a portable version of the inspection system 3000 in FIG. 9. The system 4000 includes substantially similar components and operates in a substantially similar way as the inspection system 3000 of FIG. 9; however, there are differences. For example, the inspection system 4000 has a protective, waterproof “hard case” enclosure 20 form factor, such as a ruggedized instrument case provided by Pelican Products, Inc. For this purpose, the enclosure 20 includes a base 46 and a chamber 49 formed within the base 46 and includes rails 29 that attach to and seat within the chamber 49. A top section of the case/enclosure 20 that attaches to the base 46 is removed in the figure and not shown. The tank 24 can be formed from inside walls of the base 46 and a bottom of the chamber 49. Handles 1002 located on the outside of base 46 allow operators to lift and move the base 46.

In some embodiments, the bottom of the chamber 49/tank 24 is located at a distance above a base bottom 51. This provides a separate area or compartment within the base 46 for including other components of the system 4000 such as the SDM 1090, the processing system 900, the controller 800, and the data repository 200. Alternatively, in some embodiments, one, some, or all of these components can be included in the chamber 49/tank 24, for example, in a waterproof compartment. Additionally or alternatively, one or more of these components can be located external to the base 46, and the base 46 can include a connector that enables connection to and communication with the external components.

In the illustrated example, a battery cell 1035 is placed within the tank 24 and in the electrically non-conductive fluid 62 and is ready for an interrogation session. Operation of the inspection system 4000 is described in association with FIGS. 14 and 15, the descriptions of which are included herein below.

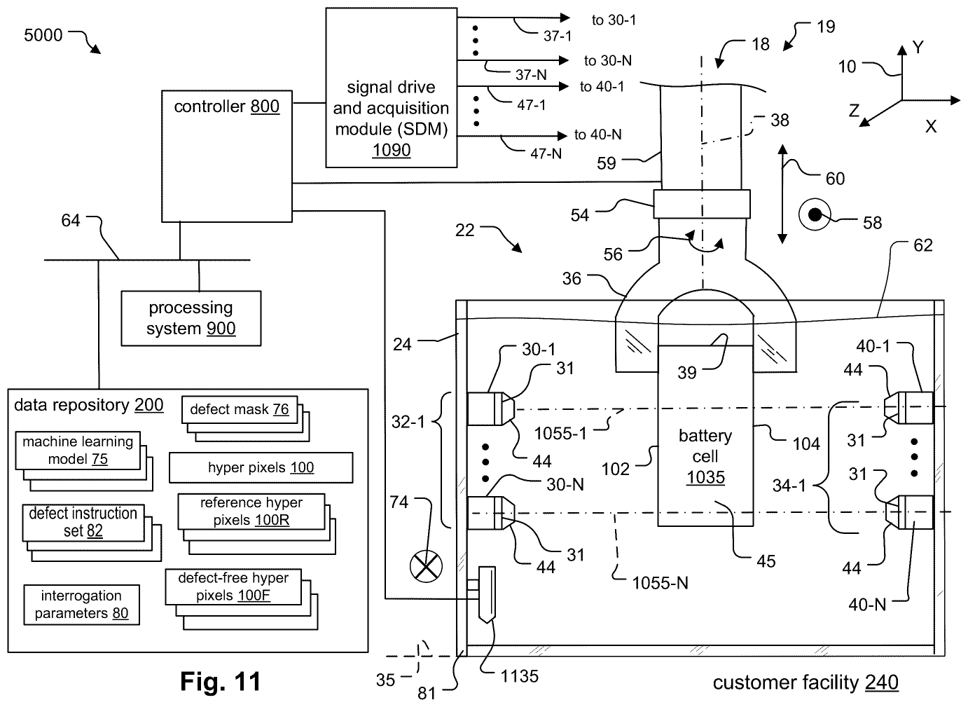

FIG. 11 shows detail for another inspection system 5000. The inspection system 5000 includes substantially similar components as the inspection system 3000 of FIG. 9, but all of the components are located at the customer facility 240, and some of the components are arranged differently. In the illustrated example, individual ultrasound transducers 30-1 . . . 30-N are placed on a first inside wall or surface of the tank 24, and individual ultrasound transducers 40-1 . . . 40-N are placed on a second inside wall or surface of the tank 24 that opposes the first inside wall. The emission faces 31 of each pair of opposing ultrasound transducers 30-1/40-1, 30-2/40-2, and 30-N/40-N are centrally aligned along a common transmission axis 1055.

Each of the transducers 30, 40, when configured as an ultrasound source, has an acoustic lens 44 disposed proximate to its emission face 31 and is configured to focus ultrasound exiting from the emission face 31. For example, ultrasound can be focused on an area corresponding with a single target point without the ultrasound impinging onto surrounding target points of the battery cell 1035. Because the acoustic lens 44 typically extends outward somewhat beyond the emission face 41, an ultrasound transducer 30, 40 equipped with an additional acoustic lens has an effective emission face that extends somewhat beyond the emission face 31. In another implementation, the emission faces 31, 41 are formed into a shape (e.g., curved or convex) that focuses the acoustic energy without the need of the acoustic lens. In yet another implementation, an acoustic lens is formed within the emission faces 31, 41 themselves. The transducers 30, 40 that include or otherwise incorporate the acoustic lens 44 can also operate as detectors of ultrasound. The principle of reciprocity holds and the lens 44 has a similar effect on transmission and reception of ultrasound, meaning that acoustic energy is also focused as it is received by transducers 30, 40 configured as ultrasound detectors.

The inspection system 5000 also operates in a different manner than the inspection system 3000 of FIG. 9. Rather than transport ultrasound transducers relative to fixed battery cells (as in the system 3000 of FIG. 9), the inspection system 5000 is configured to pick up and move each battery cell 1035 (e.g., one at a time) through the interrogation zone 22. For this purpose, the gripper 36/robotic arm 18 transports each battery cell 1035 relative to the fixed, opposing transducers 30, 40. At the same time, as in the inspection systems 1000, 2000, 3000, and 4000, both the battery cells 1035 and the opposing transducers 30-1, 40-1 are immersed in the electrically non-conductive fluid during the ultrasound interrogation of each battery cell 1035.

It can also be appreciated that various aspects of any one of the inspection systems are applicable to at least some of the other inspection systems. In one example, the transducer modules 32-1, 34-1 and the acoustic lens 44 of inspection system 5000/configuration of the ultrasound transducers to focus ultrasound into focused beams, can be included in any of the other inspection systems 1000, 2000, 3000, and 4000.

### Battery Cell Inspection Examples

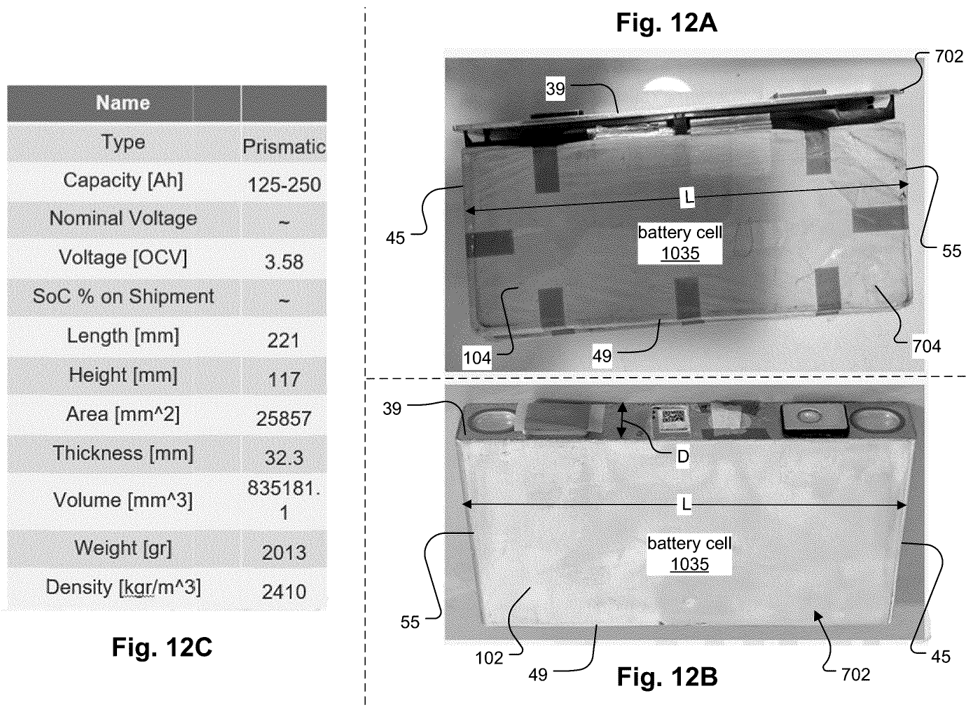

FIGS. 12A and 12B show opposing sides of an exemplary prismatic battery cell 1035 enclosed by a housing 702. In FIG. 12A, the housing 702 is removed on one surface 104 of the cell to reveal a bag 704 within the housing 702. The bag 704 includes stacks of anode/separator/cathode assemblies and is filled with an electrolyte. A back 55 of the battery cell 1035 that opposes its front 45 and a length L that extends from the front 45 to the back 55 are visible in the figure. FIG. 12B shows surface 102 of the cell 1035, which opposes surface 104 and is enclosed by the housing 702. A depth D of the battery cell 1035 is also shown. FIG. 12C is a table that lists various parameters for the battery cell 1035 in FIGS. 12A and 12B. These parameters include a type (e.g., prismatic), capacity in Ampere-hours (Ah), a nominal voltage and an OCV, and a State of Charge (SOC) upon shipment. Because the battery cell 1035 is still undergoing manufacturing and inspection testing, no values for the nominal voltage and SOC upon shipment are yet provided. Additional parameters include a height, length (L), thickness/depth (D) in millimeters (mm), an area (mm²), a volume (mm³), a weight in grams (g), and a density in kilograms per cubic meter (kg/m3).

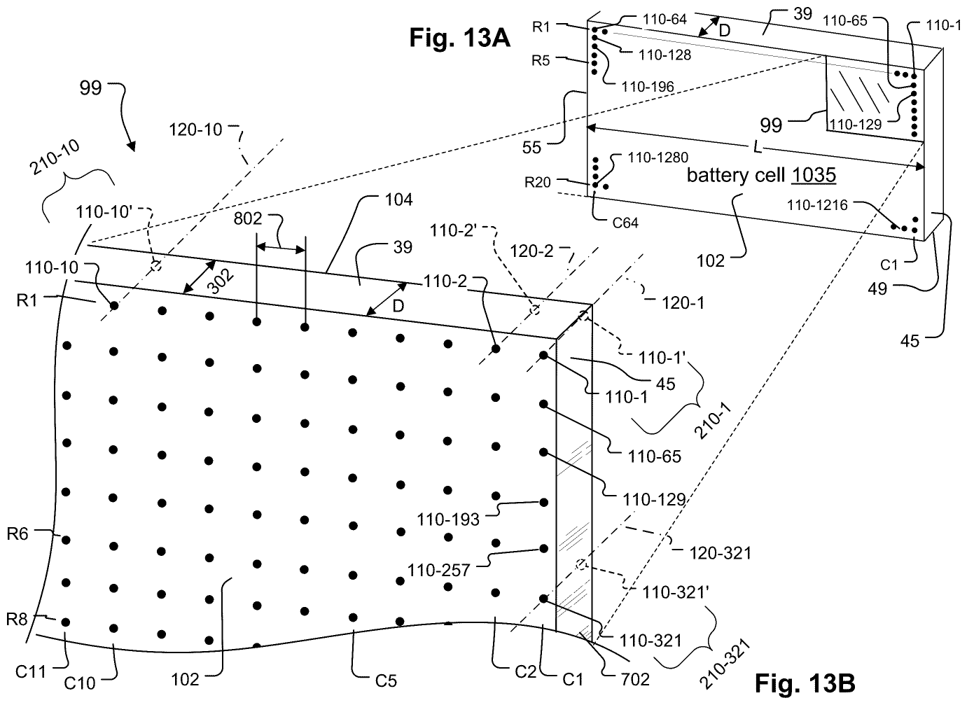

FIG. 13A shows predetermined target points 110 configured by the controller 800 and notionally superimposed upon surface 102 of an exemplary battery cell 1035. The controller 800 configures the target points 110 at initialization time of the inspection system, based upon information included within the interrogation parameters 80. In more detail, 1280 target points 110-1 through 110-1280 are shown, arranged in 20 rows R1 through R20 and 64 columns C1 through C64. Row R1 is nearest the top 39 of the battery cell 1035 while column C1 is nearest its front 45. In the illustrated example, the target points 110 begin at row and column (R1, C1) with target point 110-1 being located at a corner of the battery cell 1035 near its top 39 and front 45. The column numbers incrementally increase along the length L of the cell 1035 towards its back 55, to target point 110-64 at position (R1, C64). In other examples, target point 110-65 is at position (R2, C1) and target point 110-1280 is at position (R20, C64). A portion 99 of the battery cell 1035 is also highlighted. FIG. 13B shows more detail for the portion 99 of the battery cell 1035 in FIG. 13A. This view shows target points 110 configured by the controller 800 that are notionally superimposed upon both sides 102, 104 of the battery cell 1035. Each target point 110 on surface 102 has a corresponding target point 110′ on opposing surface 104 to form a target point pair 210. A separate axial line 120 passes through the target points 110, 110′ of each target point pair 210. A target point distance 802 is also shown.

In examples, target point 110-1 and its corresponding target point 110-1′ are both positioned at (R1, C1) but are located on surfaces 102 and 104, respectively. Axial line 120-1 passes through the target points 110-1 and 110-1′. In other examples, target point pair 210-10 includes target points 110-10 and 110-10′ and is positioned at (R1, C10), and axial line 120-10 passes through the target points 110-10 and 110-10′; and target point pair 210-321 includes target points 110-321 and 110-321′ and is positioned at (R6, C1), and axial line 120-321 passes through the target points 110-321 and 110-321′. In some embodiments, a number of the target points 110 can be greater than 1024, and the target points 110, 110′ are distributed evenly across the opposing sides 102, 104 of the battery cell 1035. For example, the target point distance 802 can be configured by the controller 800 such that a target point density of the target points 110 is at least 100 locations per square centimeter (cm2). However, other configurations of the target points 110 are possible. In examples, the target points 110 may be located on only one side or surface of the battery cell 1035, and/or may be concentrated/have a higher target point density in one or more specific areas of the battery cell than in the rest of a surface of the battery cell 1035.

In one or more embodiments, there are at least 4500 target points 110/locations configured by the controller 800 for a battery cell 1035. In one example, the distribution of the target points 110 across a surface of the battery cell 1035 can range between 1 target point and about 400 target points per square centimeter. Some of the target points 110 can also be concentrated in specific areas of the battery cell 1035. Densities of target points higher than about 400 target points per square centimeter are also possible. Experimentation has shown successful scans with target point densities of as much as 800 and even 1600 points per square centimeter, in examples. At the same time, increases in the density of target points also requires an increase in the number of ultrasound transducers 30, 40 and associated electronics provided by SDM 1090.

The battery cell 1035 generally has a plurality of planar electrodes and electrode separators assembled with surfaces thereof being substantially parallel. As a result, the ultrasound transducers can be configured to direct ultrasound at each battery cell target point 110 along an orthogonal axis (here, the axial lines 120) with respect to the substantially parallel surfaces of the planar electrodes and separators.

### Additional Inspection Method Examples

FIGS. 14-15 are diagrams that illustrate a method of operation of inspection systems 3000 and 4000 for performing an interrogation session of an exemplary battery cell 1035. In the diagrams, major components of the systems 3000, 4000 such as the controller 800, the data repository 200, the SDM 1090, the transport module 18, the ultrasound transducers 30-1, 40-1, and the processing system 900 are represented either by blocks with reference names or by symbols with reference numerals. Interactions between the components, which comprise steps of the method, are indicated by directional arrows with labels for each step. Each interrogation session performed by the inspection systems 3000, 4000 can determine characteristics of the battery cell 1035 including defects, anomalies, and changes in charge distribution of the cells 1035 as a function of a state of charge (SOC) of the cell, in examples. While the description included herein below is tailored to operation of inspection systems 3000 and 4000, it can be appreciated that the concepts described herein are applicable to any or all of inspection systems 1000, 2000, 3000, 4000, and 5000.

At initialization of the inspection system, in step 402, the controller 800 loads the interrogation parameters 80 from the data repository 200. The interrogation parameters 80 includes information for specifying a transducer map that defines the interrogation modes of each of the ultrasound transducers 30-1, 40-1, excitation signal information, a motion rate, and target point information for configuring the target points 110, in examples. The excitation signal information may include a number of the excitation signals for the SDM 1090 to send each of the ultrasound transducers 30, 40 that are configured as transmitters, and aspects of the excitation signals including an amplitude, a wavelength/frequency, a waveform type/shape, and/or a phase shift. In examples, the waveform type/shape can be unipolar, bipolar, or sinusoid. The target point information can include a number of the target points 110 and a density of the target points, in examples.

In step 404, the controller 800 sends the interrogation modes and the excitation information to the SDM 1090. Based upon the excitation information and the interrogation modes, the SDM 1090 configures corresponding excitation signals to send to the transducers 30-1, 40-1 via the transport module 19. In the illustrated example, the transport module 19 is the robotic arm 18. According to step 406, the controller 800 configures an (x, y) coordinate system for the opposing sides 102, 104 of the battery cell 1035 and sends the number and locations of the target points 110/target point pairs 210 and the motion rate to the transport module 19. At step 408, the transport module 19 maps the locations of the target points/target point pairs to its coordinate system and calibrates its motors (e.g., servo motors). According to step 410, the controller 800 begins an interrogation session of the battery cell 1035 by directing the transport module 19 to position the transducers 30-1, 40-1 relative to the first predetermined target points 110/110′. Because this specific inspection system 5000 performs an ultrasonic interrogation for the battery cell by moving the ultrasound transducers 30-1, 40-1 relative to a fixed battery cell 1035, transport module 19 moves the ultrasound transducers 30-1 and 40-1, as a unit, to the coordinates of the first axial location 120-1/the target points 110-1, 110-1′ of the first target point pair 210-1.

In step 412, the controller 800 initializes a buffer and a hyper pixel data structure (“hyper pixel” 100). Because this is the first instance of a hyper pixel, it is given reference 100-1. When the transmission axis 1055 of the ultrasound transducer 30-1 aligns with the axial line 120 of the target point 110/target point pair 210, the controller 800 sends a “ready” signal to the SDM 1090, followed by instructions to operate the ultrasound transducers 30-1, 40-1 in the one or more interrogation modes. At step 414, the SDM 1090 sends the excitation signals for the first interrogation mode over the transducer connection 37-1 to the first ultrasound transducer 30-1. Here, the first interrogation mode is “pulse-echo.” In step 416, in response to each of the excitation signals, the ultrasound transducer 30-1 transmits an associated ultrasound signal into the battery cell 1035.

At step 418, because the first interrogation mode is pulse-echo, the same ultrasound transducer 30-1 emits ultrasound to impinge on a target point of the battery cell, senses ultrasound reflected from one or more surfaces of the test battery cell 1035 and generates an electrical response signal for each instance of detected ultrasound. According to step 420, the SDM 1090 receives the response signal over the transducer connection 37-1, and in step 421 sends a representation of the transmitted ultrasound signal(s) and the associated response signal(s) to the controller 800. In step 422, the controller 800 appends a representation of the transmitted ultrasound signal(s), the associated response signal(s), and coordinates of axial location 120/target point pair 210 to the buffer. The controller 800 then appends the contents of the buffer to the hyper pixel 100-1 for the current target point 110/target point pair 210 and resets the buffer.

The response signal is a first hyper pixel value for the hyper pixel 100-1.

In step 424, the method repeats step 414-424 for each of the remaining interrogation modes for the ultrasound transducers 30-1, 40-1 at the current target point 110/target point pair 210. These remaining interrogation modes include: pulse-echo of ultrasound transducer 40-1; through-transmission mode, with ultrasound transducer 30-1 configured as an ultrasound transmitter and ultrasound transducer 40-1 configured as an ultrasound receiver; and through-transmission mode, with ultrasound transducer 40-1 configured as an ultrasound transmitter and ultrasound transducer 30-1 configured as an ultrasound receiver.

For the pulse-echo interrogation mode of ultrasound transducer 40-1, the SDM in step 414 sends excitation signals via transducer connection 47-1 to ultrasound transducer 40-1. Steps 416 through 422 are effectively the same as described herein above, with the exception that ultrasound transducer 40-1 operates in pulse-echo mode, sends the response signals to the SDM 1090 via transducer connection 47-1 and the controller 800 updates the hyper pixel 100-1 to include the transmitted ultrasound signal(s) and the associated response signal(s) for the current interrogation mode at current target point 110/target point pair 210. The response signals obtained for each interrogation mode are additional hyper pixel values stored to the hyper pixel 100-1 for the same target point 110/target point pair 210.

The next interrogation mode is through-transmission mode with ultrasound transducer 30-1 operating as a transmitter and ultrasound transducer 40-1 as a receiver. At step 414, ultrasound transducer 30-1 receives the excitation signal(s) from the SDM 1090 via transducer connection 37-1 and generates ultrasound into and through the battery cell 1035 in step 416. Ultrasound transducer 40-1 receives and detects the through-transmitted ultrasound and generates an associated response signal, in step 418. The SDM 1090 receives the response signals via transducer connection 47-1 in step 420, sends a representation of the transmitted ultrasound signal(s) and the associated response signal(s) to the controller 800 in step 421. In step 422, the controller 800 updates the hyper pixel 100-1 to include the transmitted ultrasound signal(s) and the associated response signal(s) for the current interrogation mode at current target point 110/target point pair 210.

The next interrogation mode is through-transmission mode with ultrasound transducer 40-1 operating as a transmitter and ultrasound transducer 30-1 as a receiver. At step 414, ultrasound transducer 40-1 receives the excitation signal(s) from the SDM 1090 via transducer connection 47-1 and generates ultrasound into and through the battery cell 1035 in step 416. Ultrasound transducer 30-1 receives and detects the through-transmitted ultrasound and generates an associated response signal, in step 418. The SDM 1090 receives the response signal(s) via transducer connection 37-1 in step 420 and sends representations of the transmitted signals and the associated response signals to the controller in step 421, In step 422, the controller 800 updates the hyper pixel 100-1 to include the transmitted ultrasound signal(s) and the associated response signal(s) for the current interrogation mode at current target point 110/target point pair 210.

The method continues at step 428 of FIG. 15, where the controller 800 creates and initializes a new instance of a hyper pixel 100-2 and directs the transport module 19 to move the ultrasound transducers 30-1, 40-1 to the coordinates of the next axial location 120-2/the target points 110-2, 110-2′ of the next target point pair 210-2. In step 430, the controller 800 sends instructions to the SDM 1090 to operate the ultrasound transducers 30-1, 40-1 in the one or more interrogation modes for the next axial location 120-2/the target points 110-2, 110-2′ of the next target point 210-2, and identifies this next point pair as a current target point pair. Then, in step 432, the inspection system 5000 repeats steps 414-421 for a first of the interrogation modes for the current axial location 120-2/the target points 110-2, 110-2′ of the current target point pair 210-2. In step 436, the inspection system 5000 repeats step 432 for each of the remaining interrogation modes for the ultrasound transducers 30-1, 40-1, at the current target point pair 210-2. Upon completion of step 436, hyper pixel 100-2 includes a representation of the transmitted ultrasound signals and the associated response signals, for each of the interrogation modes, at target point 110-2, 110-2′/target point pair 210-2.

In step 440, the inspection system repeats steps 428-436 for all remaining target point pairs 210/axial locations 120 (or all of a predetermined subset thereof), and the ultrasound interrogation of each target point is completed. As a result, upon completion of step 440, the controller 800 has created and stored hyper pixels 100-1 . . . 100-N for each of the target points 110-1 . . . 110-N/target point pairs 210-1 . . . 210-N. In step 442, the controller 800 sends the hyper pixels 100 to the processing system 900 for analysis. In one implementation, the controller 800 includes the hyper pixels 100 in an array and streams the array over a network to the processing system 900. According to step 450, the processing system 900 determines information concerning the battery cell 1035 based upon the hyper pixels 100, where the information concerning the battery cell 1035 includes defects and predicted defects, an estimate of battery cell capacity and inferred anomalies, in examples.

In one or more embodiments, for the first interrogation mode at a target point 110, the SDM 1090 sends at least two separate excitation signals of different frequencies (e.g., a first and a second excitation signal) to the ultrasound transducer configured to transmit ultrasound in the first interrogation mode. In response to receiving the first excitation signal, the ultrasound transducer transmits an associated first ultrasound signal with the frequency of the first excitation signal, and the ultrasound transducer configured to detect the transmitted ultrasound in the first interrogation mode detects the ultrasound at the target point and generates a first response signal. In a similar vein, the ultrasound transducer receives the second excitation signal and transmits an associated second ultrasound signal with the frequency of the second excitation signal, and the ultrasound transducer configured to detect the transmitted ultrasound detects the ultrasound at the target point and generates a second response signal. The SDM 1090 then sends a representation of the first and the second transmitted ultrasound signal, along with the first and the second generated response signal, to the controller 800. The controller 800 then creates or updates the hyper pixel 100 for the target point 110 to include this information for the first interrogation mode at the target point 110.

This process of configuring the inspection system to use at least two excitation signals of different frequencies repeats for each of the remaining interrogation modes for the current target point 110, and for each of the remaining target points during the interrogation session of the battery cell 1035, per the method of FIGS. 14-15. For example, the frequency value of the first excitation signal is selected to be the same across all interrogation modes for each target point. In a similar vein, the frequency of the second excitation signal (which has a different value than that of the frequency of the first excitation signal) can also be selected to be the same across all interrogation modes for each target point. However, it can be appreciated that the frequency values of the first and the second excitation signals can be different across different interrogation modes for a target point, or across target points 110, as long as there is a difference between the frequency value of the first excitation signal and the frequency of the second excitation signal in each of the interrogation modes and across the target points 110. Because there are at least four different interrogation modes per target point 110, the hyper pixel 100 for each target point 110 can include at least eight (8) signal representations of the transmitted ultrasound signals, and at least eight (8) different associated response signals.

The controller 800 then sends the hyper pixels 100 to the processing system 900 for analysis. The processing system 900 examines the differences between the first and the second transmitted signals and the first and the second response signals, for each interrogation mode at each target point 110 as provided in each hyper pixel 100, to determine characteristics of the battery cell 1035. In another embodiment, one or more of the ultrasound transducers can be configured as broadband transducers or as a swept source. For this purpose, the SDM 1090 sends a single excitation signal to each of the transducers configured to transmit ultrasound in each of the interrogation modes. During analysis of the hyper pixels 100, in one example, the processing system 900 can analyze the response signals in the spectral (e.g., frequency) domain to examine differences in response to different frequencies/frequency sweeping.

While the method of operation described hereinabove is tailored to the inspection systems 3000, 4000, it can be appreciated that the same concepts can be applied to the other inspection systems 1000, 2000 and 5000. With respect to inspection system 1000, for example, the method is applicable as follows. The number of transducers 30, 40 in each of the pairs of ultrasound transducer modules 32-1/34-1, 32-2/34-2 and 32-3/34-3 can be the same, and each transducer 30-1 . . . 30-N in each transducer module 32 is positioned such that a corresponding transducer 40-1 . . . 40-N in each transducer module 34 forms a pair. At least in the case of battery cells 1035 having substantially rectangular form factors such as prismatic cells and pouch cells, such an arrangement of transducers enables at least four interrogation modes of the ultrasound transducers per target point 110, 110′/target point pair 210/axial location 120. This is because the transducers 30, 40 in each pair are effectively performing ultrasound interrogation of the same area or target point 110 of a battery cell 1035, but from opposing sides of the cell 1035.

Although some of steps 402-450 of the method of FIGS. 14-15 have been described as being performed once, in some embodiments, multiple repetitions of a particular step (or portion thereof) may be employed before proceeding to the next step. In addition, although steps 402-450 have been separately illustrated and described, in some embodiments, steps (or portions thereof) may be combined and performed together (simultaneously or sequentially). Moreover, although FIGS. 14-15 illustrate a particular order for steps 402-450, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIGS. 14-15. Alternatively or additionally, in some embodiments, the method may comprise only some of steps 402-450 (or portions thereof).

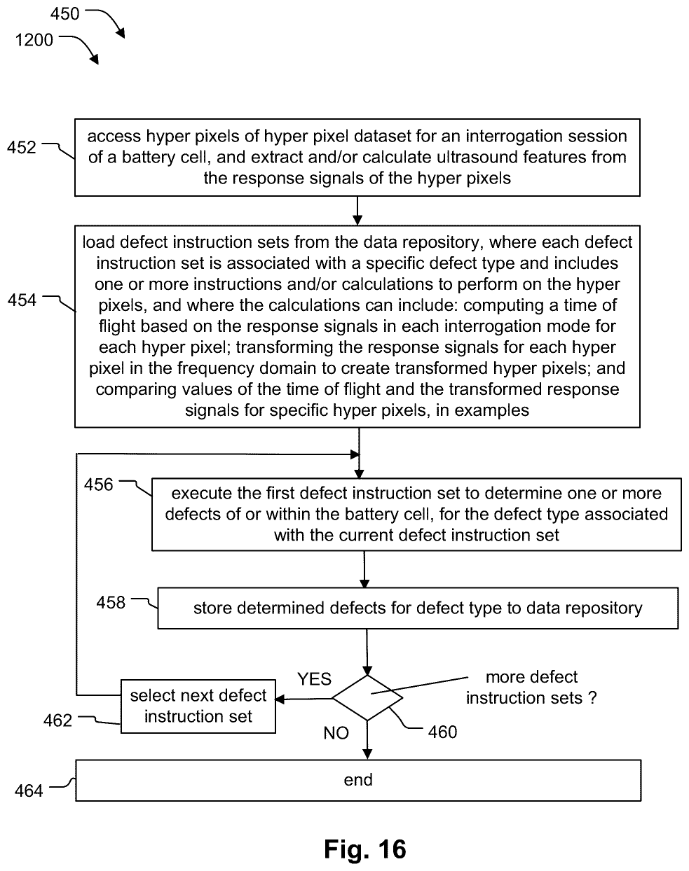

FIG. 16 is a flowchart that describes a method of operation 1200 of the processing system 900, according to one implementation. The method provides more detail for step 450 in the method of FIGS. 14 and 15 and describes how the processing system 900 can determine defects of battery cells 1035, in a deterministic fashion, using the defect instruction sets 82. The method begins at step 452. In step 452, the processing system 900 accesses the hyper pixels 100 for an interrogation session of a battery cell 1035 and extracts and/or calculates ultrasound features from the response signals of the hyper pixels 100. These ultrasound features may include a number of zero-crossings of the response signals, and an amplitude and phase of the response signals, in examples.

According to step 454, the processing system 900 loads one or more defect instruction sets 82 from the data repository 200. Each defect instruction set 82 can be associated with a specific defect type and includes one or more instructions and/or calculations (e.g., mathematical formulas, algorithms) for the controller 800 to execute or otherwise apply to the hyper pixels 100 for this purpose. In examples, the calculations can include: computing a time of flight based on the response signals in each interrogation mode for each hyper pixel; transforming the response signals for each hyper pixel 100 in the frequency domain to create transformed hyper pixels; and comparing values of the time of flight and the transformed response signals for specific hyper pixels 100.

In step 456, the processing system 900 executes the instructions of the first defect instruction set 82 to determine one or more defects of or within the battery cell 1035, for the defect type associated with the current defect instruction set 82. The processing system 900 stores any determined defects for the defect type to the data repository 200 in step 458. If there are more defect instruction sets 82 to process in step 460, the method transitions to step 462 and selects the next defect instruction set 82 from the repository, and control passes back to the beginning of step 456. The processing system 900 executes the instructions of the next defect instruction set 82 and stores the results to the data repository 200 in step 458. Otherwise, the method ends at step 464 and control passes back to the end of step 450 in FIG. 15.

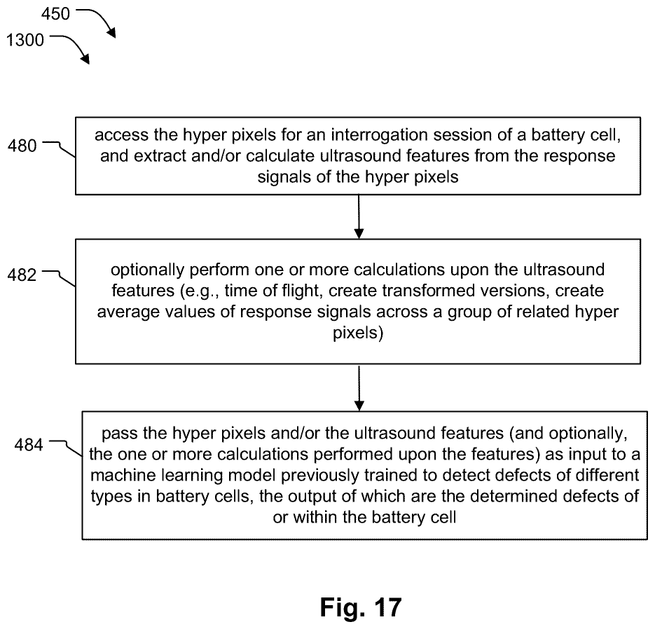

FIG. 17 is a flowchart that describes another method of operation 1300 of the processing system 900, according to another implementation. The method provides more detail for step 450 in the method of FIGS. 14 and 15 and describes how the processing system 900 can determine defects of battery cells 1035 via machine learning. The method begins at step 480. In step 480, the processing system 900 accesses the hyper pixels 100 for an interrogation session of a battery cell 1035 and extracts and/or calculates ultrasound features from the response signals of the hyper pixels 100. According to step 482, the processing system 900 may perform one or more calculations upon the ultrasound features (e.g., time of flight, create transformed versions, create average values of response signals across a group of related hyper pixels).

Then, in step 484, the processing system 900 passes the hyper pixels 100 and/or the ultrasound features (and optionally, the one or more calculations performed upon the features) as input to a machine learning model 75 previously trained to detect defects in battery cells 1035. For this purpose, the model 75 is trained using information associated with known defects of different types in the battery cells 1035. The output of the machine learning model is/are the determined defects of or within the battery cell 1035.

Although some of steps 452-464 and 480-484 of FIGS. 16-17 have been described as being performed once, in some embodiments, multiple repetitions of a particular step (or portion thereof) may be employed before proceeding to the next step. In addition, although steps 452-464 and 480-484 have been separately illustrated and described, in some embodiments, steps (or portions thereof) may be combined and performed together (simultaneously or sequentially). Moreover, although FIGS. 16-17 illustrate a particular order for steps 452-464 and 480-484, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIGS. 16-17. Alternatively or additionally, in some embodiments, the method may comprise only some of steps 452-464 and 480-484 (or portions thereof).

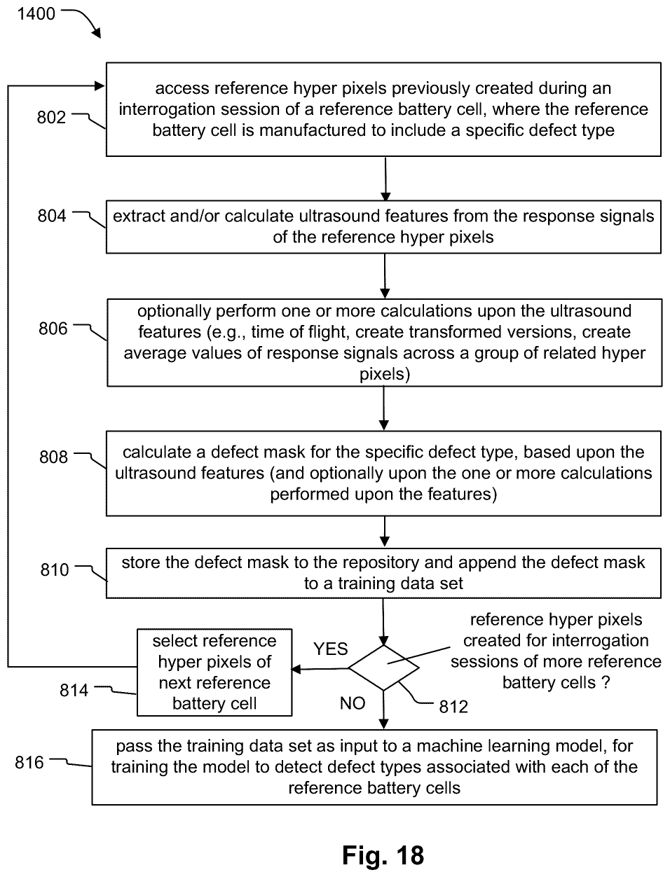

FIG. 18 is a flowchart that describes a method of operation 1400 of the processing system 900 for training a machine learning model 75 to detect defects in battery cells 1035. The method accesses sets of reference hyper pixels 100R previously created from interrogation sessions of reference battery cells, creates defect masks for specific defect types from the reference hyper pixels 100R, and includes the defect masks 76 in a training data set. The method then applies the training data set to the machine learning model 75 to train the model. For example, each set of reference hyper pixels 100R can be associated with reference battery cells having different defect types. However, multiple reference battery cells having the same defect type can also be used to create each set of reference hyper pixels 100R. Alternatively or additionally, in some embodiments, each of the reference battery cells can be of a same type as each battery cell 1035 under test.

In FIG. 18, the method begins in step 802, where the processing system 900 can access a set of reference hyper pixels 100R from the data repository 200. The set of reference hyper pixels 100R was previously created during an interrogation session of at least one reference battery cell. The reference battery cell is manufactured or otherwise modified to include a specific defect type. In step 804, the processing system 900 extracts and/or calculates ultrasound features from the response signals of the reference hyper pixels 100R, and optionally performs one or more calculations upon the ultrasound features in step 806. These calculations may include: a time of flight, transformed versions of the response signals, and average values of response signals across a group of related hyper pixels, in examples.

In step 808, the processing system 900 calculates a defect mask for the specific defect type, based upon the ultrasound features (and optionally upon the one or more calculations performed upon the features). Additionally and/or alternatively, the defect mask 76 may be calculated based upon the reference hyper pixels 100R as a whole. In step 810, the processing system 900 stores the defect mask 76 to the data repository 200 and appends the defect mask 76 to a training data set. If there are more sets of reference hyper pixels 100R in the data repository to process in step 812, the method transitions to step 814 and selects the next set of reference hyper pixels for the next defect type from the data repository 200. Control passes back to the beginning of step 802 to create the next defect mask 76 in steps 804 through 808, and to append the next defect mask to the training data set in step 810.

If there are no more sets of reference hyper pixels 100R in the data repository 200 to process, the method transitions to step 816. At step 816, the processing system 900 passes the training data set as input to a machine leaning model 75, for training the model to detect the defect types associated with each of the reference battery cells. Additionally and/or alternatively, the training data set may additionally include the raw reference hyper pixels 100R associated with each of the defect types.

It can also be appreciated that the training data set can include different types of information other than defect masks 76, for training the model 75 to defect defects in battery cells 1035. In one example, the training data set can include anomaly maps created by the processing system 900, in response to the processing system 900 analyzing hyper pixels 100 of battery cells 1035. In another example, the training data set can include a series of one or more mathematical operations performed upon the hyper pixels 100 that have experimentally been shown to detect defects in battery cells 1035. In each of these examples, possibly hundreds or thousands of battery cells 1035 of the same type (or of different types) are tested by the inspection system, and the hyper pixels 100 created for each are stored for later use. In each of these examples, at least some of the information included in the training data set has previously been compared against a destructive tear-down of the same battery cells 1035 and/or a CT scan image of the same battery cells, post-interrogation, to validate the ability of the training information to accurately and precisely detect the defects.

Although some of steps 802-816 of FIG. 18 have been described as being performed once, in some embodiments, multiple repetitions of a particular step (or portion thereof) may be employed before proceeding to the next step. In addition, although steps 802-816 have been separately illustrated and described, in some embodiments, steps (or portions thereof) may be combined and performed together (simultaneously or sequentially). Moreover, although FIG. 18 illustrates a particular order for steps 802-816, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIG. 18. Alternatively or additionally, in some embodiments, the method may comprise only some of steps 802-816 (or portions thereof).

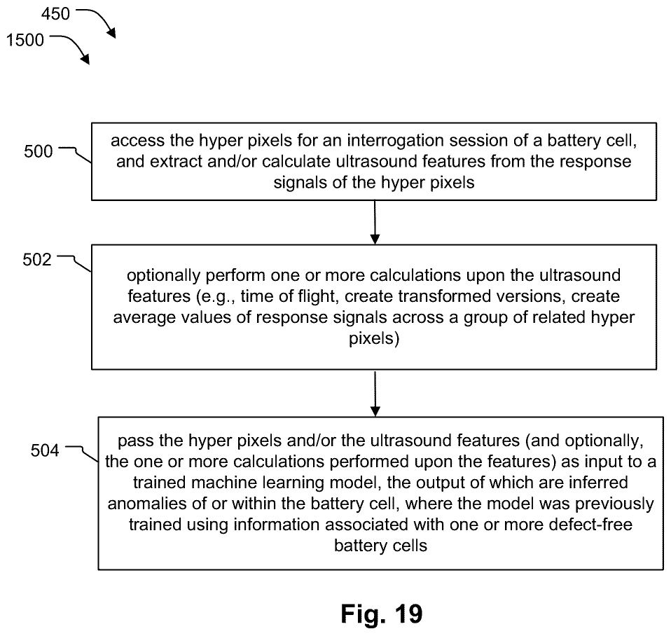

FIG. 19 is a flowchart that describes another method of operation 1500 of the processing system 900, according to another implementation. The method provides more detail for step 450 in the method of FIGS. 14-15 and describes how the processing system 900 can infer anomalies of battery cells 1035 via machine learning. The method begins at step 500, where the processing system 900 accesses the hyper pixels 100 for an interrogation session of a battery cell 1035 and extracts and/or calculates ultrasound features from the response signals of the hyper pixels 100. According to step 502, the processing system 900 may perform one or more calculations upon the ultrasound features (e.g., time of flight, create transformed versions, create average values of response signals across a group of related hyper pixels). Then, in step 504, the processing system 900 passes the hyper pixels and/or the ultrasound features (and optionally, the one or more calculations performed upon the features) as input to a machine learning model 75 previously trained to infer anomalies in battery cells 1035. For this purpose, the model 75 is trained using information associated with one or more defect-free battery cells 1035. The output of the machine learning model is/are the inferred anomalies of or within the battery cell 1035.

Although some of steps 500-504 of FIG. 19 have been described as being performed once, in some embodiments, multiple repetitions of a particular step (or portion thereof) may be employed before proceeding to the next step. In addition, although steps 500-504 have been separately illustrated and described, in some embodiments, steps (or portions thereof) may be combined and performed together (simultaneously or sequentially). Moreover, although FIG. 19 illustrate a particular order for steps 500-0504, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIG. 19. Alternatively or additionally, in some embodiments, the method may comprise only some of steps 500-504 (or portions thereof).

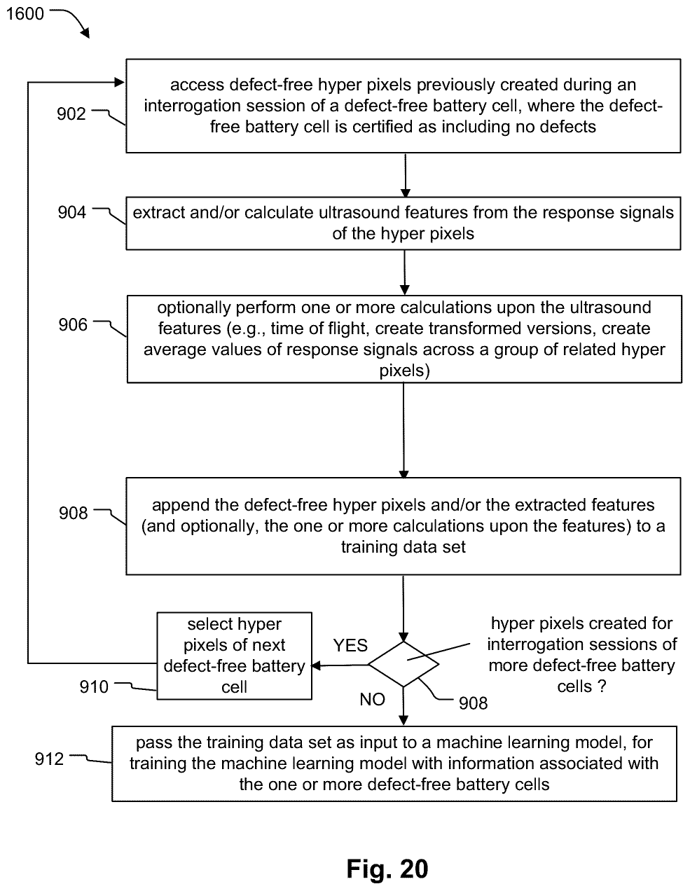

FIG. 20 is a flowchart that describes a method of operation 1600 of the processing system 900 for training a machine learning model 75 to infer anomalies in battery cells 1035. The method accesses sets of defect-free hyper pixels 100F previously created from interrogations sessions of defect-free battery cells. The method then includes the defect-free hyper pixels 100F in a training data set and applies the training data set to the machine learning model 75 to train the model. Each set of defect-free hyper pixels 100F is associated with a different defect-free battery cell (or a group of defect-free battery cells of the same type). For example, each defect-free battery cell can be of a same type as each of the battery cells 1035 under test; however, defect-free hyper pixels 100F obtained from defect-free battery cells of different types may also be used.

The method begins in step 902, where the processing system 900 accesses a set of defect-free hyper pixels 100F from the data repository 200. The set of defect-free hyper pixels 100F was previously created during an interrogation session of at least one defect-free battery cell. The defect-free battery cell is manufactured and tested to confirm that it is defect-free; a destructive teardown may also be performed on at least some of the defect-free battery cells to additionally confirm the lack of defects. In step 904, the processing system 900 extracts and/or calculates ultrasound features from the response signals of the defect-free hyper pixels 100F, and optionally performs one or more calculations upon the ultrasound features in step 906. In step 908, the processing system 900 appends the defect-free hyper pixels to a training data set. Additionally and/or alternatively, the processing system may also include the ultrasound features (and optionally, the one or more calculations upon the features) within the training data set.

If there are more sets of defect-free hyper pixels 100F in the data repository 200 to process in step 908, the method transitions to step 910 and selects the next set of defect-free hyper pixels 100F for the next defect-free battery cell. Control passes back to the beginning of step 902, and the next set of defect-free hyper pixels 100F are processed then appended to the training data set in steps 904-908. If there are no more sets of defect-free hyper pixels 100F in the data repository 200 to process, the method transitions to step 912, where the processing system 900 passes the training data set as input to a machine learning model 75 to train the model with the information associated with the one or more defect-free battery cells. Additionally and/or alternatively, the training data set may include the defect-free hyper pixels 100F.

Although some of steps 902-912 of FIG. 20 have been described as being performed once, in some embodiments, multiple repetitions of a particular step (or portion thereof) may be employed before proceeding to the next step. In addition, although steps 902-912 have been separately illustrated and described, in some embodiments, steps (or portions thereof) may be combined and performed together (simultaneously or sequentially). Moreover, although FIG. 20 illustrates a particular order for steps 902-912, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIG. 20. Alternatively or additionally, in some embodiments, the method may comprise only some of steps 900-912 (or portions thereof).

FIG. 21 is a flowchart that describes another method 1700 of the inspection system. In this method, the processing system 900 can perform an additional ultrasound interrogation session upon a battery cell 1035 that the inspection system has previously identified as including defects or anomalies. The processing system 900 can analyze the information obtained during the additional session to refine the identified defects or anomalies. This additional interrogation session is also known as a “second pass” interrogation session.

The method begins in step 1102, where the processing system 900 accesses hyper pixels 100 for a battery cell 1035 that the inspection system determined to include defects or anomalies. In step 1104, the processing system 900 identifies one or more areas of the battery cell 1035 where the defects or anomalies were found. In step 1106, the inspection system configures the controller 800 to perform another interrogation session of the battery cell 1035 at each of the identified areas of the battery cell, using a higher density of target points 110, 110′/target point pairs 210 in the areas than were previously used by the inspection system during the detection of the defects or the anomalies for the battery cell 1035 as a whole.

In step 1108, the inspection system optionally configures the controller 800 to additionally include nearest neighbor target points of the target points 110 for the areas. In step 1110, per the method of FIGS. 14-15, the inspection instructs the controller 800 to perform an ultrasound interrogation session for the areas, the result of which creates additional hyper pixels for the areas. According to step 1112, per the method of FIGS. 14-15, the controller 800 sends the additional hyper pixels for the areas to the processing system 900, which determines additional information concerning the battery cell based upon the additional hyper pixels (here, the additional information is limited to the anomalies or defects in the areas).

Although some of steps 1102-1114 of FIG. 21 have been described as being performed once, in some embodiments, multiple repetitions of a particular step (or portion thereof) may be employed before proceeding to the next step. In addition, although steps 1102-1114 have been separately illustrated and described, in some embodiments, steps (or portions thereof) may be combined and performed together (simultaneously or sequentially). Moreover, although FIG. 21 illustrate a particular order for steps 1102-1114, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIG. 21. Alternatively or additionally, in some embodiments, the method may comprise only some of steps 1102-1114 (or portions thereof).

### Additional Battery Cell Inspection Examples

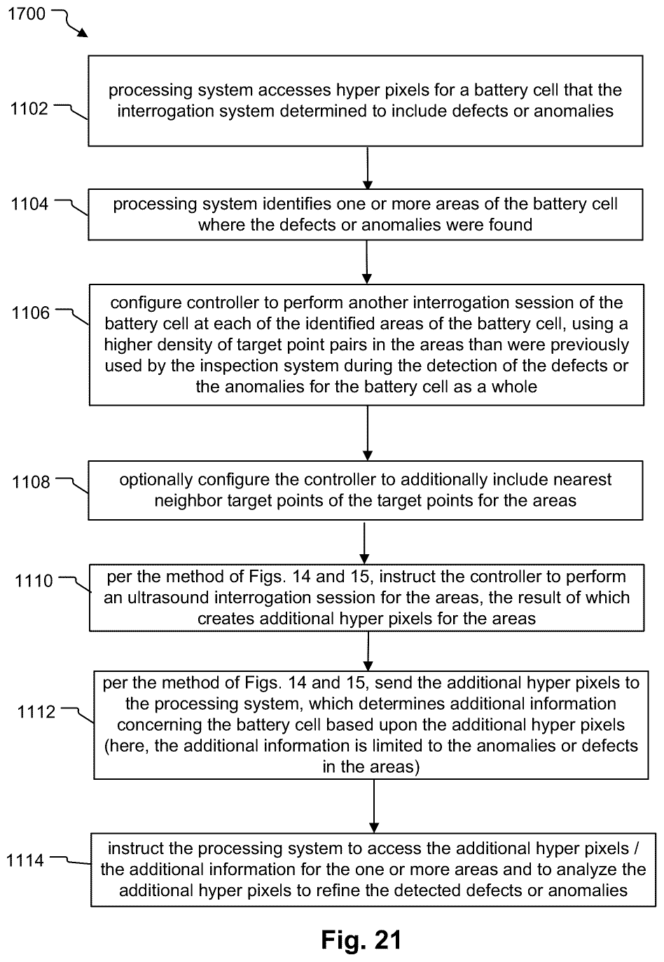

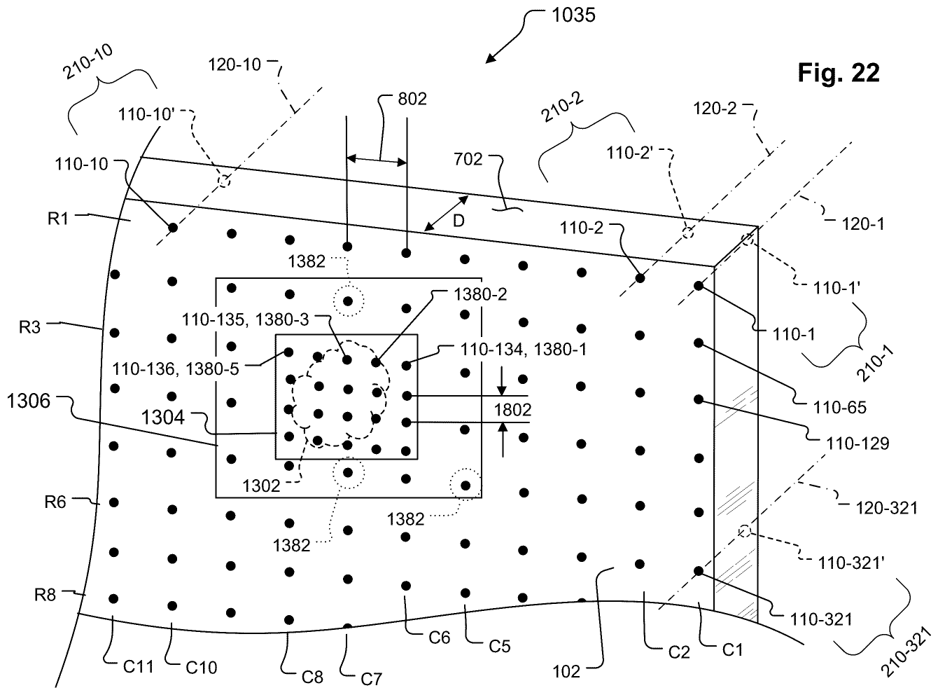

FIG. 22 shows an enlarged perspective view of a portion of a battery cell as in FIG. 13B. The figure also shows additional information associated with the battery cell 1035 that the method of FIG. 21 uses to perform the additional interrogation session of the battery cell 1035. In the illustrated example, the processing system 900 has identified at least one defect 1302 and defines a defect area 1304 that encloses the defect 1302. The defect area 1304 includes target points 110 that are located within the defect 1302 and includes target points that are located just outside but are adjacent to the defect 1302. By way of example, there are three target points at the top of the defect area 1304: target point 110-134, at position (R3, C6); target point 110-135, at position (R3, C7); and target point 110-136, at position (R3, C8).

The processing system 900 then defines a higher density of target point pairs in the defect area 1304 than was previously used by the inspection system during the interrogation session that determined the defect 1302. For this purpose, in one example, the processing system 900 defines a defect area target point distance 1802 that is smaller than the target point distance 802. The processing system 900 then instructs the controller 800 to perform an additional interrogation session upon the battery cell 1035 that is limited to the target points within the defect area 1304, and instead uses the defect area target point distance 1802 to define the density of target points within the defect area 1304.

During the start of the interrogation session, the controller 800 notionally superimposes defect area target points 1380 upon the surface 102 of the cell 1035 within the defect area 1304. In the illustrated example, the value of the defect area target point distance 1802 was defined to be half the value of the target point distance 802. As a result, as shown, there are approximately twice as many defect area target points 1380 included within the defect area 1304 as target points 110, and about half of the defect area target points 1380 coincide with an existing target point 110. Examples of defect area target points 1380 that coincide with a target point 110 include (110-134, 1380-1), (110-135, 1380-3) and (110-136, 1380-5).

The inspection system completes the interrogation session for the defect area 1304 of the battery cell 1034 and sends the additional hyper pixels obtained for the defect area to the processing system 900. The processing system 900 then analyzes the additional hyper pixels 100 to determine additional information concerning the defect 1302 within the defect area 1304 of the battery cell 1035 and uses the additional information to refine the defect 1302. In another implementation, the processing system 900 might also include nearest neighbor target points 1382 of the defect area target points 1380 when configuring the inspection system to perform the interrogation session for the defect area 1304. The nearest neighbor target points 1382 are enclosed within an enlarged defect area 1306 that encloses the defect area 1304.

### Inspection and Processing Details

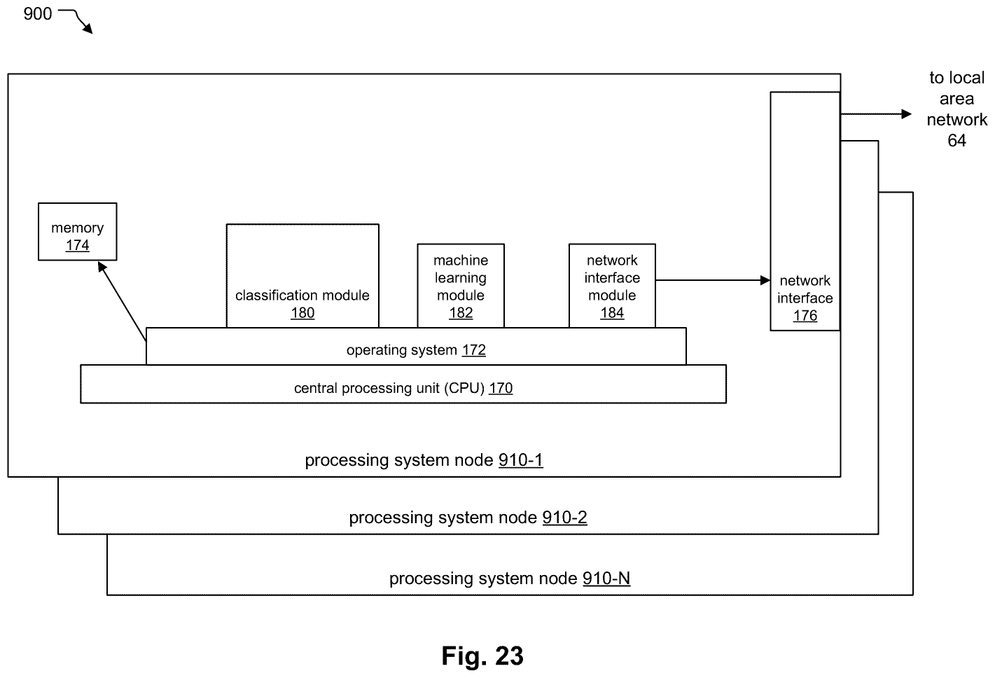

FIG. 23 shows more detail for the processing system 900. The processing system may comprise one or more processing nodes 910-1, 910-2 . . . 910-N. Each processing node 910 might be configured as a controller or as a microprocessor and includes a central processing unit (CPU) 170, an operating system 172, a memory 174, a network interface 176, and various software applications. The software applications include a classification module 180, a machine learning module 182, and a network interface module 184. In each processing mode 910, the network interface module 184 communicates with the network interface 176. The network interface 176, in turn, connects to the local area network 64. The operating system 172 loads instructions of the software applications into the memory 174 and schedules the applications for execution by the CPU 170. The processing nodes 910 collectively enable the processing system 900 (and thus the interrogation system) to both perform an interrogation session of each cell and to determine defects for each battery cell 1035 in a short time frame. In the high-speed inspection system 1000 of FIG. 1, for example, the inspection system might have a throughput rate, defined as the time to perform an interrogation session of each cell and to determine defects for each battery cell 1035, in a range between 30 and 55 battery cells per minute, inclusive, or greater than or equal to 55 battery cells per minute.

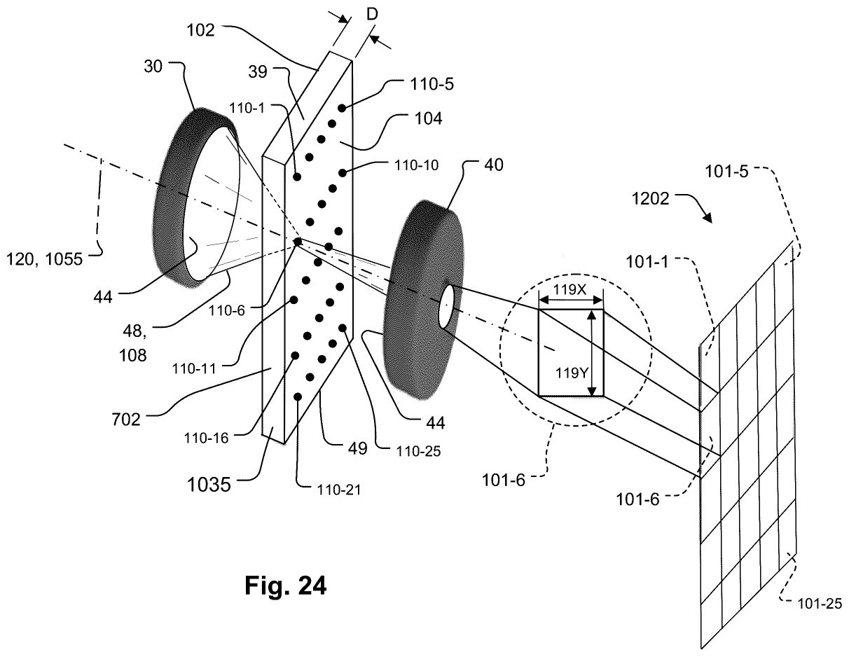

FIG. 24 shows two ultrasound transducers 30, 40 of an inspection system arranged on opposing sides of an exemplary battery cell 1035. For illustration purposes, only 25 target points 110-1 through 110-25 are configured and notionally superimposed upon the sides 102, 104 of the cell by the controller 800. Surfaces 102 and 104 of the battery cell 1035 and its target points 110 are shown. Both ultrasound transducers 30, 40 are configured to focus ultrasound signals into a focused beam (here, via an acoustic lens 44 attached to emission faces of the transducers 30, 40).

The ultrasound transducer 30, when operated as an ultrasound source, includes an acoustic lens 44 disposed proximate to the emission face of the transducer 30. The acoustic lens 44 is configured to focus the ultrasound exiting from the ultrasound transducer 30 (i.e., transmitted ultrasound 108) into a focused beam 48. The focused beam 48 can be directed to a single target point 110 without ultrasound impinging onto surrounded target points. The focused beam 48 is designed to achieve uniform intensity of the ultrasound transmitted throughout the thickness/depth D of the battery cell 1035. In one or more embodiments of an inspection system, each ultrasound transducer configured as an ultrasound source for transmitting ultrasound is positioned, opposed to, or paired with, an ultrasound transducer that is configured as an ultrasound sensor for detecting the transmitted ultrasound 108. Ultrasound transducers 30 and 40 form such an ultrasound transducer pair.

In the illustrated example, ultrasound transducer 30 transmits a focused beam 48 of ultrasound into side 102 of battery cell 1035 at target point 110-6, and the ultrasound is transmitted through the cell and exits at side 104. Ultrasound transducer 40 receives the through-transmitted ultrasound, and its acoustic lens 44 focuses the ultrasound into a focused beam, which the ultrasound transducer 40 then detects. The ultrasound transducer 40 generates a response signal for the detected ultrasound, and the response signal is stored as a hyper pixel value to the hyper pixel 100-6 for target point 110-6.

FIG. 24 also shows an anomaly map 1202 that the processing system 900 creates from selected hyper pixel values of multiple hyper pixels 100. The anomaly maps 1202 are two-dimensional color images of battery cells that enable operators to visualize defects. For this purpose, in the illustrated example, the processing system 900 might select a single hyper pixel value/response signal from each of hyper pixels 100-1 through 100-25, corresponding to target points 110-1 through 110-25. The processing system 900 then creates a 2D image representation 101 (i.e., a pixel) of each selected hyper pixel value of each hyper pixel 100-1 through 100-25. Exemplary pixel 101-6 is shown with dimensions 119X and 119Y. The pixel 101-6 is a 2D image created from a signal hyper pixel value/response signal of hyper pixel 100-6, associated with target point 110-6. In one example, the dimensions 119X, 119Y provide a resolution of 1 mm by 1 mm. The exact resolution is determined by the battery cell's geometry.

Each pixel 101-1 through 101-25 is then combined/“stitched together” to form a 2D image, also known as an anomaly map 1202. At the same time, it can be appreciated that a pixel does not have to be a specific size. With appropriate configuration of the inspection system, a pixel can be smaller (or larger) than 1 mm×1 mm. In another example, an anomaly map can be constructed from pixels that have dimensions 119X, 119Y of approximately 0.5 mm×0.5 mm. In one example, based upon customer objectives, the processing system 900 can create an anomaly map 1202 from selected “same input” hyper pixel values of a group of hyper pixels. This means that the selected hyper pixel values of each hyper pixel 100 are associated with the same input conditions (e.g., same excitation signals, ultrasound frequency, and interrogation mode) that were used when transmitting the ultrasound signals at the target points 110 associated with the hyper pixels 100. Because there can be many hyper pixel values per hyper pixel 100, the ability of the processing system to create different anomaly maps 1202 for the same group of hyper pixels 100 produces multiple “image slices” of a battery cell 1035. At the same time, when creating the anomaly maps 1202, it can also be appreciated that hyper pixel values associated with different input conditions may be selected from each hyper pixel. Additionally and/or alternatively, different processing algorithms can be applied to some selected hyper pixel values and not others, when creating the anomaly maps 1202.

During operation of the inspection systems 1000 and 2000, in examples, the processing system 900 can display the created anomaly maps 1202 (and other information derived from the anomaly maps 1202) on the display 820 of the controller 800, typically in real-time, upon completion of the interrogation of the cells in the interrogation zone 22. In this way, the customers can receive real-time feedback concerning characteristics of the battery cells.

The generated ultrasound emitted from each ultrasound transducer 30, 40 produces longitudinal wave oscillations that propagate through the battery cell 1035 along the transmission axis 1055 corresponding therewith. The longitudinal wave oscillations propagate energy and waveforms into the battery cell along the transmission axes 1055. A portion of the energy and waveforms exit from the battery cell 1035 when the energy and waveforms pass through an external surface of the battery cell 1035. Ultrasound waveform frequencies used for non-destructive testing by the inspection system can range between 20 KHz and 15 MHz, inclusive, with the selection of the one or more ultrasound interrogation frequencies for each ultrasound transducer depending on the materials and dimensions of the battery cell 1035. In another example, the range can be between 100 kHz and 10 MHz, inclusive. Lower frequency ultrasound penetrates deeper into a battery cell than higher frequency ultrasound. Thus, low frequency ultrasound is desirable for interrogating battery cells 1035 having a longer transmission axis 1055. Higher frequency ultrasound provides greater resolution, which enables detection of smaller defects 1302, and/or enables detection of more information about characteristics of the interior of the battery cell 1035. However, higher frequency ultrasound can carry less energy, one manifestation of which is a lower signal amplitude.

Ultrasound waveform characteristics generated by an ultrasound source depend on characteristics of the electrical excitation signal, characteristics of the ultrasound transmitter and environmental characteristics, e.g., temperature. The ultrasound waveform can be tailored to the battery cell 1035. In non-limiting exemplary embodiments, the frequency of the ultrasound wave is selected to excite/interrogate the battery cell 1035 at its resonant frequency. When the battery cell 1035 is excited at its resonant frequency, ultrasound input energy is both efficiently absorbed and re-emitted by structures within the battery cell 1035 to the ultrasound sensor. The ultrasound sensor therefore receives re-emitted ultrasound energy with higher ultrasound energy amplitude than would be received if the ultrasound frequency was not matched with a resonant frequency of the battery cell 1035.

The battery cell 1035 may have multiple resonant frequencies. Accordingly, there may be a plurality of ultrasound frequencies that can be selected to resonate the battery cell to absorb ultrasound energy and re-emit the ultrasound energy for detection by the ultrasound sensor. In non-limiting exemplary embodiments, the wavelength of the ultrasound wave is configured to be less than the battery thickness/depth dimension D. Additionally, a near field boundary separating a Fresnel region and the Fraunhofer region of the ultrasound wave occurs inside the battery cell 1035. However, it is also important to note that using ultrasound to excite battery cells 1035 at their resonant frequency is not an absolute requirement. While exciting materials (such as battery cells 1305) at their resonant frequency can improve the efficiency of the re-radiation of sound, exciting battery cells 1035 at their resonant frequency is not a limiting condition for material interrogation with ultrasound.

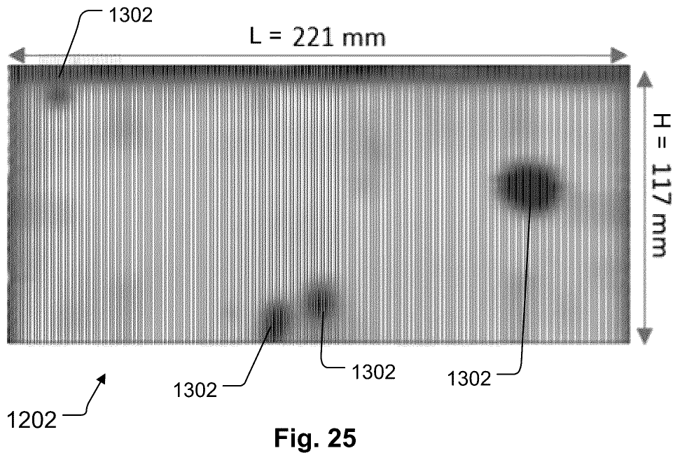

FIG. 25 is an example anomaly map 1202 for a battery cell 1035. The battery cell 1035 has a height H of 117 mm and a length L of 221 mm and includes multiple defects 1302. The processing system 900 can create many different anomaly maps 1202 for a battery cell 1035. For this purpose, the processing system is configured to either select different contents of the hyper pixels 100 for each anomaly map, and/or to use a different ultrasound feature of the selected contents. The phrase “using an ultrasound feature” refers to the operation of extracting a feature from the selected contents of/values of the hyper pixel 100, and/or possibly performing one or more calculations upon the hyper pixel values of the hyper pixel 100 and/or the extracted feature, and then applying the result of the calculation to the selected contents.

Using a “time of flight” ultrasound feature, in one example, can select contents of multiple hyper pixels 100 associated with pulse-echo interrogation mode of an ultrasound transducer, extract both the transmitted ultrasound signal and the response signal from the selected hyper pixels, calculate the elapsed time from when the transmitted signal was sent and the response signal was received, and then apply this result to the selected contents of the hyper pixels 100. After applying the ultrasound feature to the selected contents of the hyper pixels 100, the processing system combines or “stiches” the pixels into a 2D image representation to create the anomaly map 1202.

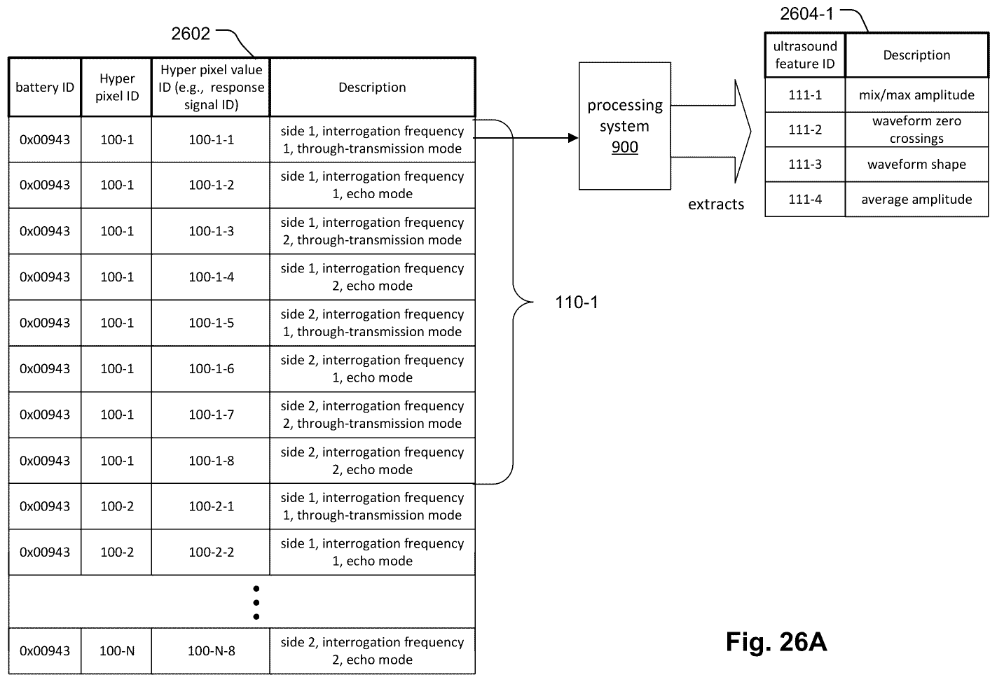

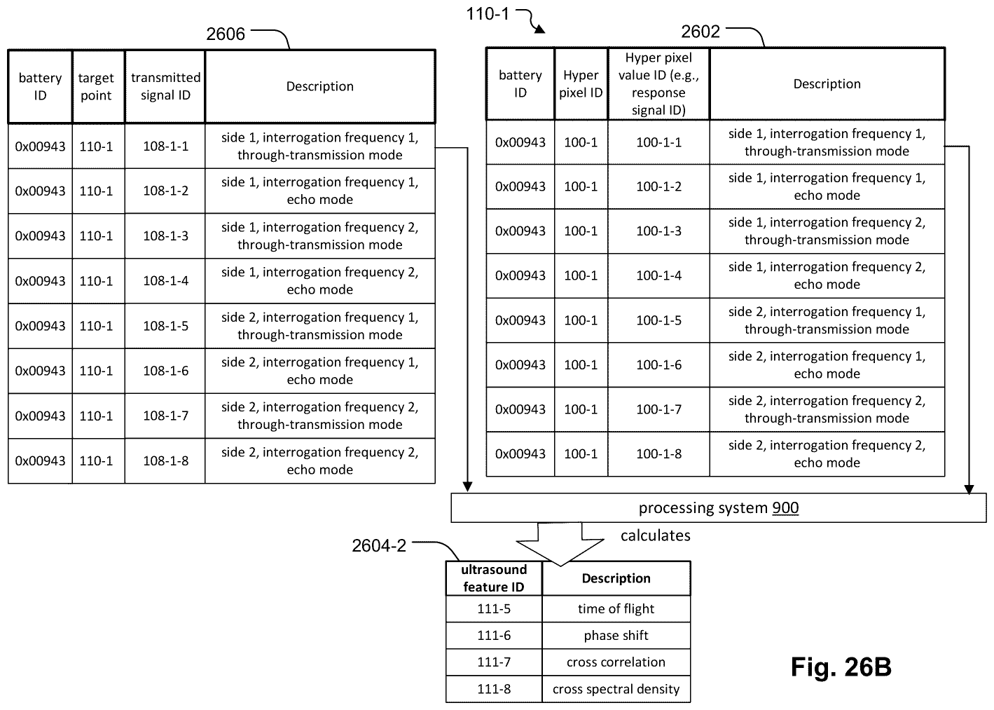

FIG. 26A illustrates how the processing system 900 can extract ultrasound features from the values of multiple hyper pixels 100. The figure includes an exemplary hyper pixel dataset 2602, in tabular format, on the left side of the figure, and an exemplary ultrasound feature table 2604-1 on the right side of the figure. The processing system 900 is configured to extract the ultrasound features from the hyper pixels 100, and to create anomaly maps 1202 of a battery cell 1035 based upon the contents of the hyper pixels 100 and/or the ultrasound features. The processing system 900 is also configured to create defect images from the anomaly maps 1202.

The hyper pixel dataset 2602, in tabular format, has columns including a battery ID, a hyper pixel ID (here, 100-1), a hyper pixel value, and a Description. There are eight (8) response signals/hyper pixel values per hyper pixel 100, corresponding to two different interrogation modes, upon each of two opposing sides (e.g., side 1 and side 2 of the battery cell, and at two different ultrasound frequencies. Eight hyper pixel values 100-1-1, 100-1-2, . . . 100-1-8 for the first hyper pixel 100-1, and eight hyper pixel values 100-N-1, 100-N-2, . . . 100-N-8 for the 100-Nth hyper pixel are listed in the table. The first eight hyper pixel values 100-1-1 through 100-1-8 are associated with first target point 110-1. The ultrasound feature table 2604-1 has an ultrasound feature ID column and a Description column, and four rows/entries 111-1 through 111-4. In the illustrated example, the processing system 900 extracts the ultrasound features 111-1 through 111-4 from only the response signal/hyper pixel value 100-1-1. In more detail, ultrasound feature 111-1 is a minimum and a maximum value for the response signal, ultrasound feature 111-2 is a number of and location of zero crossings of the response signal waveform, ultrasound feature 111-3 is a waveform shape of the response signal, and ultrasound feature 111-4 is an average amplitude of the response signal.

While FIG. 26A shows only the ultrasound features 111-1 through 111-4 that the processing system 900 extracts for a single hyper pixel value 110-1-1 of hyper pixel 100-1 for single target point 110-1, it can be appreciated that the processing system 900 extracts similar (and/or additional) ultrasound features for each of the hyper pixel values for each hyper pixel 100-1 . . . 100-N, associated with target points 110-1 . . . 110-N.

FIG. 26B illustrates how the processing system 900 can compute or otherwise obtain ultrasound features 111 from both the transmitted ultrasound signals 108 directed into each target point 110 and the associated response signals/hyper pixel values of each hyper pixel 100 for each target point 110. The figure includes: a portion of the hyper pixel dataset 2602 in FIG. 26A, where the portion is limited to the information for the first hyper pixel 100-1 of target point 110-1; a portion of a transmitted signal table 2606 for the same battery cell, also limited to information for the first target point 110-1/hyper pixel 100-1; and an exemplary ultrasound features table 2604-2 that includes ultrasound features 111 that the processing system 900 calculates from the transmitted signals and the hyper pixel values.

In the illustrated example, the transmitted signal table 2606, in tabular format, has columns including a battery ID, a target point ID (here, 110-1), a transmitted signal ID, and a Description. There are eight (8) transmitted signals for the target point 110-1, corresponding to two different interrogation modes, upon each of two opposing sides side 1 and side 2 of the battery cell 1035, and at two different ultrasound frequencies. Eight transmitted signal values 108-1-1, 108-1-2, . . . 108-1-8 are listed in the table. The ultrasound feature table 2604-2 has an ultrasound feature ID column and a Description column, and four rows/entries 111-5 through 111-8. In the illustrated example, the processing system 900 calculates the ultrasound features 111-5 through 111-8 from the transmitted signals and the response signals. In more detail, ultrasound feature 111-5 is a time of flight for the signal (transmit time+detection time); ultrasound feature 111-6 is a phase shift of the response signal relative to the transmitted signal; ultrasound feature 111-7 is a cross correlation of the response signal and the transmitted signal; and ultrasound feature 111-8 is a cross spectral density of the response signal and the transmitted signal 108. The processing system 900 is also configured to create anomaly maps of the battery cell 1035 based upon the contents of the hyper pixels 100 and/or the ultrasound features 111, and to create defect images from the anomaly maps 1202.

While FIG. 26B shows only the ultrasound features 111-4 through 111-8 that the processing system 900 calculates from the transmitted signals 108-1-1 through 108-1-8 and the hyper pixel values 100-1-1 through 100-1-8, for a single hyper pixel, it can be appreciated that the processing system 900 calculates similar ultrasound features for each of the hyper pixel values for each hyper pixel 100-1 . . . 100-N and their associated transmitted signals 108-1 . . . 108-N.

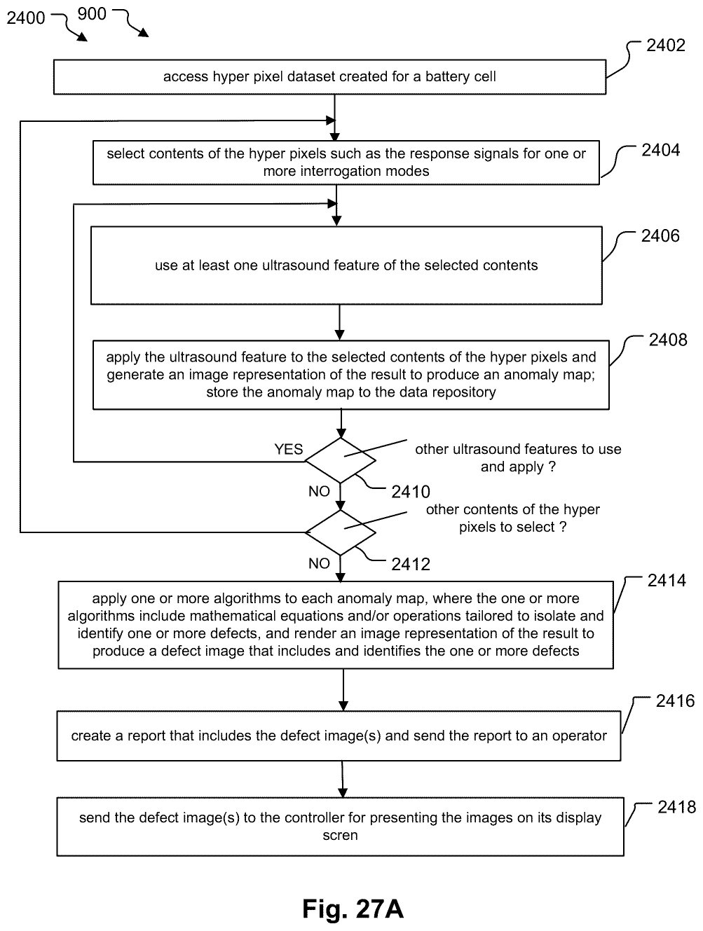

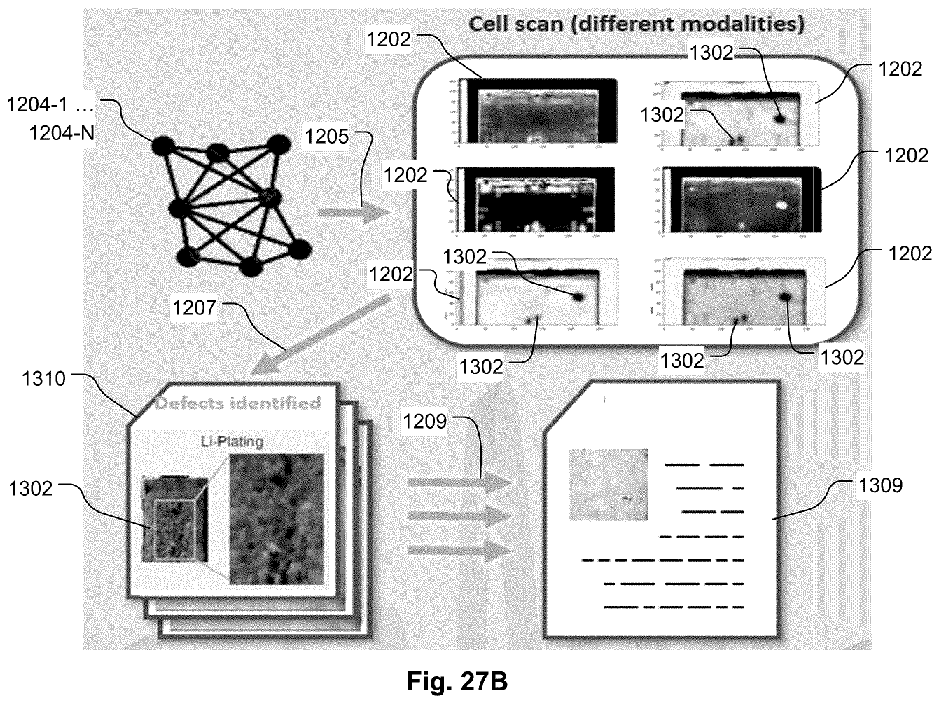

FIG. 27A is yet another method of the processing system 900 for determining characteristics of battery cells 1035 from hyper pixels 100. Here, the processing system 900 is configured to create one or more anomaly maps 1202 from the hyper pixels 100 and to create one or more defect images from the anomaly maps 1202. The defect images include and identify each of the defects/characteristics.

The method starts at step 2402, where the processing system 900 accesses hyper pixels 100 created for a battery cell 1035. The hyper pixels were previously created for the battery cell by the inspection system, in accordance with the method of FIGS. 14-15. In step 2404, the processing system selects contents of the hyper pixels 100, such as the response signals for one or more interrogation modes. According to step 2406, the processing system 900 uses at least one ultrasound feature of the selected contents. In step 2408, the processing system 900 applies the ultrasound feature to the selected contents of the hyper pixels 100 and generates an image representation of the result to produce an anomaly map 1202 and stores the anomaly map to the data repository 200.

In step 2410, the processing system 900 determines whether there are more ultrasound features to use and apply to the selected contents of the hyper pixels 100. If there are more ultrasound features 111 to use and apply, the method transitions back to the beginning of step 2406 to use the next ultrasound feature; otherwise, the method transitions to step 2412. At step 2412, the processing system determines whether there are other contents to select from the hyper pixels 100. If there are other contents to select, the method transitions back to the beginning of step 2404 to select the other contents; otherwise, the method transitions to step 2414.

In step 2414, the processing system 900 applies one or more algorithms to each anomaly map 1202. The one or more algorithms include mathematical equations and/or operations tailored to isolate and identify one or more defects. Different algorithms may be selected for each anomaly map 1202 based on customer objectives. The processing system 900 then renders an image representation of the result of applying the algorithms to each anomaly map 1202 to produce a defect image that includes and identifies the one or more defects 1302. According to step 2416, the processing system 900 can create a report that includes the defect image(s) and can send the report to an operator via a user device (e.g., mobile phone, laptop computer) carried by the operator. In step 2418, the processing system 900 can also send the defect image(s) 1310 to the controller 800 for presenting the images 1310 on its display screen 820.

Although some of steps 2402-2418 of FIG. 27A have been described as being performed once, in some embodiments, multiple repetitions of a particular step (or portion thereof) may be employed before proceeding to the next step. In addition, although steps 2402-2418 have been separately illustrated and described, in some embodiments, steps (or portions thereof) may be combined and performed together (simultaneously or sequentially). Moreover, although FIG. 27A illustrate a particular order for steps 2402-2418, embodiments of the disclosed subject matter are not limited thereto. Indeed, in certain embodiments, the steps (or portions thereof) may occur in a different order than illustrated or simultaneously with other steps (or portions thereof). In some embodiments, a method can include steps or other aspects not specifically illustrated in FIG. 27A. Alternatively or additionally, in some embodiments, the method may comprise only some of steps 2402-2418 (or portions thereof).

FIG. 27B graphically illustrates steps 2414 and 2416 in the method of FIG. 27A. The figure shows how the processing system 900 applies (reference 1205) one or more algorithms 1204-1 . . . 1204-N located in the upper left corner of the figure to six (6) anomaly maps 1202 shown in the upper right corner of the figure. The anomaly maps 1202 may include one or more defects 1302. Reference 1207 indicates that the processing system 900 applies the one or more algorithms 1204-1 . . . 1204-N to each of the anomaly maps 1202 to produce different defect images 1310 shown in the lower left corner of the figure. The defect images 1310 include and identify defects 1302 in the battery cell 1035. A Lithium plating (Li-Plating) defect 1302 is one of the identified defects. Reference 1209 indicates that the processing system 900 can then compile a defect report 1309, shown in the lower right corner of the figure, which includes the defect images 1310 and possibly other information concerning each identified defect and/or inferred anomaly.

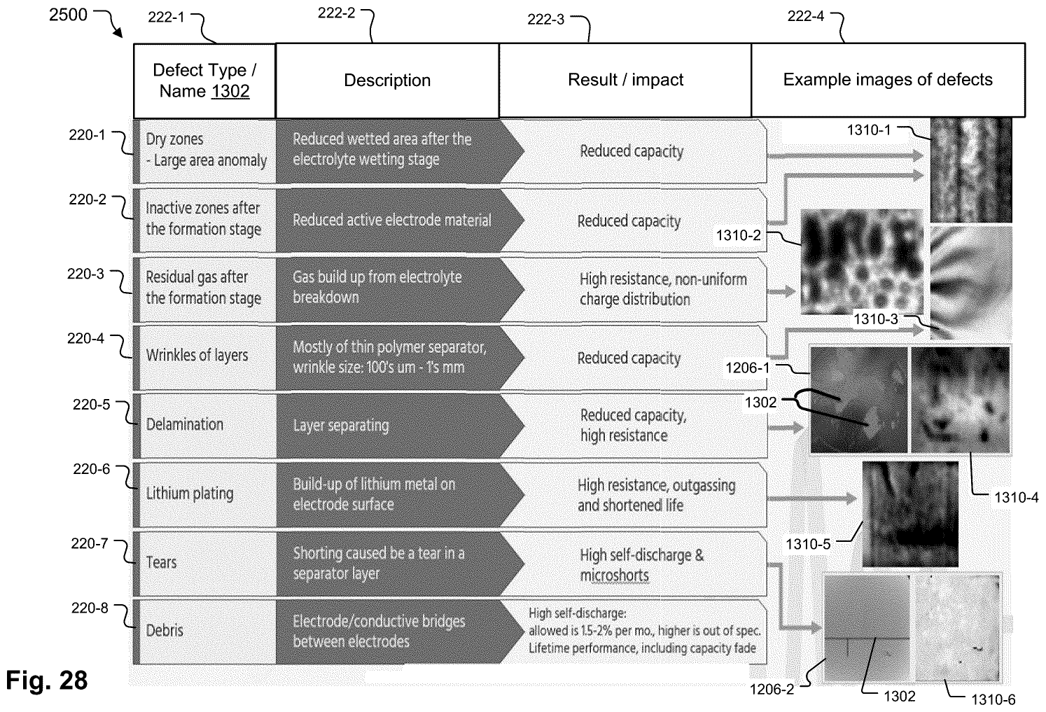

FIG. 28 is a defect table 2500 that lists example defects 1302 that the inspection systems can detect. The table also lists detailed information associated with each defect 1302 including a description, a result or impact of the defect upon the cells, and associated images of the defect 1302. These images include photographic images of the defect 1302 taken after a destructive teardown of the battery cell 1035 and defect images 1310 produced by the processing system 900 in accordance with the method of FIG. 27A.

The result or impact of the defect has economic consequences. Defects in battery cells have traditionally been difficult to determine without expensive equipment such as the CT inspection systems, and these systems cannot cost effectively test each and every battery cell. Rather, it is typically the case that a representative battery cell such as every 100th battery cell in an assembly line is removed from the line and inspected by the CT inspection systems for defects. Moreover, because the CT inspection systems can take on the order of hours to inspect each cell 1035, manufacturers typically forego testing of a representative cell at each stage of the manufacturing process. Rather, manufacturers generally inspect the representative cells at the formation and post-formation stages of manufacturing. In contrast, embodiments of the inspection systems can possibly inspect each and every battery cell 1035 for defects and anomalies during each of the manufacturing stages. Moreover, because the inspection system can determine the defects and anomalies on the order of seconds, it is also possible to both inspect many more battery cells during manufacturing as compared to existing inspection systems, and to inspect the cells without removing them from the assembly line to do so, as in the existing inspection systems.

More detail for the defect table 2500 is as follows. Rows 220-1 through 220-8 list eight (8) common defects 1302 that the inspection system can detect. Columns 222-1 through 222-4 have the following headings: Defect Type/Name, Description, Result/Impact, and Example Images of Defects, respectively. Row 220-1 presents a dry zone defect which can cover a large area of the battery cell 1035. It is associated with a reduced wetted area after the electrolyte filling/wetting stage of battery cell manufacture. This defect results in reduced capacity of the cell, and an example defect image 1310-1 that includes and identifies the defect 1302 is shown. Row 220-2 presents an inactive zone defect which occurs after the electrolyte wetting stage. It is associated with reduced active electrode material, and generally results in reduced capacity of the cell. Defect image 1310-1 also includes this defect. Row 220-3 presents a residual gas defect which occurs after the formation stage. It is associated with increased gas buildup in areas of the cell 1035, due to breakdown of the electrolyte. This defect results in high resistance, non-uniform charge distribution within the cell 1035. Defect image 1310-2 includes and identifies the defect. Row 220-4 presents a layer wrinkling defect. It occurs when portions of the layers of the cathode/separator/anode assemblies are not flat and uniform and have folds or wrinkles. Most often, wrinkling occurs within the thin polymer separator layer of the assemblies and the size of the wrinkles are generally in the range of 100 micrometers (μm) to about 2 mm. This defect results in reduced capacity of the cell, and defect image 1310-3 includes and identifies the defect 1302.

Row 220-5 presents a delamination defect, in which one or more layers in a cathode/separator/anode assembly have separated from an adjacent layer, either in the same assembly or between assemblies. The defect is associated with reduced battery cell capacity and increased resistance. Defect image 1310-4 includes this defect, and photographic image 1206-1 shows at least two instances of the defect 1302 after a destructive teardown of the same battery cell 1035. Row 220-6 presents a lithium plating defect, which is associated with buildup of lithium metal on one or more electrode surfaces. This is a common defect that generally worsens over time with increasing number of charge/discharge cycles of the cell 1035, but should not be present during manufacturing of the cell. This defect results in high resistance, outgassing and shortened battery cell life. Example defect image 1310-5 includes and identifies this defect 1302. Row 220-7 presents a tear defect. Tears are gaps in the separator layer of an assembly that cause electrical shorts between the anode and cathode layers in the locations where the tears exist. This defect results in high self-discharge and micro shorts, outgassing and shortened battery cell life. Defect image 1310-6 includes and identifies this defect. Photographic image 1206-2 of the cell, taken after a destructive teardown of the cell 1035, also shows this defect 1302. Row 220-8 presents a debris defect. Debris can be any excess material in the cell that causes unwanted conductive bridges between electrodes. This defect is associated with high self-discharge; about 1.5% or 2% self-discharge per month is generally acceptable. This defect impacts lifetime performance, including capacity fade over time.

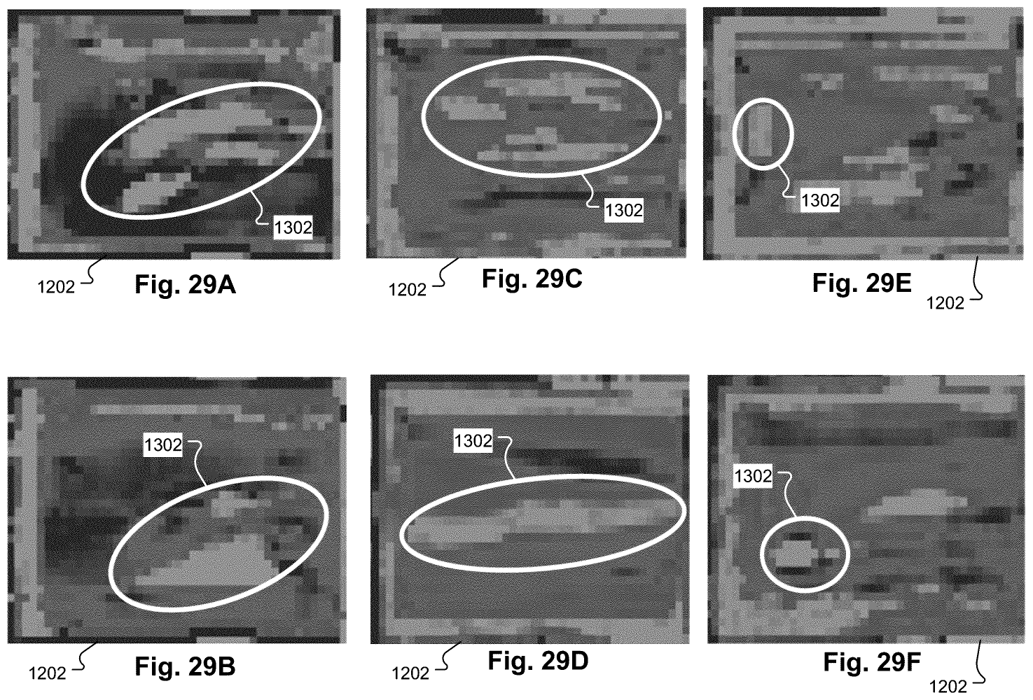

FIGS. 29A-29F are anomaly maps 1202 created for different exemplary 27 Ampere-hour (Ah) prismatic battery cells. FIGS. 29A-29B are associated with surface gas defects, where gas pockets have formed between an inside of the cell's housing and an adjacent layer of the battery cell's series of stacked anode/separator/cathode layers. FIGS. 29C-29D are associated with electrode wrinkling defects, while FIGS. 29E-29F show interlayer anomalies caused by gas generation within the layers. This gas generation within multiple layers is typically due to lithium plating of the electrodes or other undesired reaction within the layers.

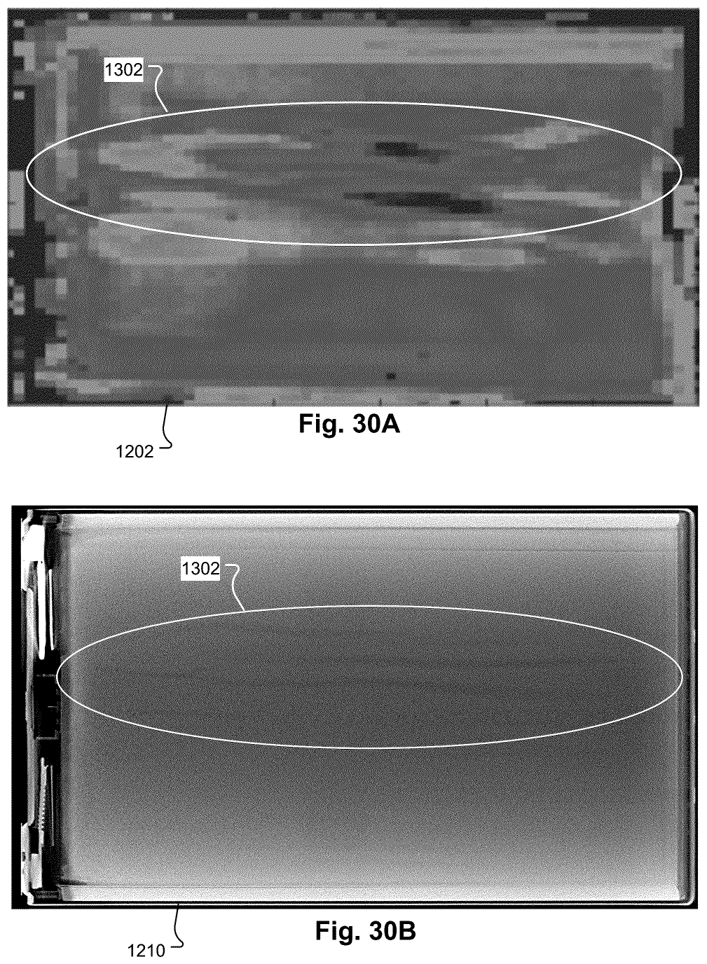

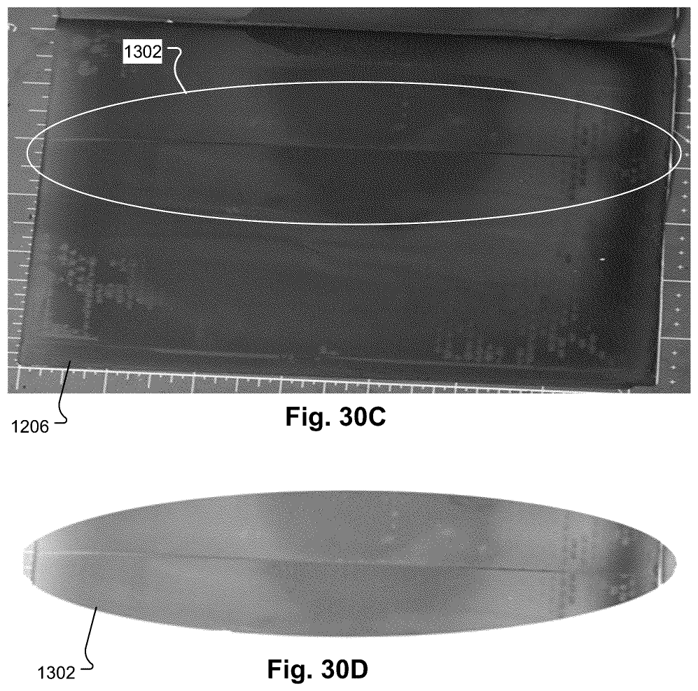

FIGS. 30A-30D are images associated with severe wrinkling of electrode defects 1302 in a battery cell. FIG. 30A is anomaly map 1202 of the battery cell that shows instances of the wrinkling across nearly 30% of its cell volume. FIG. 30B is a CT scan image 1210 of the same battery cell that shows indicia of the same defect for validation purposes. FIG. 30C is a photographic image of the same battery cell taken after the battery cell was destructively torn down that also shows the defect 1302, also for validation purposes. FIG. 30D shows an enhanced image of the defect 1302 in FIG. 30C.

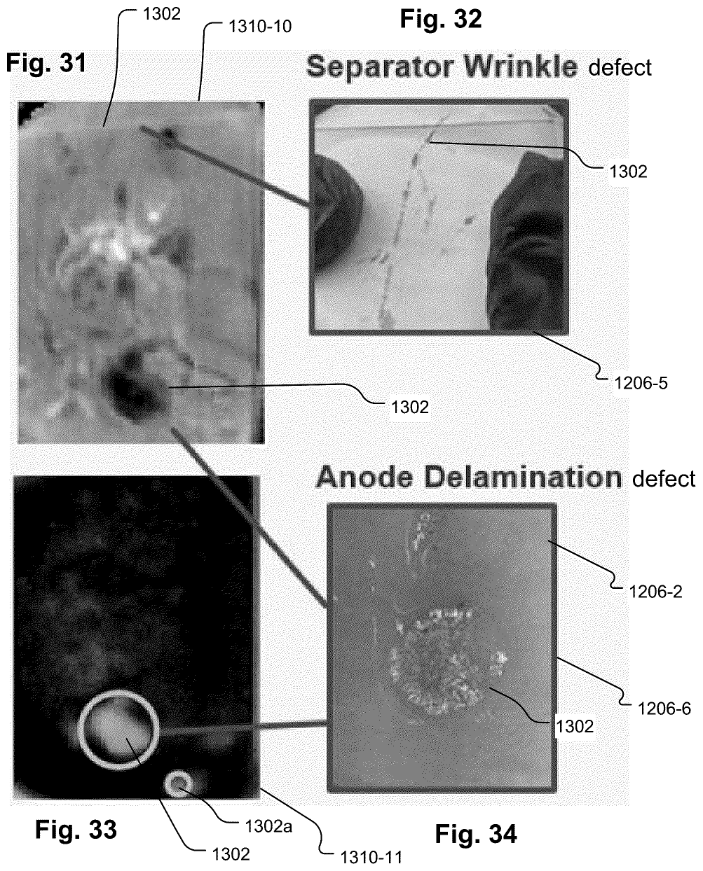

FIGS. 31-34 are images associated with a separator layer wrinkle defect and an anode delamination defect in a same battery cell 1035. FIG. 31 is a defect image 1310-10 of the cell produced by the inspection system that includes and identifies both defects. Here, the wrinkle defect appears as a faint, substantially horizontal line that spans the width of the image near its top. FIG. 32 is a magnified photographic image 1206-5 of a separator layer wrinkle defect, taken after a destructive teardown of the cell 1035. The photographic image 1206-5 is rotated approximately 90 degrees with respect to the defect image 1310-10 such that the wrinkle defect in image 1206-5 is shown as a line that extends substantially vertically from a bottom of the image to its top. FIG. 33 is a different defect image 1310-11 that includes and identifies anode delamination defects only. In the illustrated example, the anode delamination defect 1302 and an additional anode delamination defect 1302a are identified. FIG. 34 is a magnified photographic image 1206-2 of the anode delamination defect taken after a destructive teardown of the cell 1035.

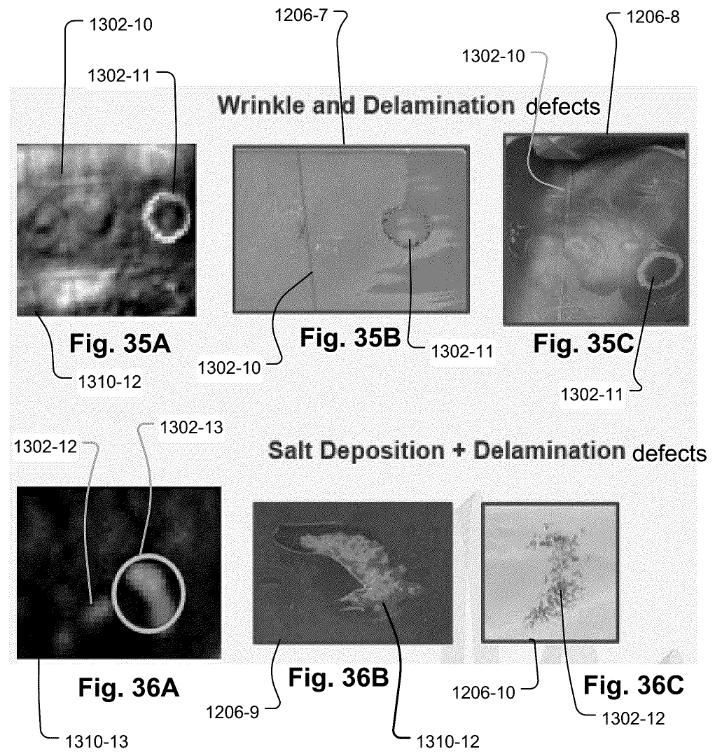

FIGS. 35A-35C are additional images associated with separator wrinkle and anode delamination defects 1302 in a battery cell 1035. FIG. 35A is defect image 1310-12 produced by the inspection system that includes and identifies both a wrinkle defect 1302-10 and a delamination defect 1302-11. FIGS. 35B-35C are different photographic images 1206-7 and 1206-8 of the cell 1035 taken after a destructive breakdown of the cell that show both defects 1302-10 and 1302-11. The photographic images 1206-7, 1206-8 were taken at different exposure and depth of field settings.

FIGS. 36A-36C are images associated with salt deposition and anode delamination defects 1302 in a battery cell 1035. FIG. 36A is defect image 1310-13 of the cell produced by the inspection system that includes and identifies both a salt deposition defect 1302-12 and an anode delamination defect 1302-13. FIGS. 36B-36C are different photographic images 1206-9 and 1206-10 of the cell taken after a destructive breakdown of the cell 1035, taken at different exposure and depth settings. The images show only the salt deposition defects 1302-12. In this example, the anode delamination defect 1302-13 is not visible in the photographic images 1206-9 and 1206-10 because the salt deposition defect 1302-12 is large and obscures anything underneath it from view.

At the same time, as shown in FIG. 36A, the anode delamination defect 1302-13 can be identified by the inspection system. For this purpose, in accordance with the method of FIG. 27A, an anomaly map 1202 was first created by configuring the processing system 900 to select information associated with the hyper pixels 100 that has been experimentally determined to include this defect. The processing system 900 then uses one or more ultrasound features 111 of the contents of the hyper pixels 100 that have been experimentally determined to reveal this defect (and to possibly exclude other defects), and then applies the ultrasound features to the selected contents to create the anomaly map 1202. The processing system 900 then applies one or more algorithms 1204 that have been experimentally determined to isolate and identify anode delamination defects within the anomaly map 1202 to create the defect image 1310-13.

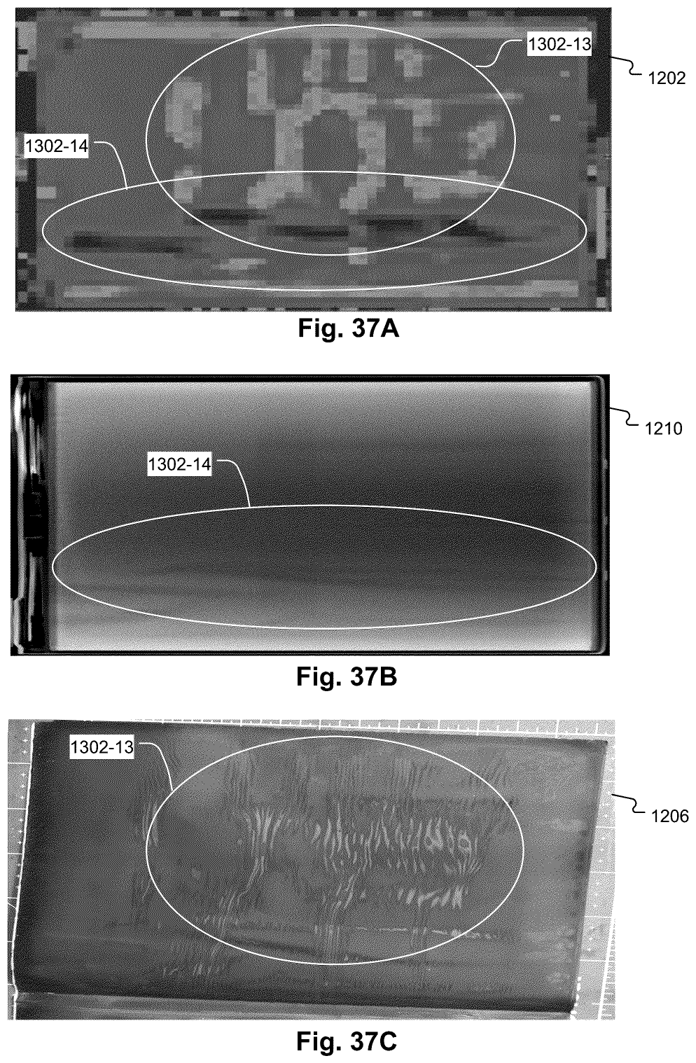

FIGS. 37A-37C are images that show severe wrinkling of electrode defects and vertical spot defects in a battery cell 1035. FIG. 37A is anomaly map 1202 of the battery cell that shows a vertical spot defect 1302-13 and a wrinkling defect 1302-14. FIG. 37B is a CT scan image of the same cell that shows only the wrinkling defect, while FIG. 37C is a photographic image of the same cell taken after the battery cell was destructively torn down that shows only the vertical spot defect 1302-13. Upon destructive tear down of the cell, the vertical spot defects 1302-13 were determined to be present in multiple slices or layers of the cell 1035 and caused by gas generation resulting from lithium plating or other undesired chemical reactions within the battery cell 1035. The vertical spot defects 1302-3 have been experimentally shown to lower capacity and battery life.

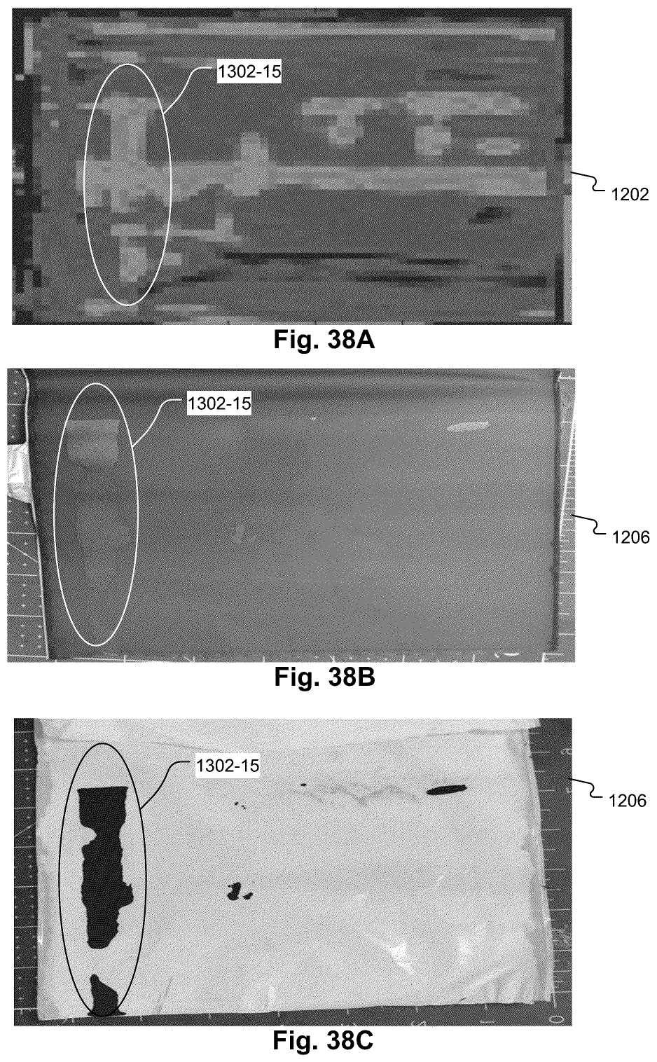

FIG. 38A-38C are images that show a vertical pattern defect 1302-15 related to electrode delamination and layer thickness deviations in a battery cell. In more detail, FIG. 38A is anomaly map 1202 that shows the defect 1302-15. FIG. 38B is a photographic image 1206 of the same battery cell taken after cell was destructively torn down that shows the defect 1302-15 on an outside layer of the anode/separator/cathode layers. FIG. 38C shows the defect 1302-15 on the bag 704 that houses the layers. Causes of the vertical pattern 1302-15 include a tear during the electrode cutting process and compression concentrated in the area of the defect. Destructive tear down of the cell confirmed anode delamination and a missing cathode. Effects of the anode delamination include increased resistance and lower capacity, while effects of the missing anode include lower capacity and the likelihood of an internal short circuit occurring. Such a short circuit has been experimentally shown as a factor for thermal runaway of the battery cell.

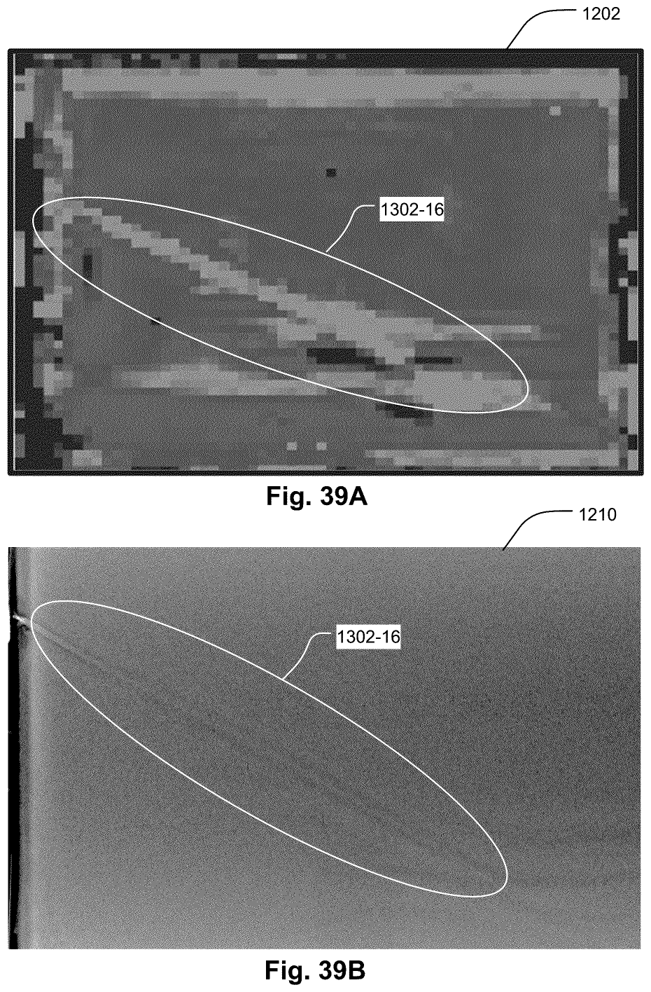

FIG. 39A-39B are images that show severe wrinkling of electrode defects in a battery cell. FIG. 39A is anomaly map 1202 that shows the wrinkling defect 1302-16, which appears as a large diagonal pattern that extends over most of its length. FIG. 39B is a CT scan image 1210 of the same battery cell that shows the wrinkling defect 1302-16 and revealed that the cause of the defect was due to a tear or wrinkle in the separator of one of the anode/separator/cathode layers. Upon destructive break down of the cell, the wrinkle defect was found to be on the outside layer of the anode/separator/cathode layers. As a result, this defect would likely have had minimal impact upon the operation, capacity and life cycle of the cell.

The inspection systems 1000, 2000, 3000, 4000, and 5000 also use immersive methodology to provide an efficient acoustic signal coupling between the ultrasound transducers 30, 40 and the battery cell 1035. The inspection systems can use, for example, de-ionized water, mineral oils, or other suitable liquids as the couplant. Additionally, the system is contactless, meaning no pressure is applied to the battery cell. This can make the system safer than contact-based interrogation systems, without impacting performance, while also being optimized for high throughput quality control. The inspection systems can include one or more ultrasound transducers. The ultrasound transducers may be part of larger module or array and may be configured in a paired manner, where each transducer of the pair is directly opposed to the other. At least one of these pairs of transducers is designed to transmit ultrasound signals into the battery cell in transmission mode and at least one of these transducers is designed to transmit in echo/reflection mode. Equally, the inspection system is designed to receive ultrasound signals in both transmission and reflection mode. This allows for dual-sided ultrasound interrogation of battery cells. The dual-sided ultrasound interrogation enables speed of sound, depth mapping, and defect detection to a sub-millimeter resolution. In one example embodiment of the inspection system, ultrasound transducers are located near one side or surface of the battery cell and operate in echo/reflection mode.

In another implementation, using a deterministic method, the inspection system can provide a direct physical analysis and characterization of a battery cell. In this method, the system may tag any physical non-uniformity of the battery cell caused by material properties and/or manufacturing processes of the battery cell. These physical non-uniformities can include non-uniform wetted areas, wrinkles, alignment, contaminants, and tears, in examples.

In yet another implementation, the inspection systems create a hyper pixel at each target point. The hyper pixel may include the ultrasound signals transmitted into the battery cell into the target point, and include the response signals generated for the ultrasound detected at each target point. The hyper pixel might also include combinations of ultrasound features extracted and/or calculated from the transmitted ultrasound signals and the response signals. In this way, each hyper pixel carries multi-dimensional information about the battery cell, including: time domain physical properties such as amplitude, time of flight, phase, and instantaneous frequency; frequency domain physical properties such as peak frequency, center frequency, bandwidth, upper/lower frequency at some level from peak; and mixed time/frequency domain properties such as attenuation and a speed of sound (global, local).

In yet another implementation, the inspection systems receive and analyze the data of the hyper pixels near-instantaneously of the dry zones, wrinkles, detecting contaminants, alignment, separator tears; thereby enabling every cell that undergoes the manufacturing process to be inspected, as opposed to conventional systems that rely on sample or batch testing.

The inspection systems may also form the transmitted ultrasound into a focused beam at each target point 110. For this purpose, in one example, the ultrasound transducers may incorporate a variety of lenses, which may include Fresnel lenses and/or beam-forming elements. In this example, the transducers can be manufactured (or otherwise configured or adapted) to focus the beam, enabling the two opposing transducers or a single transducer to focus with respect to a battery cell interrogation zone that includes at least one target point of the battery cell and part of the immersive couplant. In another example, multiple transducers are configured as part of an array that focuses the transmitted ultrasound into a focused beam at each of the target points. In yet another example, the inspection systems can include electronics and other components coupled with the transducers to form and/or steer the ultrasound into a focused beam.

The inspection systems can also transmit ultrasound acoustic signals at one or more edge points of the battery cell to determine the precise alignment of the cathode, anode, and separator layers within the battery cell. Multiple frequencies of the transmitted ultrasound can be used. In some embodiments, this alignment may be critical during manufacturing of battery cells and impacts the integrity and longevity of each battery cell. The detection of alignment issues during manufacturing reduces scrap and improves yield.

### Additional Battery Cell Inspection and Monitoring Examples

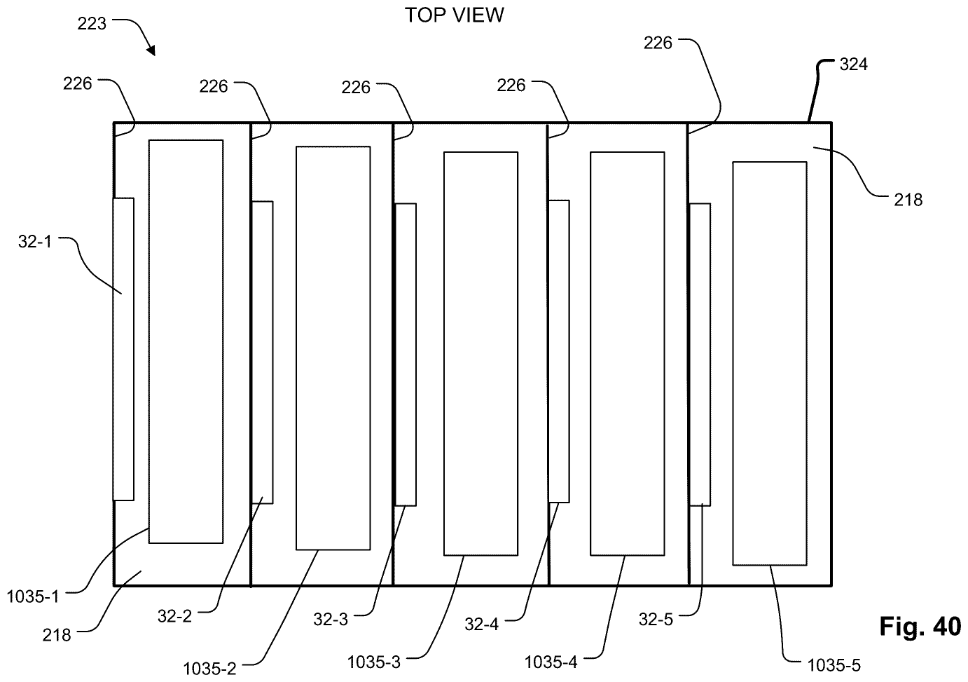

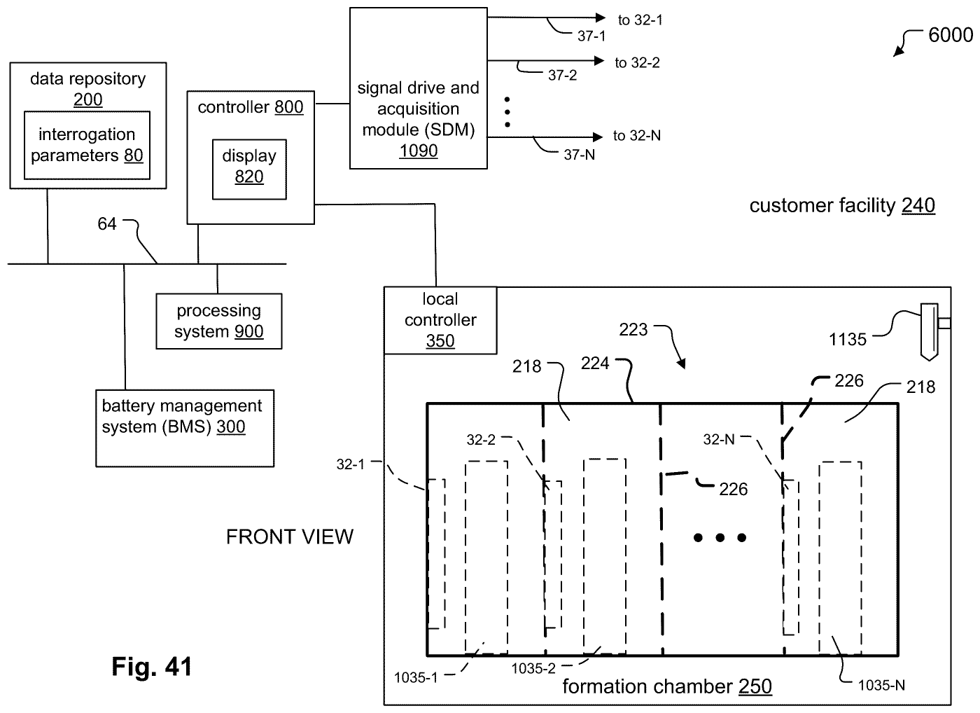

FIGS. 40-47 illustrate embodiments of still other inspection systems and their components for monitoring battery cells 1035. Here, the inspection systems are directed towards determining characteristics of battery cells during and after the cell formation process. In general, the inspection systems of FIGS. 40-47 enable direct detection and determination of the quality of a battery cell during its formation stage, with an emphasis on stages during and post the electrolyte soaking process. For this purpose, the systems detect and label anomalies including process and material anomalies. Examples of these anomalies include: dry zones due to inadequate soaking, wrinkles present in the separator, anode, or cathode, contaminants like shavings and splattering, alignment of battery cell layers (anode, cathode, & separator) and instances of separator tears. The method includes the following steps: emitting ultrasound acoustic signals at one or more frequencies (narrow or broad band) with a focused ultrasound beam to achieve uniform intensity throughout the thickness of the battery cell (interrogation zone); equally, the acoustic signal will pass through the battery cell across one or more points either in transmitting and/or receiving mode in various sections of the battery cell; and subsequently, the acoustic signal data is captured, processed, and critically analyzed to directly measure and ascertain the physical attributes and quality of the battery cell.

FIG. 40 shows a top view of an exemplary sensing fixture 223 for use in a battery cell inspection system configured to interrogate battery cells during a formation stage of the battery cells 1035. The sensing fixture 223 has a housing 224 that is designed to accept multiple prismatic battery cells 1035. Five cells numbered 1035-1 through 1035-5 are shown in the illustrated example; however, any number of cells (and/or cells of different sizes) is possible according to one or more contemplated embodiments. The sensing fixture 223 is partitioned into five sections 218 of approximately equal size, each of which accepts a separate battery cell 1035. Within each section, an ultrasound transducer module 32 is attached to an inside wall 226 of the housing 224. In the illustrated example, only one ultrasound transducer module per section/per battery cell 1035 is shown. Specifically, ultrasound transducer modules 32-1, 32-2, 32-3, 32-4, and 32-5 are associated with battery cells 1035-1, 1035-2, 1035-3, 1035-4 and 1035-5, respectively. It can also be appreciated that the sensing fixture 223 can be designed to have different sized sections within the same housing 224. Such a sensing fixture 223 can monitor different sizes and types of battery cells 1035 within the same housing 224.

FIG. 41 shows a proposed battery cell inspection system (“inspection system”) 6000 configured to assess characteristics of battery cells 1035 during the formation stage of the battery cells 1035, according to one or more embodiments. The inspection system 6000 is designed for use in a customer facility 240 such as a battery cell manufacturing facility. In the illustrated example, the inspection system 6000 includes a formation chamber 250, a sensing fixture 223, a controller 800, a signal drive and acquisition system (SDM) 1090, a processing system 900, a data repository 200, and a battery management system (“BMS”) 300. Fewer or additional components for the inspection system 6000 are also possible according to one or more contemplated embodiments.

In the illustrated example, a front view of the formation chamber 250 is shown. The formation chamber 250 is designed to perform the formation steps of battery cells 1035 under controlled temperature, pressure, and/or humidity. A door of the formation chamber 250 is removed from its front (or otherwise positioned to allow interior access) to enable view of the sensing fixture 223, which an operator (or other means, shows as a robotic system) loads into the formation chamber 250 at its front. The formation chamber 250 includes a local controller 350 and a sensor 1135 (or a suite of sensors) that measures temperature, pressure, and/or humidity. In some embodiments, the local controller 350 can also include a display screen and/or an input device (not shown), for example, to allow an operator to interact with the system 6000.

Ultrasound transducer modules 32-1 . . . 32-N and battery cells 1035-1 . . . 1035-N within the sections 218 of the sensing fixture 223 are shown in phantom. The SDM 1090 has separate transducer connections 37-1 . . . 37-N to each of the ultrasound transducer modules 32-1 . . . 32-N of the sensing fixture 223. Each transducer connection 37 functions as both a control pathway from the SDM 1090 to an ultrasound transducer module 32, and as a data pathway from the ultrasound transducer module 32 to the SDM 1090. Unlike the inspection systems 1000, 2000, 3000, 4000 and 5000, the ultrasound transducers of inspection system 6000 are contact transducers. Namely, faces of the transducers are in contact with the battery cells 1035 (with or without a liquid or dry couplant located therebetween), and neither the transducers nor the battery cells 1035 in the inspection system 6000 are immersed in an electrically non-conductive fluid.

In the illustrated example of FIG. 41, a local network 64 is also shown. In some embodiments, the local network 64 can be a high-speed local area network that is local to a facility that includes the inspection system 6000. The local network 64 can use standard data communications protocols such as Gigabit Ethernet for data exchange and messaging or proprietary communications protocols, in examples. The data repository 200 includes information that is used by the inspection system 6000 during the formation process, and also stores information created and/or otherwise obtained by the inspection system 6000 as a result of each step in the formation process. The information used by the inspection system 6000 can include interrogation parameters 80. The SDM 1090 uses the interrogation parameters to configure each of the ultrasound transducer modules 32 as ultrasound sources and/or as ultrasound sensors, and to configure excitation signals that the SDM sends to each of the ultrasound transducer modules 32 configured as ultrasound sources, in examples.

The BMS 300 can be used to manage the interrogation system 6000 during its operation. In some embodiments, the BMS 300 monitors various aspects of the system and can disable or otherwise abort operation of the system in response to detecting unsafe conditions with the battery cells 1035. Additionally or alternatively, in some embodiments, the BMS 300 can be used by an operator to configure the components of the inspection system 6000 and execute the steps of the formation process.

In one or more embodiments, the inspection system 6000 is arranged as follows. The system controller 800 connects to the SDM 1090 and the local controller 350 and has a connection to the local network 64. The connection to the local network 64 enables the SDM 1090 to communicate with the processing system 900, the BMS 300 and the data repository 200. The sensing fixture 223 is loaded into the front of the formation chamber 250, and an operator connects the transducer connections 37 to their respective ultrasound transducer modules 32. The operator then closes the door (not shown) of the formation chamber 250. Other arrangements for the inspection system are also possible according to one or more contemplated embodiments.

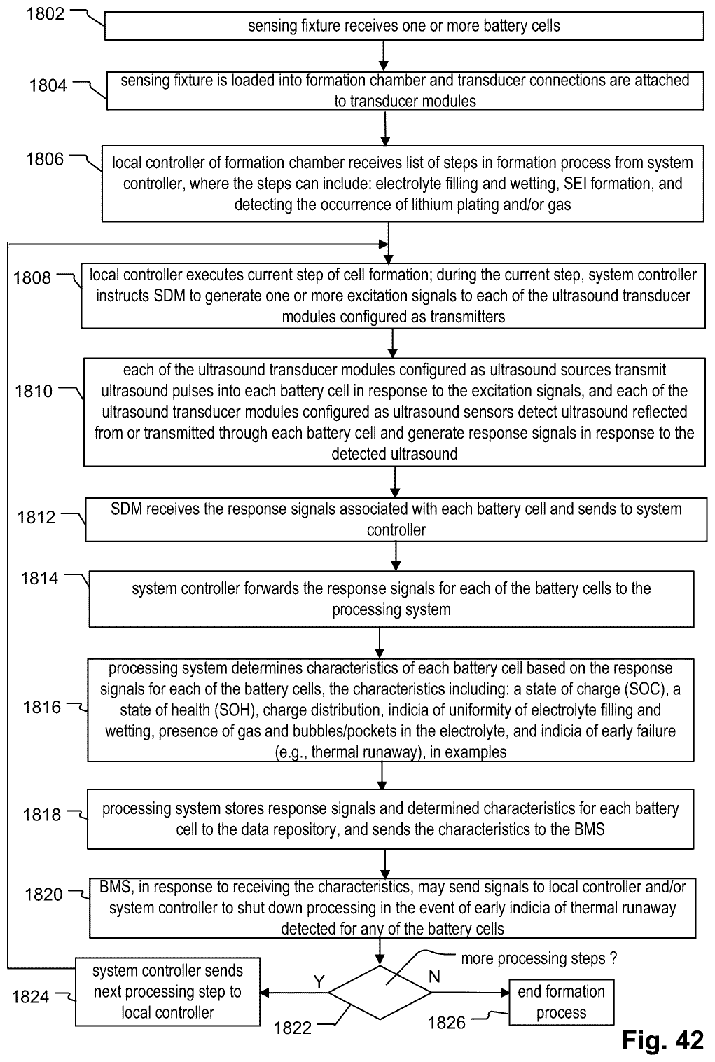

In one or more embodiments, the inspection system 6000 operates as follows. At system startup, the system controller 800 loads a set of instructions/steps of the formation process from the data repository 200 and loads a set of interrogation parameters 80 for the SDM 1090 from the data repository 200. For each step of the formation process, the system controller 800 sends instructions to the local controller 350 of the formation chamber 250 and to the SDM 1090. More detail for operation of the inspection system 6000 is provided in the method of FIG. 42, the description of which is provided below and elsewhere herein. However, other operations for the inspection system are also possible according to one or more contemplated embodiments.

FIG. 42 is a flowchart that describes a method of operation of an exemplary inspection system, such as the inspection system 6000 of FIG. 41. The method describes the ability of the inspection system to monitor battery cells 1035 during steps of a formation process of the cells at a manufacturing facility. The method begins in step 1802, where the sensing fixture 223 receives one or more battery cells 1035. In one example, an operator loads an individual battery cell 1035 into an associated section 218 of the sensing fixture 223. According to step 1804, an operator loads the sensing fixture 223 into the formation chamber 250 and connects the transducer connections 37 to their respective ultrasound transducer modules 32. In step 1806, the local controller 350 of the formation chamber 250 receives a list of steps in the formation process of the cells 1035 from the system controller 800, where the steps can include: electrolyte filling and wetting, SEI formation, and/or detecting the occurrence of lithium plating and/or gas, in examples. According to step 1808, the local controller 350 executes a first step of the formation process, and assigns the first step as a current step. During the current step, the system controller 800 also instructs the SDM 1090 to generate one or more excitation signals to each of the ultrasound transducer modules 32 configured as ultrasound transmitters, in accordance with the interrogation parameters 80. In step 1810, each of the ultrasound transducer modules 32 configured as ultrasound sources transmit ultrasound pulses into each battery cell in response to the excitation signals, and each of the ultrasound transducer modules 32 configured as ultrasound sensors detects ultrasound reflected from or transmitted through each battery cell 1035 and generates response signals in response to the detected ultrasound.

In response to an ultrasound transducer module 32 detecting ultrasound, the ultrasound transducer module 32 generates an electrical signal corresponding with instantaneous ultrasound amplitude vs time values. The electrical signal is then transmitted to the SDM 1090 to generate a digital response signal corresponding with the detected ultrasound. In step 1812, the system controller 800 receives and collects the response signals. The collected response signals are buffered by the system controller 800 and sent to the processing system 900 for analysis to determine the characteristics of the battery cell 1035, in step 1814.

According to step 1816, the processing system 900 determines characteristics of each battery cell 1035 based on the response signals for each of the battery cells, the characteristics including: a state of charge (SOC), a state of health (SOH), charge distribution, indicia of uniformity of electrolyte filling and wetting, presence of gas and bubbles/pockets in the electrolyte, and/or indicia of early failure (e.g., thermal runaway), in examples. Then, in step 1818, the processing system 900 stores the response signals and determined characteristics for each battery cell 1035 to the data repository 200 and sends the characteristics to the BMS 300.

In step 1820, the BMS 300, in response to receiving the characteristics from the processing system 900, may send signals to other system components for the purpose of managing or controlling the components. For example, the BMS 300 might send signals via the local network 64 and system controller 800 to the local controller 350, and/or via the local network 64 to the system controller 800, to shut down the inspection system 6000 when the BMS 300 receives early indicia of thermal runaway detected for any of the battery cells 1035. In step 1822, the system controller 800 determines whether any steps of the formation process remain. If more steps exist, the method transitions to step 1824; otherwise, the method ends in step 1826 and the formation process is complete. When more processing steps exist, the system controller 800 in step 1824 sends the next processing step to the local controller 350, and control of the method returns to the beginning of step 1808 to execute the next step in the formation process.

Although some of steps 1802-1826 of FIG. 42 have been described as being performed once, in some embodiments, multiple repetitions of a particular step (or portion thereof) may be employed before proceeding to the next step. In addition, although steps 1802-1826 have been separately illustrated and described, in some embodiments, steps (or portions thereof) may be combined and performed together (simultaneously or sequentially). Moreover, although FIG. 42 illustrates a particular order for steps 1802-1826, embodiments of the disclosed subject matter are not limited thereto. Indeed, in certain embodiments, the steps (or portions thereof) may occur in a different order than illustrated or simultaneously with other steps (or portions thereof). In some embodiments, the method (e.g., a method for inspecting one or more battery cells during formation thereof) can include steps or other aspects not specifically illustrated in FIG. 42. Alternatively or additionally, in some embodiments, the method may comprise only some of steps 1802-1826 (or portions thereof).

As noted above, the inspection system 6000 is a contact ultrasound evaluation system. In a contact implementation, the ultrasound transducer modules 32 are in, or come into, contact with surfaces of each battery cell 1035 and/or a couplant (e.g., a solid, liquid, or gel) is used between the emission face of the transducer module 32 and the surface of the battery cell 1035. In some embodiments, the transmitted ultrasound can additionally be formed into a focused beam. For this purpose, in one example, one or more ultrasound focusing elements may be attached to the emission faces of the ultrasound transducer modules and/or positioned between the ultrasound transducer modules and the surfaces of each battery cell 1035. These focusing elements are selected to modify the transmitted ultrasound, e.g., to focus the ultrasound at a particular point, or to collimate or otherwise reshape the ultrasound with respect to a particular point. For example, the focusing elements can reshape the ultrasound at a particular point into an ultrasound image corresponding with a response signal.

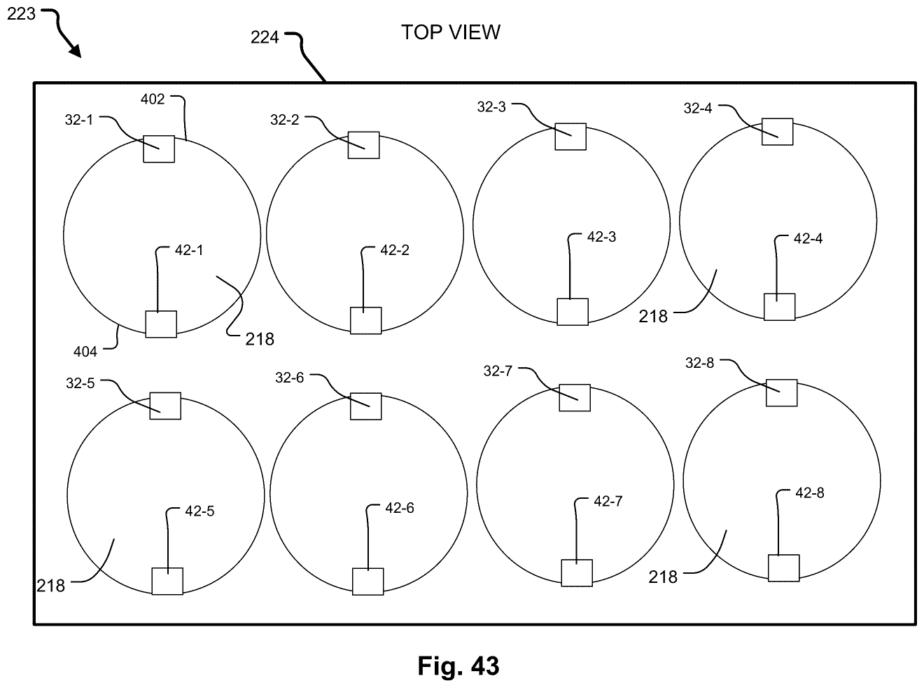

FIG. 43 shows a top view of another exemplary sensing fixture 223. The sensing fixture 223 has eight (8) substantially circular sections 183 that are each designed to accept a cylindrical battery cell 1035. The sensing fixture 223 includes two ultrasound transducer modules 32, 42 per section 218/per battery cell 1035. In the illustrated example, ultrasound transducer modules 32-1 . . . 32-8 are located near a back 402 of each section 218, and ultrasound transducer modules 42-1 . . . 42-8 are located near a front 404 of each section 218. Within each section, the two ultrasound transducer modules 32, 42 are arranged to oppose one another. Other numbers and/or shapes for battery cell sections and/or transducer modules are also possible according to one or more contemplated embodiments.

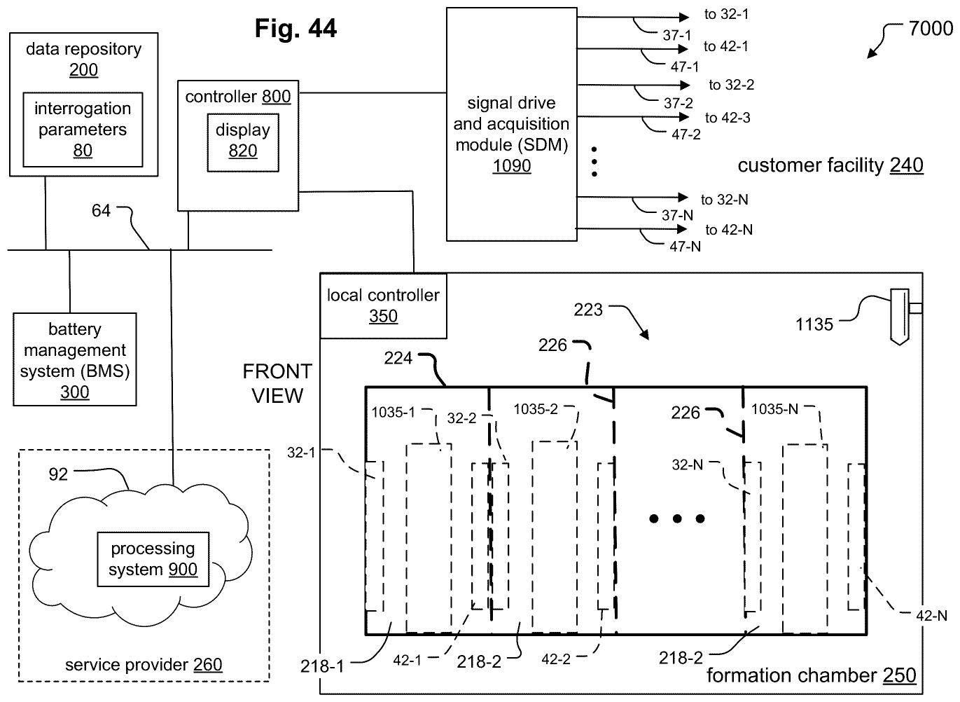

FIG. 44 shows another inspection system 7000 configured to assess characteristics of battery cells 1035 during formation of the battery cells 1035. The inspection system 7000 includes substantially similar components as, and operates in a substantially similar way to, the inspection system 6000 of FIG. 41; however, there are differences. In the illustrated example, the sensing fixture 223 includes two ultrasound transducer modules 32 and 42 per section 218. The ultrasound transducer modules 32, 42 and the battery cells 1035 are shown in phantom. In more detail, ultrasound transducer modules 32-1 and 42-1 oppose one another and are included in section 218-1 for interrogation of battery 1035-1. In a similar vein, ultrasound transducer modules 32-2 and 42-2 oppose one another and are included in section 218-2 for interrogation of battery cell 1035-2, and ultrasound transducer modules 32-N and 42-N oppose one another and are included in section 218-N for ultrasound interrogation of battery cell 1035-N. Also in the figure, the processing system 900 is included in a remote network 92. The remote network 92 has an interface (e.g., gateway) that enables connection between the local network 64 and the remote network 92.

The SDM 1090 additionally includes transducer connections 47-1 . . . 47-N for connecting to each of the ultrasound transducer modules 42-1 . . . 42-N. Each transducer connection 37, 47 functions as both a control pathway from the SDM 1090 to an ultrasound transducer module 32, 42 and as a data pathway from the ultrasound transducer module 32, 42 to the SDM 1090. Because a pair of opposing ultrasound transducer modules 32, 42 are included in each section 218 of the housing 224 of the sensing fixture 223, both pulse-echo mode and through-transmission interrogation modes of each battery cell 1035 are possible. Moreover, at least four different sets of response signals can be obtained for each battery cell 1035. For example, the ultrasound transducer modules 32-1 and 42-1 can be successively configured to operate in pulse-echo mode, the result of which provides two sets of response signals from opposing sides of the battery cell 1035-1. The ultrasound transducer modules 32-1 and 42-1 can then be configured as ultrasound source and ultrasound sensor, respectively; ultrasound transducer module 42-1 then sends a third set of response signals to the SDM 1090. In a similar vein, the ultrasound transducer modules 42-1 and 32-1 can be configured as ultrasound source and ultrasound sensor, respectively; ultrasound transducer module 32-1 then sends a fourth set of response signals to the SDM 1090.

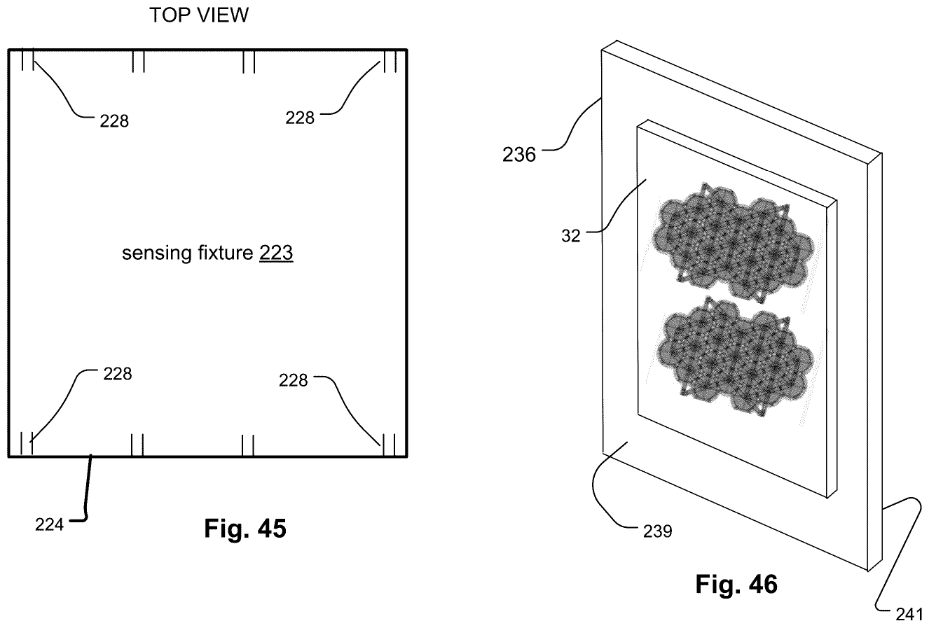

FIG. 45 shows a top view of yet another sensing fixture 223. Rather than attaching ultrasound transducer modules 32, 42 to the housing 224, the housing 224 includes or otherwise provides opposing slots 228 that accept transducer boards. The transducer boards, in turn, include the ultrasound transducer modules 32, 42.

FIG. 46 shows an exemplary transducer board 236 for placement in the slots 228 of the sensing fixture 223 in FIG. 45. An ultrasound transducer module 32 is attached to a side 239 of the transducer board 36. In one example, the transducer board 236 is made from plastic or other electrically non-conductive material. Depending on the location of the transducer board 236 relative to the housing 224, a transducer board 236 may include a single ultrasound transducer module 32 attached to one of its sides 239, 241, or include two ultrasound transducer modules 32, 42 located on opposing sides 239, 241 of the transducer board 236.

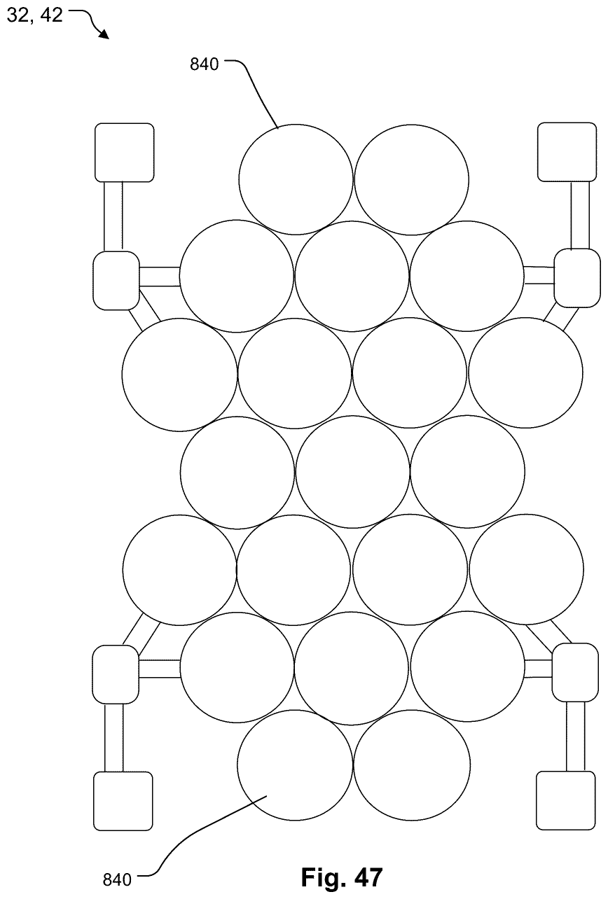

FIG. 47 shows an exemplary ultrasound transducer module 32, 42 that includes twenty one (21) CMUT “drums” 840. The drums 840 are connected to form an array, where the size of the array, the number of drums, and their arrangement can take any number of forms/shapes, for example, depending on the characteristics of the battery cell 1035 under test. These characteristics might include, but are not limited to, physical dimensions of the battery cell and/or its housing and type/formulation of its electrolyte, in examples. In one example, a size (e.g., a diameter) of the drums depends on a frequency (or range of frequencies) of ultrasound for which the drums were designed to transmit. In another example, the number of drums and their arrangement affect an acoustic output of the modules 32, 42. In the illustrated example, the arrangement of drums 840 is approximately 2.37 millimeters (mm) in height and 1.52 mm in width. In another implementation, the drums 840 are piezoelectric micromachined ultrasonic transducers (PMUT).

The inspection systems 6000, 7000 utilize ultrasound waves in transmission and/or reflection modes to interrogate cells for real-time monitoring during the formation process. The system monitors the SEI formation process, assesses the distribution of electrolyte and state of wetting, and can detect the occurrence and evolution of lithium plating or gas, in examples. The systems also utilizes ultrasound signals from cell interrogation to generate real-time insights and recommendations on the formation process for each individual battery cell, to optimize the process, or shut down the process if there is a likelihood of a dangerous event such as thermal runaway. For this purpose, the inspection systems 6000, 7000 can monitor, quantify, or otherwise detect quality aspects (e.g., uniformity and material morphology) during the manufacturing process (e.g., during electrode assembly and/or during other aspects of battery cell formation).

In some embodiments, the systems can utilize microelectromechanical systems (MEMS) technology, such as but not limited to CMUT and/or PMUT ultrasound transducer modules in an array configuration. In some embodiments, the system can transmit ultrasound into each battery cell 1035 at single or multiple frequencies, for example, in a range between 1 megahertz (MHZ) and 10 MHz, inclusive. Alternatively, in some embodiments, instead of transmitting multiple ultrasound signals of different frequencies into each battery cell, a single broadband frequency signal/swept source signal can be transmitted. In some embodiments, the system can produce high spatial resolution information maps of the battery cells 1035 based upon the response signals, with partial or full coverage of the battery cell surface area. In some embodiments, the sensing fixture 223 might be used inside or outside the formation chamber 250. In some embodiments, a clamping force may be applied to the sensing fixture 223 during battery cell formation.

It can be appreciated that time of flight (ToF), amplitude, signal shape, and frequency domain are the primary types of data for analyzing the measurements in reference to cell samples of known characteristics. In some embodiments, physics-based models and generative deep learning autoencoder techniques for creating interpretational models, using cell samples of known characteristics as learning reference, might also be used. These interpretational models input the measurements and spatial information and output a status and insights of the battery cells.

It can also be appreciated that various aspects of any one of the inspection systems are applicable to at least some of the other inspection systems. In one example, the acoustic lens 44 of inspection system 5000/the ability to configure the transducers to focus ultrasound into focused beams can be included in any of the other inspection systems 1000, 2000, 3000, 4000, 6000 and 7000. In other examples, aspects of the methods disclosed in FIGS. 14-15 for interrogation of battery cells and determining characteristics of battery cells are applicable to the inspection systems 6000, 7000, and the aspects described in the methods of FIGS. 16-21 and FIG. 27A are also applicable to the inspection systems 6000, 7000.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

### Computer Implementation

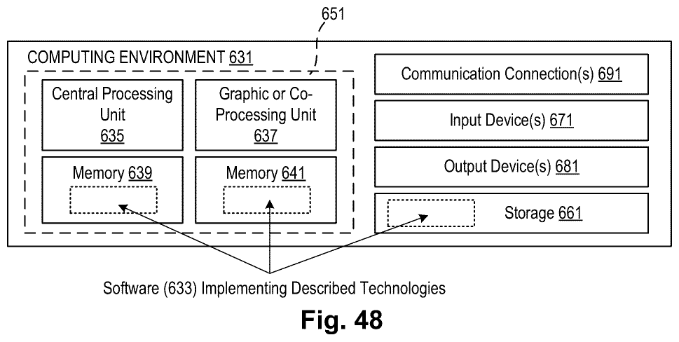

FIG. 48 depicts a generalized example of a suitable computing environment 631 in which the described innovations may be implemented, such as but not limited to controller 800, processing system 900, SDM 1090, data repository 200, service provider 260, local controller 350, BMS 300, and/or the method(s) of FIGS. 7, 8, 14-21, 27A, and/or 42. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 48, the computing environment 631 includes one or more processing units 635, 637 and memory 639, 641. This basic configuration 651 is included within a dashed line. The processing units 635, 637 execute computer-executable instructions. A processing unit can be a central processing unit (CPU), a processor in an application-specific integrated circuit (ASIC), a microcontroller, or any other type of processor (e.g., hardware processors, graphics processing units (GPUs), virtual processors, etc.). In a multi-processing system, multiple processing units execute computer-executable instructions to increase processing power. For example, FIG. 48 shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for software executing in the computing environment 631 such as the software 633, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 681 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed modes or methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. A battery cell inspection system configured to perform ultrasound interrogation of battery cells, the inspection system comprising:
   ultrasound transducers configured to direct ultrasound at target points of each battery cell in response to the ultrasound transducers receiving excitation signals, to detect the ultrasound directed at the target points that is either reflected from or transmitted through each battery cell, and to generate response signals based upon the detected ultrasound;
   a controller and a transport module configured to transport the ultrasound transducers without transporting the battery cells, or to transport the battery cells without transporting the ultrasound transducer, to thereby align the ultrasound transducers with the target points;
   a signal drive and acquisition system (SDM) configured to generate the excitation signals and to receive the response signals corresponding with the ultrasound interrogation of the target points; and
   a data repository for storing data corresponding with the response signals associated with the interrogation of each battery cell at the target points;
   wherein the ultrasound transducers and each battery cell are immersed in an electrically non-conducting fluid during the directing of the ultrasound and the detection of the ultrasound.
Clause 2. The inspection system of any clause or example herein, in particular, Clause 1, wherein the ultrasound transducers are configured to focus the directed ultrasound signals into a focused beam at the target points.
Clause 3. The inspection system of any clause or example herein, in particular, any one of Clauses 1-2, wherein the ultrasound transducers include a lens attached to a face of the transducers to focus the directed ultrasound signals into a focused beam at the target points.
Clause 4. The inspection system of any clause or example herein, in particular, any one of Clauses 1-2, wherein faces of the ultrasound transducers are formed to focus the directed ultrasound signals into a focused beam at the target points.
Clause 5. The inspection system of any clause or example herein, in particular, any one of Clauses 1-2, wherein the ultrasound transducers are included in an array of transducers, and the array focuses the directed ultrasound signals into a focused beam at the target points.
Clause 6. The inspection system of any clause or example herein, in particular, any one of Clauses 1-5, wherein the ultrasound transducers are configured to direct a first ultrasound signal having a first frequency at each of the target points and to generate a first response signal in response to detecting the ultrasound directed at each of the target points, and to direct a second ultrasound signal having a different frequency than the first frequency at each of the target points and to generate a second response signal in response to detecting the ultrasound directed at each of the target points.
Clause 7. The inspection system of any clause or example herein, in particular, any one of Clauses 1-6, further comprising:
   a tank configured to hold the electrically non-conducting fluid; and
   at least one pair of ultrasound transducer modules arranged to be substantially parallel with inside walls of the tank along a length of the tank,
   wherein the transducer modules in the at least one pair oppose one another, and each transducer module includes at least two ultrasound transducers that are configured to direct ultrasound at target points located upon opposing sides of each battery cell.
Clause 8. The inspection system of any clause or example herein, in particular, any one of Clauses 1-7, wherein the ultrasound transducers do not come into contact with the battery cells.
Clause 9. The inspection system of any clause or example herein, in particular, any one of Clauses 1-8, wherein each battery cell comprises a plurality of planar electrodes and electrode separators assembled with surfaces thereof being substantially parallel, and wherein the ultrasound transducers are configured to direct ultrasound at the target points along an orthogonal axis with respect to the substantially parallel surfaces of the planar electrodes and the electrode separators.
Clause 10. The inspection system of any clause or example herein, in particular, any one of Clauses 1-9, wherein the ultrasound transducers are configured to operate in one or more interrogation modes during the directing of the ultrasound and during the detection of the ultrasound.
Clause 11. The inspection system of any clause or example herein, in particular, any one of Clauses 1-10, further comprising:
   a processing system in communication with the SDM,
   wherein the inspection system is configured for interrogation of a plurality of target points distributed across at least one side of each of the battery cells, the SDM sends the response signals corresponding with the ultrasound interrogation of the target points to the processing system, and
   the processing system determines characteristics of each of the battery cells based upon the response signals.
Clause 12. The inspection system of any clause or example herein, in particular, Clause 11, wherein the characteristics include defects, anomalies, a state of charge (SOC) and/or a capacity of the battery cells.
Clause 13. The inspection system of any clause or example herein, in particular, any one of Clauses 1-12, wherein the inspection system is configured for interrogation of target points distributed across at least one side of each of the battery cells, and a density of the target points is at least 400 target points per square centimeter.
Clause 14. A method for inspecting a battery cell, the method comprising:
   configuring a predetermined number of target points on surfaces of the battery cell;
   interrogating the battery cell by transmitting ultrasound signals into the battery cell at each of the target points, detecting ultrasound reflected from and/or transmitted through the battery cell at each of the target points, and generating response signals from the detected ultrasound at each of the target points, the interrogation being performed while the battery cell is immersed in a non-conducting fluid;
   creating a hyper pixel for each target point, wherein each hyper pixel includes a representation of the response signals at each target point; and
   determining characteristics of the battery cell based upon the hyper pixels for each target point.
Clause 15. The method of any clause or example herein, in particular, Clause 14, wherein the determining characteristics of the battery cell based upon the hyper pixels for each target point comprises creating at least one anomaly map from the hyper pixels that includes the characteristics of the battery cell.
Clause 16. The method of any clause or example herein, in particular, Clause 15, further comprising creating at least one defect image from the at least one anomaly map, the at least one defect image identifying at least one characteristic of the battery cell.
Clause 17. The method of any clause or example herein, in particular, Clause 16, wherein the creating at least one defect image from the at least one anomaly map comprises:
   selecting one or more mathematical algorithms that are preconfigured to isolate and identify one or more specific characteristics in anomaly maps; and
   applying the one or more one or more mathematical algorithms to the at least one anomaly map and generating an image representation of a result to create the at least one defect image identifying the at least one characteristic of the battery cell.
Clause 18. The method of any clause or example herein, in particular, any one of Clauses 14-17, wherein the transmitting of the ultrasound signals into the battery cell and the detecting of the ultrasound reflected from and/or transmitted through the battery cell are performed by ultrasound transducers that do not come into contact with the surfaces of the battery cell.
Clause 19. The method of any clause or example herein, in particular, any one of Clauses 14-18, wherein the transmitting ultrasound signals into the battery cell at each of the target points, the detecting ultrasound reflected from and/or transmitted through the battery cell at each of the target points, and the generating response signals from the detected ultrasound at each of the target points comprises:
   transmitting a first ultrasound signal having a first frequency into the battery cell at each of the target points, detecting ultrasound reflected from and/or transmitted through the battery cell at each of the target points, and generating a first response signal from the detected ultrasound at each of the target points; and
   transmitting a second ultrasound signal having a second frequency that is different from the first frequency into the battery cell at each of the target points, detecting ultrasound reflected from and/or transmitted through the battery cell at each of the target points, and generating a second response signal from the detected ultrasound at each of the target points.
Clause 20. The method of any clause or example herein, in particular, any one of Clauses 14-19, further comprising focusing the ultrasound signals transmitted into the battery cell at each of the target points into focused beams at each of the target points.
Clause 21. The method of any clause or example herein, in particular, any one of Clauses 14-20, further comprising providing a battery cell throughput rate for the interrogating in a range of 10-55 battery cells per minute, inclusive.
Clause 22. The method of any clause or example herein, in particular, any one of Clauses 14-20, further comprising providing a battery cell throughput rate for the interrogating that is greater than 55 battery cells per minute.
Clause 23. A battery cell inspection system configured to perform ultrasound interrogation of battery cells, the inspection system comprising:
   ultrasound transducers configured to direct ultrasound at target points of each battery cell in response to the ultrasound transducers receiving excitation signals, to detect the ultrasound directed at the target points that is either reflected from or transmitted through each battery cell, and to generate response signals based upon the detected ultrasound;
   a controller and a transport module configured to transport the ultrasound transducers without transporting the battery cells, or to transport the battery cells without transporting the ultrasound transducer, to thereby align the ultrasound transducers with the target points;
   a signal drive and acquisition system (SDM) configured to generate the excitation signals and to receive the response signals corresponding with the ultrasound interrogation of the target points, and to forward the response signals to the controller, wherein the controller creates a hyper pixel for each of the target points, and wherein each hyper pixel includes a representation of the response signals generated for each of the target points; and
   a processing system configured to receive the hyper pixels from the controller and to determine information concerning the battery cells based upon the hyper pixels;
   wherein the ultrasound transducers and each battery cell are immersed in an electrically non-conducting fluid during the directing of the ultrasound and the detection of the ultrasound.
Clause 24. The inspection system of any clause or example herein, in particular, Clause 23, wherein the ultrasound transducers are configured to focus the directed ultrasound signals into a focused beam at the target points.
Clause 25. The inspection system of any clause or example herein, in particular, any one of Clauses 23-24, wherein the ultrasound transducers are configured to direct a first ultrasound signal having a first frequency at each of the target points and to generate a first response signal in response to detecting the ultrasound directed at each of the target points, and to direct a second ultrasound signal having a different frequency than the first frequency at each of the target points and to generate a second response signal in response to detecting the ultrasound directed at each of the target points.
Clause 26. The inspection system of any clause or example herein, in particular, any one of Clauses 23-25, wherein the information concerning the battery cells are defects, and wherein the processing system is configured to determine the defects by:
   loading defect instruction sets from a data repository, where each defect instruction set is associated with a specific defect type and includes one or more calculations for the processing system to perform on the hyper pixels to determine one or more defects of or within the battery cell for each defect type; and
   executing the defect instruction sets to determine the one or more defects of or within the battery cells for each defect type.
Clause 27. The inspection system of any clause or example herein, in particular, any one of Clauses 23-26, wherein the information concerning the battery cells are defects including: dry zones during an electrolyte wetting stage, inactive zones and residual gas after a formation stage, contaminants, tears and wrinkles in layers, and/or layer misalignment and delamination.
Clause 28. The inspection system of any clause or example herein, in particular, any one of Clauses 23-27, wherein the information concerning the battery cells is/are defects including: a material distribution non-uniformity, micro shorts, soft shorts, lithium plating, and/or charge distribution.
Clause 29. The inspection system of any clause or example herein, in particular, any one of Clauses 23-28, wherein the information concerning the battery cells includes an estimate of remaining battery cell capacity, a predicted capacity fade over a predetermined number of battery cell cycles, and/or charge distribution mapping.
Clause 30. The inspection system of any clause or example herein, in particular, any one of Clauses 23-29, wherein the information concerning the battery cells is/are predicted defects that the processing system determines by extracting and/or calculating ultrasound features from the response signals of the hyper pixels, and by passing the hyper pixels and/or the ultrasound features as input to a machine learning model trained to detect defects, the output of which are the predicted defects.
Clause 31. The inspection system of any clause or example herein, in particular, Clause 30, wherein the machine learning model was previously trained to detect defects in reference batteries of a same type as each battery cell, and each of the reference batteries is manufactured to include a different defect type at a specific location therein.
Clause 32. The inspection system of any clause or example herein, in particular, Clause 31, wherein the inspection system trains the machine learning model to detect the defect in each reference battery cell by:
   configuring the controller to perform an ultrasound interrogation session of each reference battery cell in the one or more interrogation modes at each of the target points, and to send the created hyper pixels to the processing system;
   configuring the processing system to extract and/or calculate ultrasound features from the hyper pixels of each reference battery cell, and to calculate a defect mask for the defect type associated with each reference battery cell, based upon the hyper pixels and/or the ultrasound features; and
   including the defect mask calculated for each reference battery cell in a training data set and training the machine learning model using the training data set.
Clause 33. The inspection system of any clause or example herein, in particular, any one of Clauses 23-32, wherein the information concerning the battery cells is/are inferred anomalies that the processing system determines by extracting and/or calculating ultrasound features from the response signals of the hyper pixels, and by passing the hyper pixels and/or the ultrasound features as input to a machine learning model trained using information associated with defect-free batteries, the output of which are the inferred anomalies.
Clause 34. The inspection system of any clause or example herein, in particular, Clause 33, wherein the system trains the machine learning model using information associated with each detect-free battery cell by:
   configuring the controller to perform an ultrasound interrogation session of each defect-free battery cell in the one or more interrogation modes at each of the target points, and to send the created hyper pixels to the processing system;
   configuring the processing system to extract and/or calculate ultrasound features from the hyper pixels of each defect-free battery cell received from the controller; and
   including the hyper pixels for each defect-free battery cell and/or the ultrasound features in a training data set and training the machine learning model using the training data set.
Clause 35. The inspection system of any clause or example herein, in particular, any one of Clauses 23-34, wherein the information concerning the battery cells is/are either defects identified in the battery cells or anomalies inferred in the battery cells, and wherein after the processing system identifies the defects or the anomalies by:
   the controller is configured to perform an additional ultrasound interrogation session at one or more areas of the battery cells where each of the defects or the anomalies were found, using a higher density of target points in each of the one or more areas, the output of the additional interrogation session creating additional hyper pixels for the higher density target points of the one or more areas; and
   the processing system is configured to analyze the additional hyper pixels for the one or more areas to refine the defects or the anomalies.
Clause 36. The inspection system of any clause or example herein, in particular, Clause 35, wherein, when the controller is configured to perform the additional ultrasound interrogation session, the controller is configured to additionally use nearest neighbor target points of the target points for the one or more areas.
Clause 37. The inspection system of any clause or example herein, in particular, any one of Clauses 23-36, wherein the inspection system is configured for interrogation of target points distributed across at least one side of each of the battery cells, and wherein a density of the battery cell target points is at least 400 target points per square centimeter.
Clause 38. The inspection system of any clause or example herein, in particular, any one of Clauses 23-37, wherein the interrogation system provides a battery cell throughput rate in a range from 10 to 55 battery cells per minute, inclusive.
Clause 39. The inspection system of any clause or example herein, in particular, any one of Clauses 23-37, wherein the interrogation system provides a battery cell throughput rate that is greater than 55 battery cells per minute.
Clause 40. An inspection system for monitoring battery cells during cell formation, the system comprising:
   a sensing fixture including a housing that accepts battery cells;
   a formation chamber configured to receive the sensing fixture and which enables formation of the battery cells within the sensing fixture;
   at least one MEMS ultrasound transducer module associated with each battery cell and configured to perform ultrasound interrogation of each battery cell during the formation of the battery cells, the ultrasound interrogation including: directing ultrasound at each battery cell in response to receiving an excitation signal; detecting the ultrasound directed at each battery cell that is either reflected from or transmitted through each battery cell; and generating a response signal based upon the detected ultrasound; and
   a processing system that is configured to receive the response signals from the at least one MEMS ultrasound transducer module associated with each of the battery cells, and to determine characteristics of each battery cell based on the response signals.
Clause 41. The inspection system of any clause or example herein, in particular, Clause 40, wherein the inspection system is configured to determine the characteristics of each battery cell both during and after electrolyte filling and wetting of the battery cells.
Clause 42. The inspection system of any clause or example herein, in particular, any one of Clauses 40-41, wherein the characteristics include anomalies including: dry zones due to inadequate soaking during electrolyte filling and wetting; wrinkles present in a separator, anode, and/or cathode; and/or contaminants including shavings and splattering.
Clause 43. The inspection system of any clause or example herein, in particular, any one of Clauses 40-42, wherein the characteristics include anomalies including: misalignment of battery cell layers including anode, cathode, and/or separator layers; inactive zones and residual gas after cell formation; instances of separator tears, tears and wrinkles in layers, and/or delamination of the battery cell layers.
Clause 44. The inspection system of any clause or example herein, in particular, any one of Clauses 40-43, wherein the characteristics include defects including: material distribution non-uniformities, micro shorts, soft shorts, lithium plating, and/or indicia of improper or non-uniform charge distribution.
Clause 45. The inspection system of any clause or example herein, in particular, any one of Clauses 40-44, wherein the at least one MEMS ultrasound transducer module associated with each battery cell is attached to the housing of the sensing fixture.
Clause 46. The inspection system of any clause or example herein, in particular, any one of Clauses 40-44, wherein the at least one MEMS ultrasound transducer module associated with each battery cell is attached to at least one removeable transducer board, and the sensing fixture includes slots that accept the at least one removeable transducer board.
Clause 47. The inspection system of any clause or example herein, in particular, any one of Clauses 40-46, wherein the formation chamber is configured to apply a clamping force to the sensing chamber during the cell formation of each battery cell.
Clause 48. The inspection system of any clause or example herein, in particular, any one of Clauses 40-47, wherein the housing of the sensing fixture is partitioned into sections, each section is configured to receive a battery cell, and each section includes the at least one ultrasound MEMS transducer module associated with each battery cell.
Clause 49. The inspection system of any clause or example herein, in particular, Clause 48, further comprising a pair of opposing MEMS ultrasound transducer modules included in each section of the housing.
Clause 50. The inspection system of any clause or example herein, in particular, any one of Clauses 40-49, wherein the at least one MEMS ultrasound transducer module associated with each battery cell is configured to direct ultrasound of least two different frequencies at each battery cell.
Clause 51. The inspection system of any clause or example herein, in particular, any one of Clauses 40-50, wherein the at least one MEMS ultrasound transducer module associated with each battery cell is configured to direct a focused beam of ultrasound at each battery cell.
Clause 52. The inspection system of any clause or example herein, in particular, any one of Clauses 40-51, wherein the at least one MEMS ultrasound transducer module associated with each battery cell includes a lens attached to a face of the module to focus the directed ultrasound signals into a focused beam.
Clause 53. The inspection system of any clause or example herein, in particular, any one of Clauses 40-51, wherein a face of the at least one MEMS ultrasound transducer module associated with each battery cell is formed to focus the directed ultrasound signals into a focused beam.
Clause 54. A method for monitoring battery cells during cell formation, the method comprising:
   providing a sensing fixture including a housing accepting battery cells;
   providing a formation chamber receiving the sensing fixture, the formation chamber enabling the formation of the battery cells within the sensing fixture;
   interrogating each battery cell using at least one MEMS ultrasound transducer module associated with each battery cell, the at least one MEMS ultrasound transducer module being configured to perform ultrasound interrogation of each battery cell during the formation of the battery cells, the ultrasound interrogation comprising:
   directing ultrasound at each battery cell in response to receiving an excitation signal;
   detecting the ultrasound directed at each battery cell that is either reflected from or transmitted through each battery cell; and
   generating a response signal based upon the detected ultrasound; and
   receiving the response signals from the at least one MEMS ultrasound transducer module associated with each of the battery cells, and determining characteristics of each battery cell based on the response signals.
Clause 55. The method of any clause or example herein, in particular, Clause 54, wherein the characteristics of each battery cell are characterized during and after electrolyte filling and wetting of the battery cells.
Clause 56. The method of any clause or example herein, in particular, any one of Clauses 54-55, wherein the determined characteristics comprise one or more anomalies selected from dry zones due to inadequate soaking during electrolyte filling and wetting; wrinkles present in a separator, anode, and/or cathode; and/or contaminants including shavings and splattering.
Clause 57. The method of any clause or example herein, in particular, any one of Clauses 54-56, wherein the determined characteristics comprise one or more anomalies selected from misalignment of battery cell layers (e.g., anode, cathode, and/or separator layers), inactive zones and residual gas after cell formation, instances of separator tears, tears, and wrinkles in layers, and/or delamination of the battery cell layers.
Clause 58. The method of any clause or example herein, in particular, any one of Clauses 54-57, wherein the determined characteristics comprise one or more defects selected from material distribution non-uniformities, micro shorts, soft shorts, lithium plating, and/or improper or non-uniform charge distribution.
Clause 59. The method of any clause or example herein, in particular, any one of Clauses 54-58, wherein the at least one MEMS ultrasound transducer module associated with each battery cell is attached to the housing of the sensing fixture.
Clause 60. The method of any clause or example herein, in particular, any one of Clauses 54-59, wherein the at least one MEMS ultrasound transducer module associated with each battery cell is attached to at least one removeable transducer board, and the sensing fixture includes slots that accept the at least one removeable transducer board.
Clause 61. The method of any clause or example herein, in particular, any one of Clauses 54-60, further comprising applying, via the formation chamber, a clamping force to the sensing chamber during the cell formation of each battery cell.
Clause 62. The method of any clause or example herein, in particular, any one of Clauses 54-61, wherein the housing of the sensing fixture is partitioned into sections, each section is configured to receive a battery cell, and each section includes the at least one ultrasound MEMS transducer module associated with each battery cell.
Clause 63. The method of any clause or example herein, in particular, any one of Clauses 54-62, wherein a pair of opposing MEMS ultrasound transducer modules are included in each section of the housing.
Clause 64. The method of any clause or example herein, in particular, any one of Clauses 54-63, wherein the directing ultrasound comprises directing, via the at least one MEMS ultrasound transducer module associated with each battery cell, ultrasound of least two different frequencies at each battery cell.
Clause 65. The method of any clause or example herein, in particular, any one of Clauses 54-64, wherein the directing ultrasound comprises directing, via the at least one MEMS ultrasound transducer module associated with each battery cell, a focused beam of ultrasound at each battery cell.
Clause 66. The method of any clause or example herein, in particular, any one of Clauses 54-65, further comprising attaching a respective lens to a face of each MEMS ultrasound transducer module, the lens being configured to focus the directed ultrasound signals into a focused beam.
Clause 67. The method of any clause or example herein, in particular, any one of Clauses 54-66, further comprising forming a face of each MEMS ultrasound transducer module, the formed face being configured to focus the directed ultrasound signals into a focused beam.
Clause 68. A system comprising:
   a plurality of ultrasonic transducers constructed to direct ultrasound energy into and to detect ultrasound energy passing through and/or reflected from a battery cell;
   a bath of fluid in which the plurality of ultrasonic transducers and the battery cell are disposed; and
   a control system operatively coupled to the plurality of ultrasonic transducers, the control system comprising one or more processors and one or more non-transitory computer-readable storage media storing computer-readable instructions that, when executed by the one or more processors, causes the one or more processors to control the plurality of ultrasonic transducers to inspect the battery cell,
   wherein the ultrasonic transducers are arranged with respect to the battery cell such that the ultrasonic transducers are spaced from facing surfaces of the battery cell during the directing and detecting of the ultrasound energy to inspect the battery cell, and
   the fluid is electrically insulating.
Clause 69. The system of any clause or example herein, in particular, Clause 68, further comprising a transport system configured to move the plurality of ultrasonic transducers with respect to the battery cell and/or to move the battery cell with respect to the plurality of ultrasonic transducers.
Clause 70. The system of any clause or example herein, in particular, any one of Clauses 68-69, wherein the inspecting of the battery cell comprises determining one or more characteristics of the battery cell based at least in part on the detected ultrasound energy.
Clause 71. A method for non-contact ultrasound inspection of one or more battery cells according to any clause or example herein, in particular, using the system of any one of Clauses 68-70.

### CONCLUSION

Although energy storage devices (e.g., battery cells), components, and configuration have been illustrated in the figures and discussed in detail herein, embodiments of the disclosed subject matter are not limited thereto. Indeed, one of ordinary skill in the art will readily appreciate that different energy storage devices, components, or configurations can be selected and/or components added to provide the same effect. In practical implementations, embodiments may include additional components or other variations beyond those illustrated. Accordingly, embodiments of the disclosed subject matter are not limited to the particular batteries, components, and configurations specifically illustrated and described herein.

Any of the features illustrated or described herein, for example, with respect to FIGS. 1-48 and Clauses 1-71, can be combined with any other feature illustrated or described herein, for example, with respect to FIGS. 1-48 and Clauses 1-71 to provide systems, devices, methods, and embodiments not otherwise illustrated or specifically described herein. All features described herein are independent of one another and, except where structurally impossible, can be used in combination with any other feature described herein.

It will also be recognized by those skilled in the art that, while the invention has been described above in terms of examples and embodiments, it is not limited thereto. Various features and aspects of the above-described embodiments may be used individually or jointly. Further, although the examples and embodiments have been described in the context of its implementation in a particular environment, and for particular applications, those skilled in the art will recognize that its usefulness is not limited thereto and that embodiments of the disclosed subject matter can be beneficially utilized in any number of environments and implementations, for example, where it is desirable to implement one or more of inspection systems 1000, 2000, 3000, 4000, 5000, and 6000. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A battery cell inspection system configured to perform ultrasound interrogation of battery cells, the inspection system comprising:
ultrasound transducers configured to direct ultrasound at target points of each battery cell in response to the ultrasound transducers receiving excitation signals, to detect the ultrasound directed at the target points that is either reflected from or transmitted through each battery cell, and to generate response signals based upon the detected ultrasound;
a controller and a transport module configured to transport the ultrasound transducers without transporting the battery cells, or to transport the battery cells without transporting the ultrasound transducer, to thereby align the ultrasound transducers with the target points;
a signal drive and acquisition system (SDM) configured to generate the excitation signals and to receive the response signals corresponding with the ultrasound interrogation of the target points; and
a data repository for storing data corresponding with the response signals associated with the interrogation of each battery cell at the target points;
wherein the ultrasound transducers and each battery cell are immersed in an electrically non-conducting fluid during the directing of the ultrasound and the detection of the ultrasound.

2. The inspection system of claim 1, wherein the ultrasound transducers are configured to focus the directed ultrasound signals into a focused beam at the target points.

3. The inspection system of claim 2, wherein the ultrasound transducers include a lens attached to a face of the transducers to focus the directed ultrasound signals into a focused beam at the target points.

4. The inspection system of claim 2, wherein faces of the ultrasound transducers are formed to focus the directed ultrasound signals into a focused beam at the target points.

5. The inspection system of claim 2, wherein the ultrasound transducers are included in an array of transducers, and the array focuses the directed ultrasound signals into a focused beam at the target points.

6. The inspection system of claim 1, wherein the ultrasound transducers are configured:
to direct a first ultrasound signal having a first frequency at each of the target points and to generate a first response signal in response to detecting the ultrasound directed at each of the target points, and
to direct a second ultrasound signal having a different frequency than the first frequency at each of the target points and to generate a second response signal in response to detecting the ultrasound directed at each of the target points.

7. The inspection system of claim 1, further comprising:
a tank configured to hold the electrically non-conducting fluid; and
at least one pair of ultrasound transducer modules arranged to be substantially parallel with inside walls of the tank along a length of the tank,
wherein the transducer modules in the at least one pair oppose one another, and
each transducer module includes at least two ultrasound transducers that are configured to direct ultrasound at target points located upon opposing sides of each battery cell.

8. The inspection system of claim 1, wherein the ultrasound transducers do not come into contact with the battery cells.

9. The inspection system of claim 1, wherein:
each battery cell comprises a plurality of planar electrodes and electrode separators assembled with surfaces thereof being substantially parallel, and
the ultrasound transducers are configured to direct ultrasound at the target points along an orthogonal axis with respect to the substantially parallel surfaces of the planar electrodes and the electrode separators.

10. The inspection system of claim 1, wherein the ultrasound transducers are configured to operate in one or more interrogation modes during the directing of the ultrasound and during the detection of the ultrasound.

11. The inspection system of claim 1, further comprising:
a processing system in communication with the SDM,
wherein the inspection system is configured for interrogation of a plurality of target points distributed across at least one side of each of the battery cells,
the SDM sends the response signals corresponding with the ultrasound interrogation of the target points to the processing system, and
the processing system determines characteristics of each of the battery cells based upon the response signals.

12. The inspection system of claim 11, wherein the characteristics include defects, anomalies, a state of charge (SOC), and/or a capacity of the battery cells.

13. The inspection system of claim 1, wherein:
the inspection system is configured for interrogation of target points distributed across at least one side of each of the battery cells, and
a density of the target points is at least 400 target points per square centimeter.

14. A method for inspecting a battery cell, the method comprising:
configuring a predetermined number of target points on surfaces of the battery cell;
interrogating the battery cell by:
transmitting ultrasound signals into the battery cell at each of the target points, detecting ultrasound reflected from and/or transmitted through the battery cell at each of the target points, and
generating response signals from the detected ultrasound at each of the target points;
creating a hyper pixel for each target point, wherein each hyper pixel includes a representation of the response signals at each target point; and
determining characteristics of the battery cell based upon the hyper pixels for each target point,
wherein the interrogating is performed while the battery cell is immersed in an electrically non-conducting fluid.

15. The method of claim 14, wherein determining characteristics of the battery cell based upon the hyper pixels for each target point comprises creating at least one anomaly map from the hyper pixels that includes the characteristics of the battery cell.

16-17. (canceled)

18. The method of claim 14, wherein the transmitting of the ultrasound signals into the battery cell and the detecting of the ultrasound reflected from and/or transmitted through the battery cell are performed by ultrasound transducers that do not come into contact with the surfaces of the battery cell.

19. The method of claim 14, wherein the transmitting ultrasound signals into the battery cell at each of the target points, the detecting ultrasound reflected from and/or transmitted through the battery cell at each of the target points, and the generating response signals from the detected ultrasound at each of the target points comprises:
transmitting a first ultrasound signal having a first frequency into the battery cell at each of the target points, detecting ultrasound reflected from and/or transmitted through the battery cell at each of the target points, and generating a first response signal from the detected ultrasound at each of the target points; and
transmitting a second ultrasound signal having a second frequency that is different from the first frequency into the battery cell at each of the target points, detecting ultrasound reflected from and/or transmitted through the battery cell at each of the target points, and generating a second response signal from the detected ultrasound at each of the target points.

20. The method of claim 14, further comprising focusing the ultrasound signals transmitted into the battery cell at each of the target points into focused beams at each of the target points.

21. (canceled)

22. The method of claim 14, wherein the interrogating is performed at a battery cell throughput rate that is greater than 55 battery cells per minute.

23. A battery cell inspection system configured to perform ultrasound interrogation of battery cells, the inspection system comprising:
ultrasound transducers configured to direct ultrasound at target points of each battery cell in response to the ultrasound transducers receiving excitation signals, to detect the ultrasound directed at the target points that is either reflected from or transmitted through each battery cell, and to generate response signals based upon the detected ultrasound;
a controller and a transport module configured to transport the ultrasound transducers without transporting the battery cells, or to transport the battery cells without transporting the ultrasound transducer, to thereby align the ultrasound transducers with the target points;
a signal drive and acquisition system (SDM) configured to generate the excitation signals and to receive the response signals corresponding with the ultrasound interrogation of the target points, and to forward the response signals to the controller; and
a processing system,
wherein the ultrasound transducers and each battery cell are immersed in an electrically non-conducting fluid during the directing of the ultrasound and the detection of the ultrasound,
the controller is configured to create a hyper pixel for each of the target points,
each hyper pixel includes a representation of the response signals generated for each of the target points, and
the processing system is configured to receive the hyper pixels from the controller and to determine information concerning the battery cells based upon the hyper pixels.

24-67. (canceled)
